(19) United States
(12) Patent Application Publication
(10) Pub. No.: US 2024/0347767 A1
(43) Pub. Date: Oct. 17, 2024

(54) RECHARGEABLE BATTERY SYSTEMS AND METHODS THEREOF

(71) Applicant: University of Maryland, College Park, College Park, MD (US)

(72) Inventors: Chunsheng Wang, Silver Spring, MD (US); Chongyin Yang, Bedford (CA); Xiyue Zhang, College Park, MD (US)

(21) Appl. No.: 18/406,077

(22) Filed: Jan. 5, 2024

Related U.S. Application Data
(60) Provisional application No. 63/484,861, filed on Feb. 14, 2023.
(60) Provisional application No. 63/478,845, filed on Jan. 6, 2023.

(51) Int. Cl. H01M 10/0563

(52) U.S. Cl. CPC H01M 10/0563

(57) ABSTRACT

The present disclosure is directed to high entropy electrolyte compositions, batteries utilizing said electrolyte compositions, and methods of assembling and using said batteries. The fast ion-exchanging networks formed by the electrolyte compositions disclosed herein allow for operating conditions over a wide temperature range, allowing for efficient use at both high and low temperatures.

### CROSS REFERENCE TO RELATED APPLICATION(S)

This application claims priority to U.S. Application No. 63/478,845, filed on Jan. 6, 2023, and U.S. Application No. 63/484,861, filed on Feb. 14, 2023, the contents of which are hereby incorporated by reference in their entirety.

### STATEMENT OF FEDERALLY SPONSORED RESEARCH AND DEVELOPMENT

This invention was made with government support under DE-AR0000389 awarded by the U.S. Department of Energy. The government has certain rights in the invention.

### FIELD OF THE INVENTION

The field of the invention relates generally to electrochemical cells, and more particularly, to electrolytes, electrolyte designs, and electrolyte compositions, and even more particularly, to high-entropy electrolyte compositions for high and low operating temperatures in batteries.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

In dilute salt-in-solvent electrolytes, all ions tend to be solvated by highly polar solvents (FIG. 1A). The strong dipolar interactions between solvent molecules promote structural ordering, resulting in a high glass transition temperature (T_{g}) or freezing point. For example, electrolyte viscosity (η) of 2 mol/kg LiCl or 2 mol/kg ZnCl₂ aqueous single salt electrolyte increases rapidly as temperature decreases, as shown by the early rollover of ionic conductivities at >−20° C. (FIG. 1B). Their deviation from Vogel-Tammann-Fulcher (VTF) equation (corresponding dash lines) is due to the spontaneous increase of salt concentration caused by water crystallizing into ice. Adding non-polar or low-polarity solvents with low melting points into salt-in-solvent electrolytes can reduce their viscosity even at a low temperature. However, it also reduces the overall dielectric constant and the availability of charge carriers, thereby decreasing ionic conductivity. Alternatively, it is well-known that switching to the super concentrated or “solvent-in-salt” regime disrupts the intermolecular network in free solvent cluster (FIG. 1A). As a result, the reduced solvent activity suppresses the contraction and crystallization of solvent clusters at a low temperature. However, its high cation-to-solvent ratio also introduces contact ion-pairs (CIPs) and salt aggregates, as evidenced by the sudden drop of ionic conductivities for aqueous LiCl·3H₂O and ZnCl₂·3H₂O at −20° C. (FIG. 1B), promoting salt precipitation and destabilizing the global structure at a low temperature. Both conventional solvent-in-salt and salt-in-solvent electrolytes contain local cluster structures with high structural ordering, limiting the ionic conductivity at a low temperature.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIGS. 1A-1F. FIG. 1A displays an illustration of solution structure in different electrolytes. FIG. 1B displays Arrhenius plots of the overall ionic conductivities of Li₂ZnCl₄·9H₂O electrolyte compared with concentrated LiCl·3H₂O, ZnCl₂·3H₂O solutions and diluted (2 mol kg⁻¹) LiCl and ZnCl₂ aqueous solutions. Insert: The hysteresis loops (same colors as in the main figure) for each electrolyte during the measurement cycle with a cooling course (solid circles, 80° C.→−70° C.), then a heating course (empty cycles, −70° C.→80° C.), with an equilibrium time of 5 hr for each temperature. FIG. 1C displays the overall ionic conductivities (solid lines) of LiCl—ZnCl₂—H₂O solutions with different Li/Zn ratios from 0:1 to 1:0 at different temperatures. The glass transition temperatures (T_{g}) measured by DSC were showed as dash line. FIG. 1D displays a Walden plot for the Li₂ZnCl₄·9H₂O, LiCl·3H₂O, and ZnCl₂·3H₂O electrolytes at the temperature range from +80 to −70° C. The perfector C_{Λ} is 5/3 for Li₂ZnCl₄·9H₂O, 1 for LiCl·3H₂O, and 3 for ZnCl₂·3H₂O (see detail calculation in Supplementary Information). In a Walden plot, electrolyte solutions can be classified in terms of their performance as ionic conductors: superionic (upper left region above the ideal KCl line), good-ionic (on the ideal line), sub-ionic (bottom right region under the ideal line), or non-ionic (far below the ideal line) liquids and solutions. Insert: viscosity of these electrolytes as functions of the temperatures. FIG. 1E displays the temperature dependence of MSD of Li₂ZnCl₄·9H₂O, LiCl·3H₂O and ZnCl₂·3H₂O solutions measured by fixed window scan with HFBS. FIG. 1F displays the small angle neutron scattering (SANS) intensity profile for Li₂ZnCl₄·9D₂O and Li₂ZnCl₄·10D₂O at different temperatures (173 K-293 K). Throughout this manuscript error bars and uncertainties represent one standard error.

FIGS. 2A-2G. FIG. 2A displays a representative configuration of [ZnCl₄²⁻]ₙ anion chains (green and blue network) extracted from BOMD simulations of Li₂ZnCl₄·9H₂O electrolyte; the Zn—Cl bonds (with Cl⁻ within 2.8 Å of Zn²⁺ ions) are depicted by a ball-and-stick model, while the Li⁺ and water molecules are shown as purple balls and red-white wireframes, respectively. FIG. 2B displays high-energy X-ray scattering spectra of Li₂ZnCl₄·9H₂O, measured by synchrotron and predicated by MD simulation. FIG. 2C displays the number of water oxygen (O_{w}) and Cl⁻ within 2.8 Å of Zn²⁺ and Li⁺ from MD simulations using modified AMEOBA force field (filled symbols) at 25° C. for Li₂ZnCl₄·RH₂O electrolytes; the coordination numbers from last 20 ps of BOMD simulations for replica r1 using PBE-D3BJ and revPBE-D3BJ functionals at 177° C. are given as open and crossed open symbols, respectively. FIGS. 2D-2E display Raman spectra of Li₂ZnCl₄·RH₂O at the Raman shift range of 100-450 cm⁻¹ (FIG. 2D) and 2,800-3,800 cm⁻¹ (FIG. 2E). All the Raman bands are fitted by Gaussian peaks with coefficient of determination R²>0.999. FIG. 2F displays the activity coefficient of water as a function of water molar fractions estimated by vapor pressure measurement at 22° C. FIG. 2G displays the activity coefficient for Li⁺ (upper) and Zn²⁺ (button) as a function of their concentrations in various aqueous solutions estimated by the equilibrium potential shift of LiₓFePO₄ (x=0.5) and Zn metal electrodes, respectively.

FIGS. 3A-3F. FIG. 3A displays galvanostatic Zn stripping/plating in a Zn/Zn symmetrical cell with Li₂ZnCl₄·9H₂O and ZnCl₂·3H₂O electrolytes at 0.2 mA cm⁻² and temperature range from +80 to −70° C. FIG. 3B displays the voltage profiles of Zn plating/stripping on a Ti working electrode at 0.4 mA cm⁻² and temperature range from +80 to −70° C. Inset: CE of corresponding cycling performance. Inset: SEM image of a Zn anode after 100^{th} stripping/platting cycles in Li₂ZnCl₄·9H₂O electrolyte. FIG. 3C displays the pH values (top) and Coulombic efficiencies (CEs) of Zn plating/strapping (button) for Li₂ZnCl₄·RH₂O and ZnCl₂·RH₂O electrolytes as a function of their water concentrations at 20° C. FIG. 3D displays the reduction potentials (vs Zn/Zn²⁺) for H₂ evolution reactions of different cation—water solvates species predicted by DFT calculations with solvates immersed in implicit solvent with dielectric constants 8=20 (black) and 8=78 (red). FIGS. 3E-3F display Zn 2p_{3/2} (FIG. 3E) and O 1s XPS (FIG. 3F) spectra of Zn anode after 20^{th} stripping/platting cycles in Li₂ZnCl₄·9H₂O electrolyte. All the XPS peaks are fitted by Gaussian peaks with coefficient of determination R²>0.999.

FIGS. 4A-4F. FIG. 4A displays Galvanostatic voltage profiles in a capacity fixed mode (fixed capacity: 8.0 mA·hour cm-2) of the Zn-air pouch cell with Li₂ZnCl₄·9H₂O electrolyte at the temperature range between 80° C. and −60° C. with a specific current of 0.4 mA cm⁻² and a fixed capacity of 4.0 mA-hour cm⁻². FIG. 4B displays the long-term cycling performance (800 hours) of Zn-air cells at 20° C. and −60° C. at a specific current of 0.4 mA cm⁻². FIG. 4C displays SEM images (left) and corresponding EDX mapping (Zn, O, C and Cl, right) of air cathodes obtained after 10^{th} discharge. FIG. 4D displays corresponding XRD patterns of air cathodes obtained after discharge and charge after 2^{nd} and 10^{th} discharge. FIG. 4E displays schematic snapshots (side view) of the interfacial structures at the air cathodes with positive polarization applied (Charge density q=+0.0128 e/carbon). FIG. 4F displays the free energy change from M05-2X/6-311++G(3df,3pd) calculation with PCM(acetone) and PCM(water) (in parentheses) implicit solvation model for the reaction of hydrated Li₂ZnCl₄ replacing one Cl⁻ with O₂⁻.

FIGS. 5A-5F. FIG. 5A displays an illustration of solution structure in different electrolytes. FIG. 5B displays Raman spectra of Li₂ZnCl₄·RH₂O at the Raman shift range of 100-500 cm⁻¹ and 2,500-4,000 cm⁻¹. FIG. 5C displays the enthalpy changes of a solution that is prepared by mixing LiCl·3H₂O with ZnCl₂·3H₂O (blue points) and a 1 mol kg⁻¹ LiCl—ZnCl₂ solution (black points) with the Li/Zn ratio from 0.5 to 2.5. FIG. 5D displays the activity coefficient of water as a function of water molar fractions estimated by vapor pressure measurement at 22° C. FIG. 5E displays the activity coefficient for Li⁺ (upper) and Zn²⁺ (button) as a function of their concentrations in various aqueous solutions estimated by the equilibrium potential shift of LiₓFePO₄ (x=0.5) and Zn metal electrodes, respectively; FIG. 5F displays the pH values (top) and Coulombic efficiencies (CEs) of Zn plating/strapping (button) for Li₂ZnCl₄·RH₂O and ZnCl₂·RH₂O electrolytes as a function of their water concentrations.

FIGS. 6A-6D. FIG. 6A displays a snapshot from BOMD simulations of Li₂ZnCl₄·6H₂O electrolyte; the Zn—Cl bonds (with Cl⁻ within 2.8 Å of Zn²⁺ ions) are depicted by a ball-and-stick model, while the Li⁺ and water molecules are shown as purple balls and red-white wireframes, respectively. FIG. 6B displays representative configuration of [ZnCl²⁻]ₙ anion chains (green and blue network) extracted from MD simulations of Li₂MClₓ·9H₂O electrolyte. FIG. 6C displays high-energy X-ray scattering spectra of Li₂ZnCl₄·8H₂O, LiCl·3H₂O and ZnCl₂·3H₂O measured by synchrotron and predicated by MD simulation. FIG. 6D displays the small angle neutron scattering (SANS) intensity profile for Li₂ZnCl₄·9D₂O and Li₂ZnCl₄·10D₂O at different temperatures (173K-293K). Throughout this manuscript error bars and uncertainties represent one standard error.

FIGS. 7A-7F. FIG. 7A displays the overall ionic conductivities (solid lines) of LiCl—ZnCl₂—H₂O solutions with different Li/Zn ratios from 0:1 to 1:0 at different temperatures. The glass transition temperatures (T_{g}) measured by DSC were showed as dash line. FIG. 7B displays Arrhenius plots of the overall ionic conductivities of Li₂ZnCl₄·9H₂O high-entropy electrolyte compared with concentrated LiCl·3H₂O, ZnCl₂·3H₂O solutions and diluted (2 mol kg⁻¹) LiCl and ZnCl₂ aqueous solutions. Insert: The hysteresis loops (same colors as in the main figure) for each electrolyte during the measurement cycle with a cooling course (solid cycles, 80° C.→−70° C.), then a heating course (empty cycles, −70° C.→80° C.), with an equilibrium time of 5 hr for each temperature. FIG. 7C displays Walden plot for the Li₂ZnCl₄·9H₂O, LiCl·3H₂O, and ZnCl₂·3H₂O electrolytes at the temperature range from +80 to −70° C. In a Walden plot, electrolyte solutions can be classified in terms of their performance as ionic conductors: superionic (upper left region above the ideal KCl line), good-ionic (on the ideal line), poor-ionic (bottom right region under the ideal line), or non-ionic (far below the ideal line) liquids and solutions. Insert: viscosity of these electrolytes as functions of the temperatures. FIG. 7D displays the transference numbers of Zn²⁺ of Li₂ZnCl₄·RH₂O (R=6-8) at the temperature range from +80 to −70° C., measured by the steady-state current method in a Zn∥Zn symmetric cell. FIG. 7E displays the temperature dependence of mean square displacements of Li₂ZnCl₄·9H₂O, LiCl·3H₂O and ZnCl₂·3H₂O solutions measured by fixed window scan measured with high flux neutron backscattering spectrometer. FIG. 7F displays the Q²-dependence of 1-estimated by quasielastic neutron scattering (QENS) measurements for Li₂ZnCl₄·9H₂O high-entropy electrolyte to probe the relaxations in a wide time ranging from ˜100 ps ns to 2 ns at 200, 220, 240 and 260 K, respectively.

FIGS. 8A-8H. FIG. 8A displays galvanostatic Zn stripping/plating in a Zn/Zn symmetrical cell with Li₂ZnCl₄·9H₂O and ZnCl₂·3H₂O electrolytes at 0.2 mA cm⁻² and temperature range from +80 to −70° C. FIG. 8B displays the voltage profiles of Zn plating/stripping on a Ti working electrode at 0.2 mA cm⁻² and temperature range from +80 to −70° C. Inset: CE of corresponding cycling performance. FIG. 8C displays charge/discharge profiles of ZnₓVOPO₄·2H₂O/Zn punch cell using Li₂ZnCl₄·9H₂O electrolyte at the C/10 rate and different temperatures with capacity ratio of positive/negative electrodes is 1:1.5. FIG. 8D displays the cycling performance of ZnₓVOPO₄·2H₂O/Zn pouch cell using Li₂ZnCl₄·9H₂O electrolyte at 20° C. (C/5 and 4 C, upper), 80° C. and −70° C. (C/10, button). FIG. 8E displays V K-edge XANES spectra of ZnₓVOPO₄·2H₂O cathode obtained ex situ during the 10th discharging process. Inset: Zn K-edge XANES spectra of ZnₓVOPO₄·2H₂O cathode obtained ex situ after the 10th fully discharging (0 V), Zn metal and ZnCl₂ crystal. FIG. 8F displays XRD patterns of the (2 0 0) peak (left) and (3 0 1) peak (right) of the ZnₓVOPO₄·2H₂O cathode obtained in situ during a charge-discharge cycle. The patterns were collected with high-energy X-ray radiation (wavelength of 0.1885 Å) in transmission geometry. FIG. 8G displays GITT characterization of the ZnₓVOPO₄·2H₂O cathode at 20° C. and −70° C., respectively. The bold curve indicates the quasi-equilibrium potential at different lithiation/de-lithiation stages, which was constructed from the average value of each open-circuit voltage period during charge/discharge. FIG. 8H displays the typical full-range voltage profile of the Zn/O2 punch cell with Li₂ZnCl₄·9H₂O electrolyte at the temperature range between 80° C. and −70° C. with a current density of 50 mA g⁻¹ (based on the catalyst mess in cathode).

FIG. 9. FIG. 9 displays Raman spectra of ZnCl₂·3H₂O, ZnCl₂ crystal and LiCl·3H₂O at the Raman shift range of 100-500 cm⁻¹ and 2,500-4,000 cm¹.

FIG. 10. FIG. 10 displays differential scanning calorimeter (DSC, 20° C.-500° C.) of both concentrated (R=3, left) and diluted (1 mol kg⁻¹, right) LiCl and ZnCl₂ mixtures. The molar ratios of ZnCl₂: LiCl are 1:0, 1:1.05, 1:1, 1:1.5, 1:2, 1:2.5 and 0:1.

FIGS. 11A-11B. FIGS. 11A-11B displays snapshots from BOMD simulations of Li₂ZnCl₄·6H₂O and (FIG. 11A) and Li₂ZnCl₄·15H₂O (FIG. 11B) at 450 K. Jmol color scheme is used: Li—purple, Zn—gray, Cl—green, O—red, H—white.

FIGS. 12A-12D. FIGS. 11A-11D displays the evolution of the Zn²⁺ coordination shell (FIGS. 11A-11B) and Li⁺ coordination shell (FIG. 11C-11D) using 2.8 Å the size of the coordination shell from BOMD simulations at 393 K and 450 K. r1-r4 denote different replicas discussed in text.

FIGS. 13A-13B. FIGS. 13A-13B display radial distribution functions (RDFs) from BOMD simulations of Li₂ZnCl₄·6H₂O at 177° C. for replica r4 (FIG. 13A) and Li₂ZnCl₄·15H₂O at 120° C. (FIG. 13B) during the last 30 ps of simulations.

FIGS. 14A-14B. FIGS. 14A-14B display radial distribution functions (RDFs) for Zn²⁺ and Li⁺ with oxygen of water and Cl— from MD simulations using modified AMEOBA force field at 25° C. for Li₂ZnCl₄·6H₂O (FIG. 14A) and Li₂ZnCl₄·9H₂O (FIG. 14B) electrolytes.

FIGS. 15A-15B. FIGS. 15A-15B display the number of water oxygen (O_{w}) and Cl⁻ within 2.8 Å of Zn²⁺ and Li⁺ from MD simulations using modified AMEOBA force field at 25° C. for ZnCl₂·RH₂O (FIG. 15A) and Li₂ZnCl₄·RH₂O (FIG. 15B) electrolytes.

FIG. 16. FIG. 16 displays the fraction of the fully hydrated Li⁺(H₂O)₄ without direct contact with Cl⁻ (within 2.8 Å) denoted as free Li⁺ and degree of uncorrelated ionic motion cd that is often called ionicity in Li₂ZnCl₄·RH₂O electrolytes from MD simulations.

FIG. 17. FIG. 17 displays the Zn—Cl and Zn—Cl—Li aggregates from MD simulations of ZnCl₂·4H₂O and Li₂ZnCl₄·6H₂O electrolytes.

FIGS. 18A-18B. FIGS. 18A-18B display representative clusters extracted from Li₂ZnCl₄·9H₂O MD simulations at 298 K. Showing how small Zn—Cl aggregates are connected with the [Li⁺(H₂O)]ₙ chains (FIG. 18A) with one of the [Li⁺(H₂O)]ₙ chains with shared water highlighted in (FIG. 18B). These aggregates serve as precursors to fractal structures observed in VSANS measurements. Jmol color scheme is used: Li—purple, Zn—gray, Cl—green, O—red, H—white.

FIGS. 19A-19B. FIGS. 19A-19B display the structure factor from X-ray measurements, BOMD DFT simulations (replica r2 over the last 10 ps) and force field-based MD simulations for Li₂ZnCl₄·6H₂O electrolyte (FIG. 19A) and the prime partial contributions to the X-ray weighted structure factor (FIG. 19B) from MD simulations offset up −1.

FIG. 20. FIG. 20 displays the structure factor from X-ray measurements and MD simulations for LiCl·3H₂O electrolyte together with the prime partial contributions to the structure factor from MD simulations offset up −1.

FIGS. 21A-21B. FIGS. 21A-21B display diffusion coefficients and ionic conductivity (k) from MD simulations using modified AMEOBA force field at 298 K for ZnCl₂·RH₂O (FIG. 21A) and Li₂ZnCl₄·RH₂O (FIG. 21B) electrolytes.

FIGS. 22A-22B. FIGS. 22A-22B display very small angle neutron scattering (VSANS) intensity profile for LiCl·3D₂O (FIG. 22A) and ZnCl₂·3D₂O (FIG. 22B) at different temperatures (173K-293K).

FIGS. 23A-23F. FIGS. 23A-23F display low-temperature differential scanning calorimeter (DSC, −120° C.-60° C.) of LiCl and ZnCl₂ mixtures, respectively. The molar ratios of LiCl/ZnCl₂ are (FIG. 23A) 1:0, (FIG. 23B) 4:1, (FIG. 23C) 2:1, (FIG. 23D) 1:1, (FIG. 23E) 1:2, (FIG. 23F) 0:1.

FIG. 24. FIG. 24 the overall ionic conductivities of Li₂ZnCl₄·RH₂O electrolyte from 1 mol kg⁻¹ to R=6 at the temperature range from 80° C. to −70° C.

FIG. 25. FIG. 25 displays the steady-state current method for Zn-ion transference number measurements in a Zn/Zn symmetric cell with Li₂ZnCl₄·9H₂O at different temperatures. The ratios of steady-state and initial currents were calculated for transference numbers when 5 mV of polarization voltages ΔV applied across the cell.

FIGS. 26A-26B. FIGS. 26A-26B display the measured dynamic structure factor as a function of momentum and energy transfer at 260K (FIG. 26A), which were dissociated into elastic mode and quasielastic mode by fittings with delta and Lorentz functions (FIG. 26B).

FIG. 27. FIG. 27 displays an XRD pattern of cycled Zn anodes (after 20 cycles) in Li₂ZnCl₄·9H₂O high-entropy electrolytes. No ZnO or hydroxyl compound were observed.

FIG. 28. FIG. 28 displays cyclic voltammograms (CV) of Ti foil electrode versus Ag/AgCl reference when scanned at 1 mV s⁻¹, wherein the potential has been converted to Li/Li⁺ reference for convenience. Li₂ZnCl₃·9H₂O aqueous electrolyte has a wide electrochemical stability window (2.2V-4.5 V vs. Li⁺).

FIGS. 29A-29C. FIGS. 29A-29C display charge/discharge profiles of different traditional Li-ion intercalation cathodes coupled with Zn metal anodes in Li₂ZnCl₄·9H₂O electrolyte at +20° C. and −70° C.: (FIG. 29A) LiCoO₂ (LCO), (FIG. 29B) LiFePO₄ (LFP), (FIG. 29C) LiMn₂O₄(LMO) at the C/10 rate and different temperatures. The active material loading in cathodes are all around 5 mg cm⁻².

FIGS. 30A-30C. FIGS. 30A-30C display charge/discharge profiles of commercial (FIG. 30A) Li-ion (Nominal cell capacity: 550 mAh), (FIG. 30B) Ni-MH (Nominal cell capacity: 700 mAh), (FIG. 30C) Lead-acid batteries (Nominal cell capacity: 600 mAh) at the C/10 rate and different temperatures.

FIGS. 31A-31D. FIG. 31A displays a schematic of the solvation structures of magnesium chloride (MgCl₂)—aluminum chloride (AlCl₃) based electrolytes in 1,2-dimethoxyethane (DME). FIG. 31B displays Raman spectra of 1.1 mol kg⁻¹ and 5 mol kg-1 MgCl₂—AlCl₃ (1:1) in DME. The bands at 493 (T₂), 348 (A₁), 179 (T₂) and 120 cm-1 (E), which are due to the [AlCl₄]⁻ species in the Td point group. The wide band around 446 and 394 cm⁻¹ are correspond to the OCC and COC bending modes of DME. FIG. 31C displays the voltage profiles of Mg plating/stripping on a Ti working electrode at 0.1 mA cm⁻² and the temperature range from +25 to −60° C. FIG. 31D displays charge/discharge profiles of Mo₆S₈/Mg coin cell using 1.1 mol kg⁻¹ MgCl₂—AlCl₃ (1:1) in DME electrolyte at the C/10 rate and different temperatures.

FIG. 32. FIG. 32 displays the voltage profiles of Mg plating/stripping on a Ti working electrode in 2 mol/L Li₂MgCl₄ in DME and 2 mol/L MgCl₂ in DME electrolytes.

Particular non-limiting embodiments of the present invention will now be described with reference to accompanying drawings.

### DESCRIPTION

All publications mentioned herein are incorporated by reference to the extent they support the present invention.

### 1.0 Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “halogen” or “halo” as used herein by itself or as part of another group refers to chlorine, bromine, fluorine, or iodine.

The term “FSI⁻” refers to the bis(fluorosulfonyl)imide anion, having the formula F₂NO₄S₂⁻.

The term “TFSI⁻” refers to the bistriflimide anion, also known as bis(trifluoromethanesulfonyl)imide, having the formula C₂F₆NO₄S₂⁻.

The term “PF⁻” refers to the hexafluorophosphate anion.

The term “OTf⁻” refers to the triflate anion, also known as trifluoromethanesulfonate, having the formula CF₃SO₃.

The term “DME” refers to dimethoxyethane.

The term “diglyme” refers to bis-(2-methoxyethyl)ether.

The term “triglyme” refers to triethylene glycol dimethyl ether.

The term “tetraglyme” refers to tetraethylene glycol dimethyl ether.

The term “pentaglyme” refers to pentaethylene glycol dimethyl ether.

The term “EA” refers to ethyl acetate.

The term “MA” refers to methyl acetate.

The term “EP” refers to ethylene glycol monopropyl ether.

The term “EC” refers to ethylene carbonate.

The term “EMC” refers to ethyl methyl carbonate.

The term “DMC” refers to dimethyl carbonate.

The term “PC” refers to propylene carbonate.

The term “THF” refers to tetrahydrofuran.

The term “PTHF” refers to polytetrahydrofuran.

The term “MeTHF” refers to 2-methyltetrahydrofuran.

The term “DPE” refers to dipropylene glycol monoethyl ether.

The term “DBE” refers to DBE-4 dibasic ester, also known as dimethyl succinate.

The term “high entropy electrolyte composition” as used herein refers to an electrolyte composition that enables an electrochemical cell or a battery (or the like) to charge and discharged in the temperate range of about −100° C. to about 100° C., in the range of about −80° C. to about 80° C., or in the range of about −60° C. to about 80° C.

It is to be understood that both the foregoing descriptions are exemplary, and thus do not restrict the scope of the invention.

### 2.0 Non-Limiting Embodiments

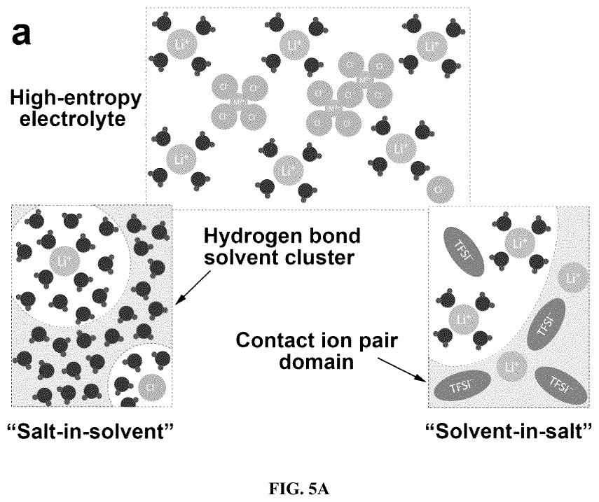

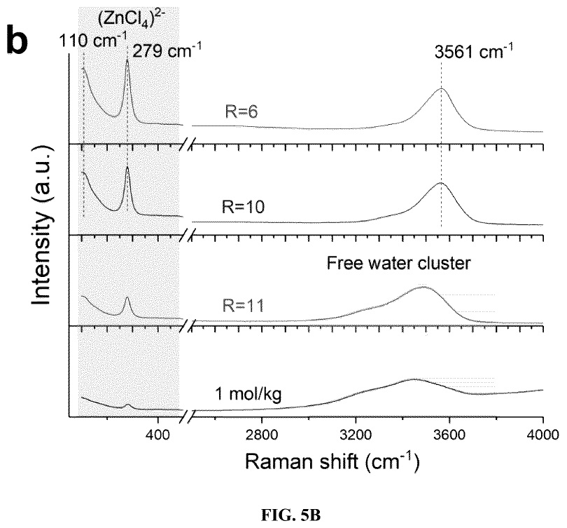

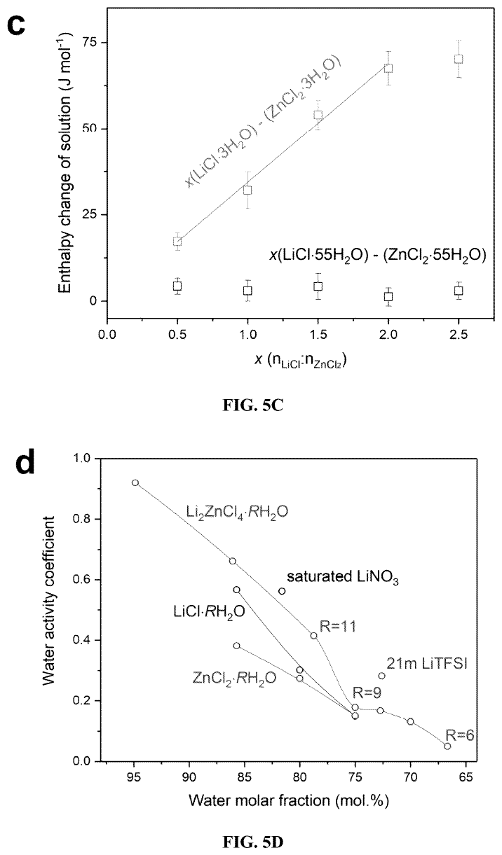

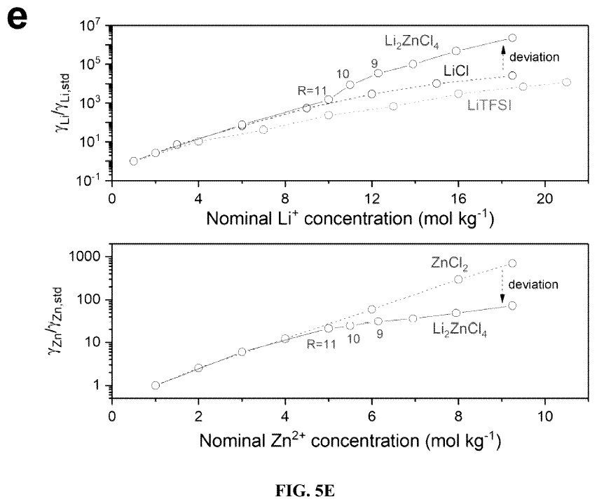

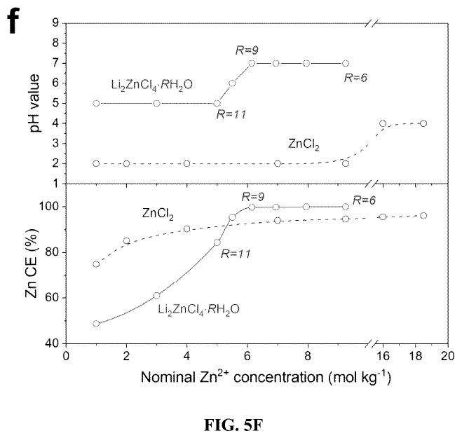

One aspect of the invention pertains to an all temperature multivalent batteries with nano-phase frustrated electrolyte disclosed herein. A high-entropy electrolyte (exemplary embodiment) was designed by creating an asymmetrically solvation structure to trigger maximal frustration of free solvent network and ion-pair aggregation. Firstly, an aqueous high-entropy electrolyte was demonstrated by introducing Lithium chloride (LiCl) as a support salt into a stronger Lewis acid—zinc chloride (ZnCl₂) aqueous electrolyte at a molar ratio of 2:1, where the Cl⁻ was predominantly partitioned from LiCl to ZnCl₂ forming a tetrahedral large anion—ZnCl₄²⁻ or [ZnCl₄^{m-}]ₙ anion networks, while water preferentially coordinates with the supporting cation Li⁺ (FIG. 5A). The hydrated Li⁺ cation—ZnCl²⁻ anion pair size is larger than Bjerrum critical radius in aqueous solution, indicating dissociation of Li⁺ from the ZnCl₄²⁻ complex. Without wishing to be limited to any particular theory, meanwhile the suppressed ion-pairing means that Li⁺ ions remains highly hydrated even in highly concentrated realm, serving as a water sponge to break down the hydrogen bond network of water. This minimizes water activity and prevents ice nucleation at low temperatures. Furthermore, it also avoids the formation of contiguous [ZnCl₄^{m-}]ₙ extended network with another dimension of ordering, which is an issue in concentrated ZnCl₂·RH₂O, by shared Cl to maximize the Zn—Cl coordination. The extra Cl⁻ donated from the LiCl support salt to ZnCl₂ satisfies the desired Zn coordination by 4 Cl⁻, largely eliminating the need to share Cl⁻ between Zn²⁺. Thus, contiguous [ZnCl₄^{m-}]ₙ extended anion networks are broken down to smaller ZnCl₄²⁻ complexes. Such solution structure was formed in Li₂ZnCl₄·9H₂O high-entropy aqueous electrolyte for Zn batteries. To demonstrate the universality of the high-entropy electrolyte, a MgAlCl₅·10DME high-entropy nonaqueous electrolyte for Mg batteries was also investigated. In addition, the performance of high-entropy non-aqueous electrolytes can be further improved by introducing Lithium chloride (LiCl) as a support salt into a stronger Lewis acid—magnesium chloride (MgCl₂) non-aqueous electrolyte. The high-entropy dual-salt electrolyte in both aqueous and nonaqueous systems provided fast active cation transport over a wide liquidus temperature range while eliminating parasitic reaction of solvents, which is impossible for both solvent-in salt and salt in-solvent electrolytes.

Another aspect of the invention pertains to high entropy solvent-in-salt electrolyte composition, said electrolyte composition comprising a combination of a solvent (S) and 2 or more metal salts chosen from M⁺Y⁻, M²⁺Y₂, and M³⁺Y₃, wherein said 2 or more metal salts have different metal cations, and wherein said 2 or more metal salts have different Y ions. Y may be monoanionic. In some embodiments, Y is Cl⁻, Br⁻, I⁻, FSI⁻, TFSI⁻, PF₆⁻, or OTf⁻.

In some embodiments, the metal salts are present in a stoichiometry chosen from M⁺_{z}M²⁺_{3-z}Y_{6-z}, M²⁺_{z}M²⁺_{2-z}Y₄, M⁺_{z}M³⁺_{2-z}Y_{6-2z}, M²⁺_{z}M³⁺_{2-z}Y_{6-z}, or M³⁺_{z}M³⁺_{2-z}Y₆. In further embodiments, the metal salts are present in the stoichiometry M²⁺_{z}M³⁺_{2-z}Y_{6-z}.

In some embodiments, the metal salt has one or more cations chosen from Li⁺, Na⁺, K⁺, Mg²⁺, Ca²⁺, Al³⁺, Zn²⁺, Fe (II), Fe (III), and other transition metals cations.

In some embodiments, the metal salts are chosen from MgCl₂, AlCl₃, ZnCl₂, CaCl₂, LiCl, NaCl, KCl, or a combination thereof. In some embodiments, the metals salts are LiCl and ZnCl₂. The electrolyte composition may comprise a combination of LiCl and ZnCl₂ in a solvent (e.g., water), wherein the number of solvent molecules, R, is in the range of about 5 to about 56. In other embodiments, the metals salts are MgCl₂ and AlCl₃.

The electrolyte composition may have M²⁺_{z}M³⁺_{2-z}Y_{6-z} present in the molar ranges of about 0.1: about 1 to about 1: about 1 for M²⁺Y₂, and M³⁺Y₃, or the concentrations of M²⁺Y₂, and M³⁺Y₃ present in the electrolyte composition in the range of about 0.1 mol/kg to about 1.1 mol/kg.

For example, the electrolyte composition may have MgCl₂ and AlCl₃ present in the molar ranges of about 0.1:1 to about 1:1 for MgCl₂:AlCl₃, or the concentrations of MgCl₂ and AlCl₃ present in the electrolyte composition may be in the range of about 0.1 mol/kg to about 1.1 mol/kg.

Various solvents may be used for the electrolyte composition. In some embodiments, the solvent may be chosen from water, dimethoxyethane, diglyme, triglyme, pentaglyme, tetraethyleneglycol, ethyl acetate, methyl acetate, ethylene glycol monopropyl ether, ethylene carbonate, ethyl methyl carbonate, dimethylcarbonate, propylene carbonate, tetrahydrofuran, polytetrahydrofuran, 2-methyltetrahydrofuran, dipropylene glycol monoethyl ether, and dimethyl succinate.

In some embodiments, the electrolyte composition comprises MgAlCl₅·10DME. In further embodiments, the electrolyte composition further comprises LiCl.

In some embodiments, the electrolyte composition stoichiometry may also comprise a number, R, of solvent molecules. R may be in the range of about 10 to about 220, or in the range of about 10 to about 200, or in the range of about 6 to about 55. In some embodiments, the solvent is water. In other embodiments, the solvent is dimethoxyethane.

In some embodiments, M⁺ is Li⁺. In some embodiments, M²⁺ is Zn²⁺. In other embodiments, Y is chloride. The electrolyte composition may have a z value in the range of 1-3. In some embodiments, z is 2. In further embodiments, the electrolyte composition comprises Li₂ZnCl₄·9H₂O.

Another aspect of the invention pertains to a high entropy solvent-in-salt electrolyte composition, said composition comprising a solvent (S) and two or more metal salts chosen from M⁺Y and M²⁺Y₂, wherein the composition has a stoichiometry of M⁺₂M²⁺Y₄·R.S (e.g., M⁺₂M²⁺Y₄—RH₂O), wherein S is solvent. In some embodiments, M is chosen from Li, Na, K, Mg, Ca, Al, Zn, or combinations thereof. In other embodiments, Y is chosen from Cl⁻, Br⁻, I⁻, FSI⁻, TFSI⁻, PF₆⁻, OTf⁻. In further embodiments, R is in the range of 6 to 18, or in the range of 8 to 12. In some embodiments R is 6. In other embodiments, R is 9. Various solvents may be used for the electrolyte composition. In some embodiments, the solvent is chosen from water, dimethoxyethane, diglyme, triglyme, pentaglyme, tetraethyleneglycol, ethyl acetate, methyl acetate, ethylene glycol monopropyl ether, ethylene carbonate, ethyl methyl carbonate, dimethylcarbonate, propylene carbonate, tetrahydrofuran, polytetrahydrofuran, 2-methyltetrahydrofuran, dipropylene glycol monoethyl ether, and dimethyl succinate.

An additional aspect of the invention pertains to a battery, said battery comprising a cathode, an anode, and an electrolyte composition of any of the preceding embodiments. In some embodiments, the cathode comprises Mo₆S₈ and the anode comprises Mg metal. In some embodiments, the cathode comprises Zn and the anode comprises Zn, forming a Zn symmetric cell. In some embodiments, the cathode comprises ZnₓVOPO₄·2H₂O, manganese oxide, vanadium oxide, or a combination thereof, and the anode comprises Zn metal. In some embodiments, the cathode comprises (Pt—C) catalyst loaded porous carbon and the anode comprises Zn metal.

In some embodiments, the operating temperature of the battery is in the range of about −100° C. to about 100° C., or in the range of about −80° C. to about 80° C., or in the range of about −60° C. to about 80° C.

The battery of the preceding embodiments may also further comprise a separator material. In some embodiments, the separator material comprises polyethylene, polypropylene, polyimides, polyamides, cellulose, silica-based fiber, or a combination thereof. In further embodiments, the separator material is chosen from CELGARD 2325®, CELGARD 3501®, CELGARD 2500®, or CELGARD PP1410®.

In some embodiments, the battery is a coin cell type battery. In other embodiments, the battery is a pouch type battery.

One aspect of the invention pertains to a method for making a battery assembly comprising combining multiple layers of cathode, electrolyte, and anode. Another aspect of the invention pertains to a method of assembling a battery of any of the preceding embodiments, said method comprising layering a cathode, an electrolyte of any of the preceding embodiments, and an anode to obtain multiple layers, wherein said cathode, then said electrolyte, then said anode are layered; placing a separator between the cathode and the anode, wherein said cathode, then said electrolyte, then anode and said separator are sealed (e.g., mechanically sealed) in a battery casing. An additional aspect of the invention pertains to a method of supplying power, said method comprising using a battery of any of the preceding claims to supply a voltage in the range of about 0.6 V to about 2 V upon discharging within the operational temperature ranges of about −70° C. to about 80° C.

### LIST OF EMBODIMENTS

The following is a list of non-limiting embodiments:
1. A high entropy solvent-in-salt electrolyte composition (e.g., nano-phase frustrated electrolyte), said electrolyte composition comprising a combination of a solvent (S) and 2 or more metal salts chosen from M⁺Y⁻, M²⁺Y₂, and M³⁺Y₃,
   wherein said 2 or more metal salts have different metal cations, and
   wherein said 2 or more metal salts have different Y ions.
2. The electrolyte composition of embodiment 1, wherein metal salts are in present in a stoichiometry chosen from M⁺_{z}M²⁺_{3-z}Y_{6-z}, M²⁺_{z}M²⁺_{2-z}Y₄, M⁺_{z}M³⁺_{2-z}Y_{6-2z}, M²⁺_{z}M³⁺_{2-z}Y_{6-z}, or M³⁺_{z}M³⁺_{2-z}Y₆.
3. The electrolyte composition of embodiment 1, wherein said metal salt has one or more cations chosen from Li⁺, Na⁺, K⁺, Mg²⁺, Ca²⁺, Al³⁺, Zn²⁺, Fe (II), Fe (III), and other transition metals cations.
4. The electrolyte composition of embodiment 1, wherein Y is monoanionic.
5. The electrolyte composition of embodiment 1, wherein Y is Cl⁻, Br⁻, I⁻, FSI⁻, TFSI⁻, PF₆⁻, or OTf⁻.
6. The electrolyte composition of embodiment 1, wherein said metal salts are chosen from MgCl₂, AlCl₃, ZnCl₂, CaCl₂, LiCl, NaCl, and KCl.
7. The electrolyte composition of embodiment 1, wherein the metal salts are LiCl and ZnCl₂.
8. The electrolyte composition of embodiment 7, wherein the composition comprises a combination of LiCl and ZnCl₂ in a solvent (e.g., water), wherein the number of solvent molecules, R, is in the range of about 5 to about 56.
9. The electrolyte composition of embodiment 1, wherein the metal salts are MgCl₂ and AlCl₃.
10. The electrolyte composition of embodiment 9, wherein MgCl₂ and AlCl₃ are at present at a molar ratio in the range of about 0.1:1 to about 1:1 for MgCl₂:AlCl₃.
11. The electrolyte composition of 1, wherein the concentrations of MgCl₂ and AlCl₃. are present in the range of about 0.1 mol/kg to about 1.1 mol/kg.
12. The electrolyte composition of embodiment 1, wherein the solvent (S) is chosen from water, dimethoxyethane, diglyme, triglyme, pentaglyme, tetraethyleneglycol, ethyl acetate, methyl acetate, ethylene glycol monopropyl ether, ethylene carbonate, ethyl methyl carbonate, dimethylcarbonate, propylene carbonate, tetrahydrofuran, polytetrahydrofuran, 2-methyltetrahydrofuran, dipropylene glycol monoethyl ether, and dimethyl succinate.
13. The electrolyte composition of any of the preceding embodiments, wherein the electrolyte composition comprises MgAlCl₅·10DME.
14. The electrolyte of composition of embodiment 13, wherein said composition further comprises LiCl.
15. The electrolyte composition of embodiment 2, wherein metal salts are in a stoichiometry chosen from M²⁺_{z}M³⁺_{2-z}Y_{6-z}.
16. The electrolyte composition of any of the preceding embodiments, wherein each stoichiometry comprises one or more solvent molecules (R). As used herein, the term “R” refers to the number of solvent molecules associated with said metal salt(s) in said compositions disclosed herein. For instance, R for compositions comprising a combination of LiCl and ZnCl₂ in a solvent (e.g., water) may be in the range of about 6 to about 56. In another example, a stoichiometry such as M⁺_{z}M²⁺_{3-z}Y_{6-z} in a solvent may have a value for R in the range of about 6 to about 56.
17. The electrolyte composition of any of the preceding embodiments, wherein R is in the range of about 10 to about 200.
18. The electrolyte composition of any of the preceding embodiments, wherein the solvent is water.
19. The electrolyte composition of any of the preceding embodiments, wherein R is in the range of about 6 to about 56.
20. The electrolyte composition of any of the preceding embodiments, wherein the solvent is dimethoxyethane.
21. The electrolyte composition of any of the preceding embodiments, wherein R is in the range of about 10 to about 220, or about 8 to about 56.
22. The electrolyte composition of any of the preceding embodiments, wherein M⁺ is Li⁺.
23. The electrolyte composition of any of the preceding embodiments, wherein M²⁺ is Zn²⁺.
24. The electrolyte composition of any of the preceding embodiments, wherein Y is chloride.
25. The electrolyte composition of any of the preceding embodiments, wherein z is 1-3.
26. The electrolyte composition any of the preceding embodiments, wherein z is 2.
27. The electrolyte composition of any of the preceding embodiments, wherein the electrolyte composition comprises Li₂ZnCl₄·9H₂O.
28. A high entropy solvent-in-salt electrolyte composition, said composition comprising a solvent (S) and two or more metal salts chosen from M⁺Y and M²⁺Y₂, wherein the composition has a stoichiometry of M⁺₂M²⁺Y₄·R.S (e.g., M⁺₂M²⁺Y₄—RH₂O), wherein S is solvent.
29. The electrolyte composition of embodiment 28, wherein M is chosen from Li, Na, K, Mg, Ca, Al, and Zn.
30. The electrolyte composition of embodiment 28, wherein Y is chosen from Cl⁻, Br⁻, I⁻, FSI⁻, TFSI⁻, PF₆⁻, OTf⁻.
31. The electrolyte composition of embodiment 28, wherein R is 6-18.
32. The electrolyte composition of embodiment 28, wherein R is 8-12.
33. The electrolyte composition of embodiment 28, wherein R is 6.
34. The electrolyte composition of embodiment 28, wherein R may be 9.
35. The electrolyte composition of embodiment 28, wherein the solvent (S) is chosen from water, dimethoxyethane, diglyme, triglyme, pentaglyme, tetraethyleneglycol, ethyl acetate, methyl acetate, ethylene glycol monopropyl ether, ethylene carbonate, ethyl methyl carbonate, dimethylcarbonate, propylene carbonate, tetrahydrofuran, polytetrahydrofuran, 2-methyltetrahydrofuran, dipropylene glycol monoethyl ether, and dimethyl succinate.
36. A battery, said battery comprising a cathode, an anode, and an electrolyte composition of any of the preceding embodiments. For example, said battery is an all temperature multivalent battery (e.g. with nano-phase frustrated electrolyte of any of the preceding embodiments).
37. The battery of embodiment 36, wherein the cathode comprises Mo₆S₈ and the anode comprises Mg metal.
38. The battery of embodiment 36, wherein the cathode and anode comprises Zn metal, forming a Zn symmetric cell.
39. The battery of embodiment 36, wherein the cathode comprises ZnₓVOPO₄·2H₂O, manganese oxide, vanadium oxide, or a combination thereof, and the anode comprises Zn metal.
40. The battery of embodiment 36, wherein the cathode comprises (Pt—C) catalyst loaded porous carbon and the anode comprises Zn metal.
41. The battery of the preceding embodiments, wherein the operating temperature of the battery is in the range of about −100° C. to about 100° C., about −80° C. to about 80° C., or about −60° C. to about 80° C.
42. The battery of any of the preceding embodiments further comprising a separator material, wherein the separator material may be polyethylene, polypropylene, polyimides, polyamides, cellulose, silica-based fiber, or a combination thereof.
43. The battery of embodiment 42, wherein the separator material may be CELGARD 2325®, CELGARD 3501®, CELGARD 2500®, or CELGARD PP1410®.
44. The battery of any of embodiments 37 and 38, wherein the battery is a coin cell type battery.
45. The battery of any of embodiments 39 and 40, wherein the battery is a pouch type battery.
46. A method for making a battery assembly comprising combining multiple layers of cathode, electrolyte, and anode.
47. A method of assembling a battery of any of the preceding embodiments, said method comprising layering a cathode, an electrolyte of any of the preceding embodiments, and an anode to obtain multiple layers, wherein said cathode, then said electrolyte, then said anode are layered;
   placing a separator between the cathode and the anode,
   wherein said cathode, then said electrolyte, then anode and said separator are sealed (e.g., mechanically sealed) in a battery casing.
48. A method of supplying power, said method comprising using a battery of any of the preceding claims to supply a voltage in the range of about 0.6 V to about 2 V upon discharging within the operational temperature ranges of about −100° C. to about 100° C. or about −70° C. to about 80° C.

### 3.0 Examples

The following examples are provided solely to illustrate the present invention and are not intended to limit the scope of the invention, described herein. Further aspects of the invention are described in the following: Nature Sustainability, 6, 325-335 (2023), “High-Entropy Electrolyte Enabled All-Temperature Rechargeable Batteries” (in press), and “All-Temperature Multivalent Batteries with Nano-Phase Frustrated Electrolyte” (in press), which are hereby incorporated by reference.

### Example 1. Properties of Nano-Phase Frustrated Li₂ZnCl₄·9H₂O Electrolytes

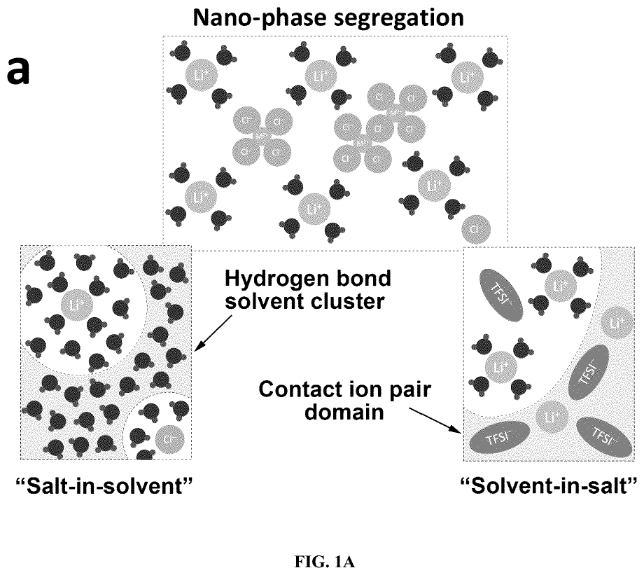

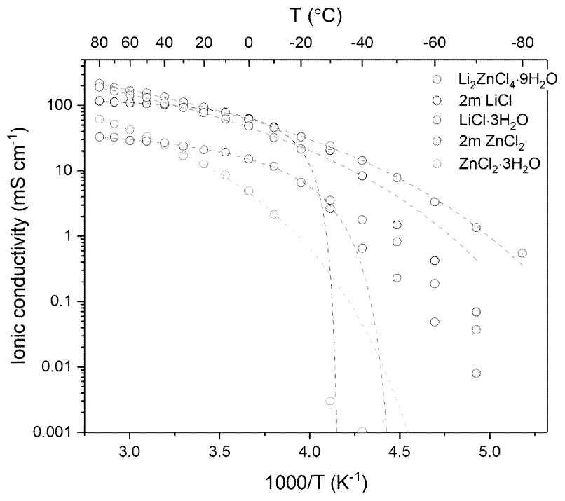

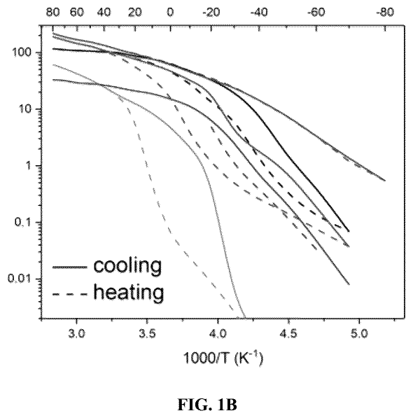

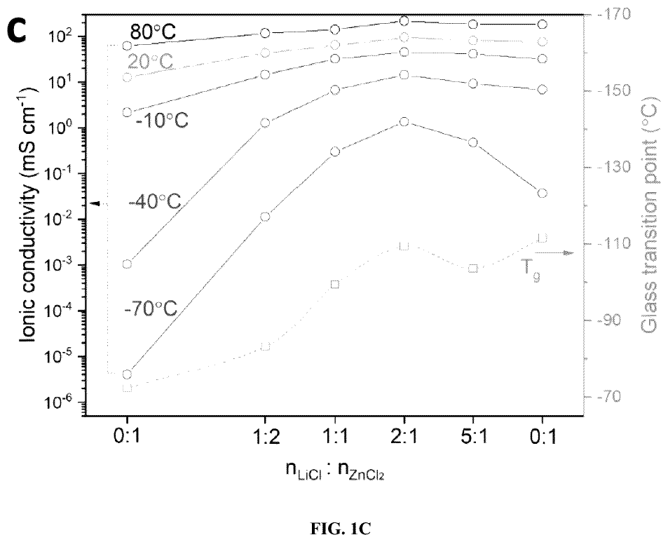

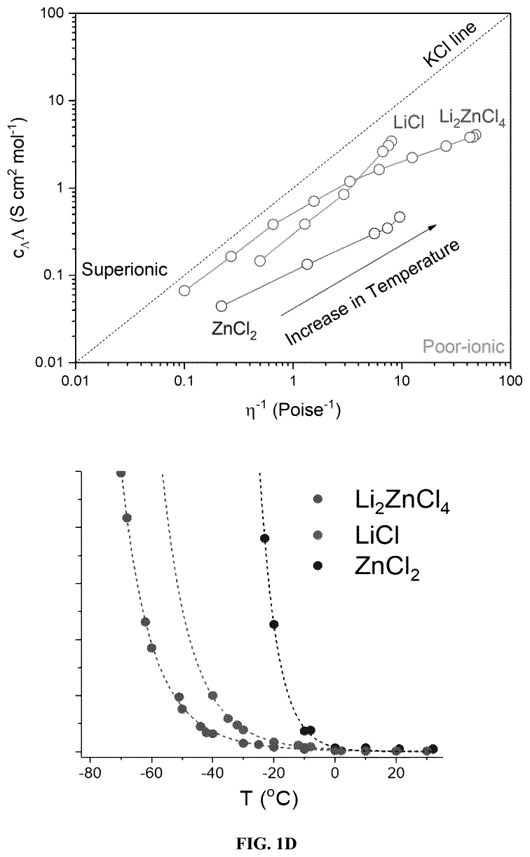

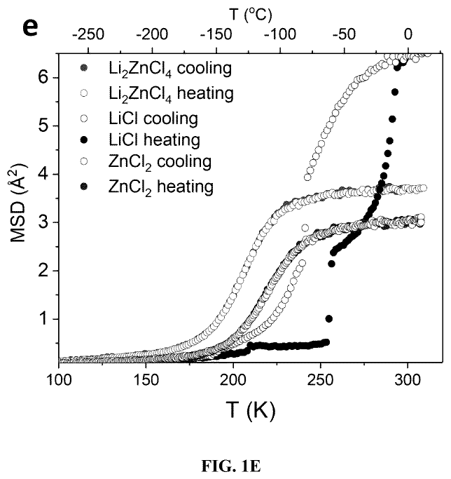

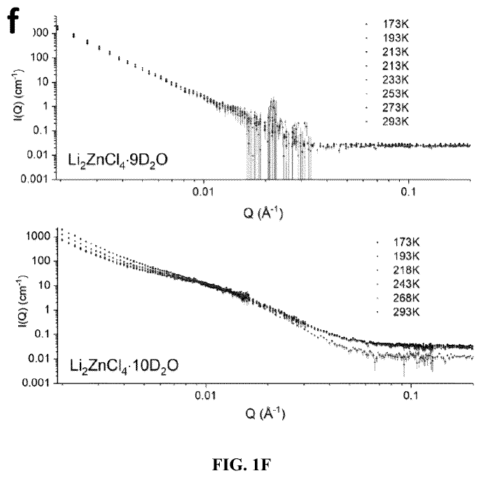

Both free solvent network and ion-pair aggregation were simultaneously frustrated by forming a nano-phase segregated structure through adding a support salt. As a proof-of-concept, lithium chloride (LiCl) is introduced as a supporting salt into a stronger Lewis acid-zinc chloride (ZnCl₂) aqueous electrolyte at a 2:1 molar ratio, where the Cl⁻ was preferentially partitioned from LiCl to ZnCl₂ forming small ZnCl₄²⁻ anions or [ZnCl₄^{m-}]ₙ anion networks while water preferentially coordinates with the supporting cation Li⁺ (middle of FIG. 1A). The hydrated Li⁺ cation—ZnCl₄²⁻ anion pair size is larger than Bjerrum critical radius in aqueous solution, indicating dissociation of Li⁺ from the ZnCl₄²⁻ complex. Meanwhile, the suppressed ion-pairing means that Li⁺ remains highly hydrated even in the highly concentrated regime, serving as a water sponge to break down the hydrogen bond network of water. FIG. 1B shows the extraordinary conductivity retention of Li₂ZnCl₄·9H₂O electrolyte in a temperature range from +80 to −80° C., comparing to single salt aqueous electrolyte of LiCl·3H₂O or 2 M ZnCl₂·3H₂O with the same salt/water ratio=1:3, and their diluted versions with molar concertation of 2 mol/kg. The ionic conductivity Li₂ZnCl₄·9H₂O exactly followed the VTF equation across the whole temperature range, dropping from 200 mS·cm⁻¹ at +80° C. to 1.36 and 0.66 mS·cm⁻¹ at the ultra-low temperatures of −70 and −80° C., respectively, which is superior to the most aqueous and non-aqueous electrolytes developed for low temperature operations. Its Vogel temperature, To, equal to the glass transition in ideal glasses, is 12° C. lower than the measured T_{g} (−109° C.). This suggests that Li₂ZnCl₄·9H₂O is a fragile glass-former without any crystalline phase transition of water or salt in this temperature range, which is quite rare in aqueous systems. As a result, Li₂ZnCl₄·9H₂O is the only electrolyte without any thermal hysteresis in cooling-heating cycle between +80 to −80° C. (red line in insert of FIG. 1B), which is tied to battery performance in harsh environments. Further studies of various concentrated Li₂ZnCl₄·RH₂O electrolyte system showed similar ionic conductivity with R from 6 to 18. The transference number t_{Zn} and t_{Li} at room temperature was found to range from 0.41 to 0.25 for R=9 and R=6 in Li₂ZnCl₄·RH₂O at 20° C. Interestingly, these values decrease slowly with temperature. This large portion of Zn contribution to overall conductivity is likely due to high mobility of [ZnCl₄]²⁻ and back diffusion of Cl⁻ and/or fast moving (LiCl₂)⁻ complexes.

Li₂ZnCl₄·RH₂O electrolytes show unexpected properties due to the unique solvation structure. The overall ionic conductivities of LiₓZn₃₋ₓCl₆₋ₓ·9H₂O with different molar ratios of LiCl:ZnCl₂ and at different temperatures (FIG. 1C) were evaluated. Li₂ZnCl₄·9H₂O (n_{LiCl}:n_{ZnCl2}=2) showed the highest ionic conductivity in the temperature range from +20° C. to −70° C. (FIG. 1C), which also agreed with the T_{g} (yellow dash line in FIG. 1C) measured using differential scanning calorimetry. The extra Cl⁻ donated from the LiCl supporting salt to ZnCl₂ satisfies the desired Zn coordination by 4 Cl⁻ to form ZnCl₄²⁻ anions, largely eliminating the need to share Cl⁻ between Zn²⁺. So it avoids the formation of a contiguous [ZnCl₄⁻²⁺ⁿ]ₘ extended network with another dimension of ordering, which is an issue in concentrated single-salt ZnCl₂·RH₂O, resulting in a high degree (˜0.5) of ion uncorrelated motion (ionicity) at room temperature. The redistribution of Cl⁻ (from Li⁺ to Zn²⁺) and H₂O (from Zn²⁺ to Li⁺) reaches to a maximum value at the LiCl/ZnCl₂ ratio of 2:1, delivering ultimate dissociation of LiCl salt, [ZnCl₄₋ₙ⁻²⁺ⁿ]ₘ aggregates and disruption of the hydrogen-bond network.

Due to the maximized cation-anion dissociation, the Li₂ZnCl₄·RH₂O electrolytes also show a low viscosity that were separated from following the Walden rule. The Walden plots in FIG. 1D showed that, at room temperature, Li₂ZnCl₄·9H₂O shows sub-ionic behavior in accord with the highly concentrated aqueous systems, due to ion-pairing. However, the plot of Li₂ZnCl₄·9H₂O approaches the ideal “KCl line” as temperature (or η⁻¹) decreases. This indicates that after eliminating ice nucleation and salt recrystallization, charge motion in Li₂ZnCl₄·9H₂O electrolyte becomes less correlated translating to the superior transport properties at ultra-low temperatures.

The dynamics of water in Li₂ZnCl₄·9H₂O, LiCl·3H₂O and ZnCl₂·3H₂O electrolytes on time scales of ˜100 ps-2 ns was probed using high flux neutron backscattering spectrometry (HFBS) to understand the water behavior in a low temperature. As shown FIG. 1E, water mean square displacement (MSD) in Li₂ZnCl₄·9H₂O is more or less constant down to −50° C. followed by a small drop of MSD as temperature further decreased to T_{g} at −110° C. By contrast, the MSDs of LiCl·3H₂O and ZnCl₂·3H₂O started to drop when temperature drop to below −25° C., which correlate with their deviations from VTF behavior (FIG. 1B). MSD for LiCl·3H₂O showed hysteresis due to water crystallization observed at −30° C. in cooling and melting at −10° C. in heating in accordance with the hysteresis of conductivity (FIG. 1B insert), while both Li₂ZnCl₄·9H₂O and ZnCl₂·3H₂O showed no hysteresis during the cooling and heating cycle. So, the hysteresis in ionic conductivity observed for ZnCl₂·3H₂O (insert in FIG. 1b) is due to changes of the [ZnCl₄₋ₙ⁻²⁺ⁿ]ₘ aggregates not correlated with water MSD.

The subtle microscopic structure changes of water in low temperature are also evaluated using small angle neutron scattering (SANS) by using D₂O to enhance sensitivity. FIG. 1F demonstrated that Li₂ZnCl₄·9D₂O and Li₂ZnCl₄·10D₂O electrolytes show a typical power law behavior at low Q (wave vector transfer of neutron), indicative of a homogeneous fractal structure at length scales of >100 nm and larger. The linear (in log-log scale) scattering profiles for Li₂ZnCl₄·9D₂O electrolyte showed no temperature dependence during cooling from 293K to 173 K, indicating that a homogeneous liquid phase remained, and no ice nucleation occurred in the whole investigated temperature range. As reference, sudden changes happened below 213 K for LiCl·3D₂O and ZnCl₂·3D₂O, which correlated with the observed changes in ionic conductivity (FIG. 1B) and dynamic measurements (FIG. 1E).

### Example 2. Structure of Nano-Phase Frustrated Li₂ZnCl₄·RH₂O Electrolyte

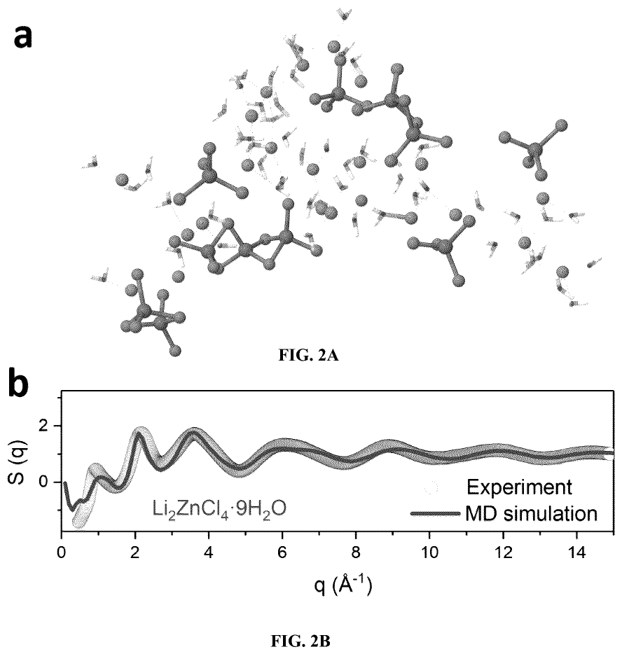

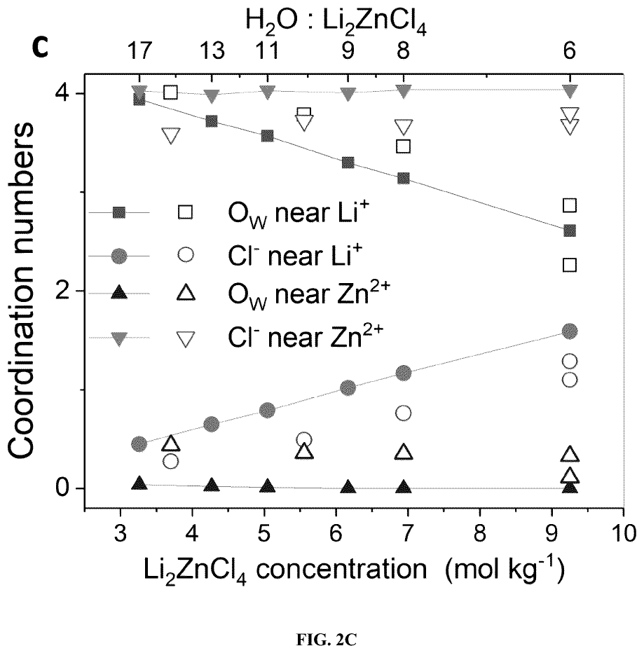

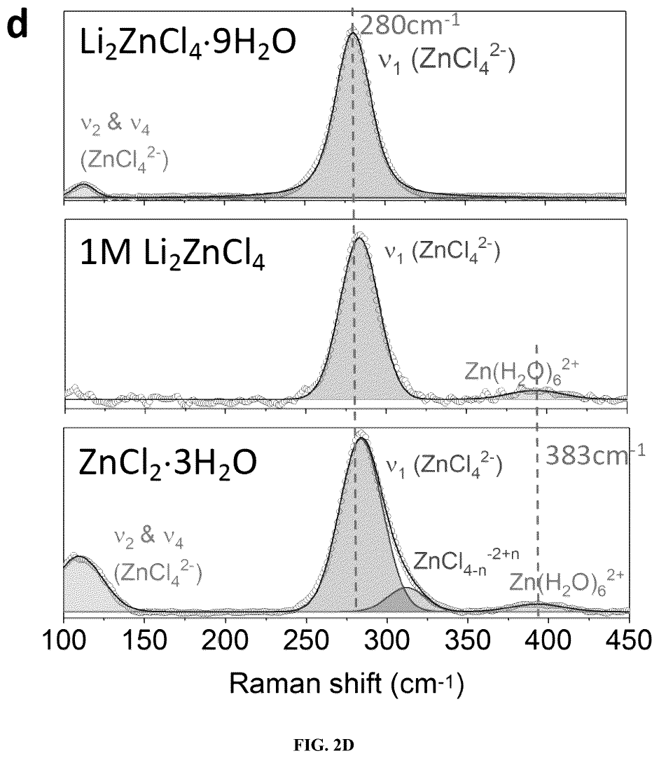

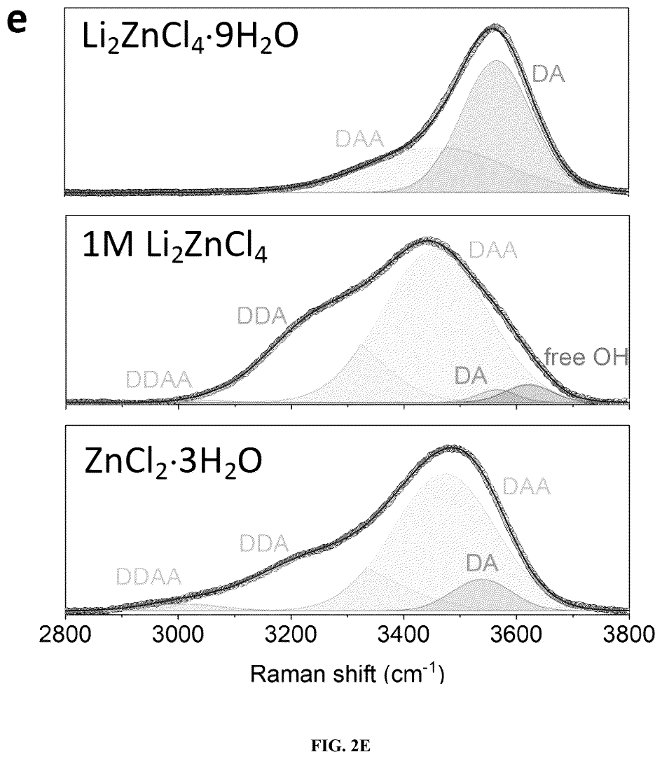

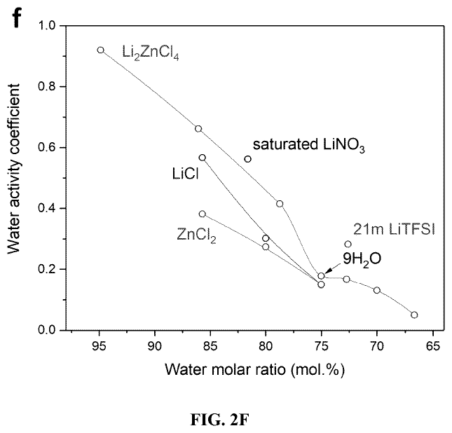

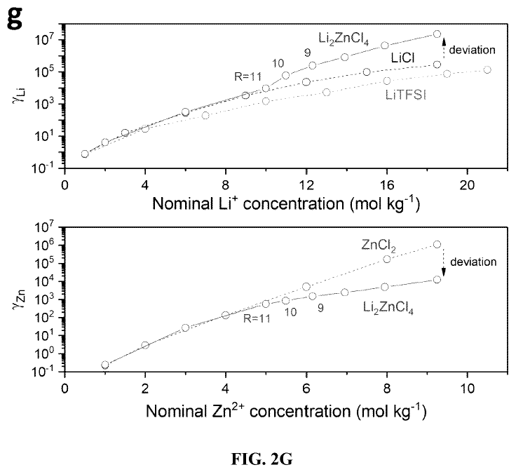

Density functional theory (DFT)-based Born-Oppenheimer Molecular Dynamics (BOMD) simulations and force field-based MD simulations provided further insight into the structure and transport for single salt and bi-salt electrolytes (FIG. 2A). The structure of Li₂ZnCl₄·9H₂O, Li₂ZnCl₄·6H₂O, and LiCl·3H₂O electrolytes predicted by MD simulations was in excellent agreement with high-energy X-ray scattering measurements. (FIG. 2B). BOMD and MD simulations of Li₂ZnCl₄·RH₂O showed the Zn—Cl coordination number staying at 4 independent on water concentration for R between 15 and 6 (green line in FIG. 2C), while barely any water (˜0-0.2) is observed in the first solvation shell of Zn (blue line in FIG. 2C). ZnCl₂·RH₂O (R=6-17) single salt electrolyte also showed a preference of Zn for Cl approaching over water in its first solvation shell, in good agreement with previous reports. However, water is not completely excluded from the Zn²⁺ solvation shell in single salt electrolyte with Zn²⁺ being hydrated by 0.4-1.0 waters in ZnCl₂·RH₂O. In Li₂ZnCl₄·RH₂O, it is not required for Zn²⁺ to share Cl⁻ with tetrahedral Cl⁻ coordination due to availability of extra Cl⁻ donated by LiCl to ZnCl₂. Thus, the extended [ZnCl₄^{m-}]ₙ ionic networks in ZnCl₂·RH₂O break up into smaller anions [ZnCl₄]²⁻. However, they are bridged via the halogen and mobile Li⁺ hydrates that as a “water sponges” in Li₂ZnCl₄·RH₂O. The number of coordinated Cl⁻ with Li⁺ showed an increase with increasing salt concentration and remained below 1.3 even for the most concentrated electrolyte (R=6), which indicated a maximized dissociation of Li⁺— ZnCl₄²⁻ pairs.

The formation of [ZnCl₄]²⁻ complex anion and hydrated Li⁺ cation in Li₂ZnCl₄·RH₂O electrolytes were confirmed by Raman spectroscopy between 100 cm⁻¹-450 cm⁻¹ (FIG. 2D). Two fitted Gaussian peaks at 110 cm⁻¹ (component of v₂ and v₄ modes) and 280 cm⁻¹ (v₁ modes) in Li₂ZnCl₄·9H₂O were assigned to the characteristic vibrational mode of zinc tetrachloride —[ZnCl₄]²⁻. Crucially, the Zn—O peak attributed to [Zn(OH₂)₆]²⁺ at 383 cm⁻¹ is absent in Li₂ZnCl₄·9H₂O. When salt was diluted to 1 mol/kg, the [ZnCl₄]²⁻ v₁ modes are still dominant but shifted slightly to 283 cm⁻¹ and a small peak at 383 cm⁻¹ related to the hexahydrate species appears. Interestingly, ZnCl₂·3H₂O still showed the same [Zn(OH₂)₆]²⁺ peak even though the Zn²⁺:H₂O ratio increased to 1:3 along with an extra peak for v₁ modes of [ZnCl₄₋ₙ]⁻²⁺ⁿ(ZnCl₂ or ZnCl₃⁻). The coexistence of hydrated Zn²⁺ and di-, tri-, and tetrachloro complexes in the ZnCl₂ electrolyte confirmed the lack of sufficient Cl⁻ to satisfy tetrahedral ZnCl₄²⁻ which drives formation of large Zn—Cl network aggregates as predicted by BOMD simulation. The Raman band between 2,800 cm⁻¹-3,800 cm⁻¹ shows the O—H stretching vibration modes of water molecules (FIG. 2E). In dilute solution (1 mol kg⁻¹), the O—H stretching vibration exhibited the same broad Raman band as the pure water, which is attributed to five hydrogen-bonding environments: DDAA (double donor-double acceptor), DDA (double donor-single acceptor), DAA (single donor-double acceptor), DA (single donor-single acceptor), and free OH in free water clusters. The double proton donor mode (DDAA and DDA) can only exist in the hydrogen-bond network of free water clusters. In Li₂ZnCl₄·9H₂O, only DAA and enhanced DA peaks are observed, indicating that most of water was confined in the first solvation shell of Li⁺. Different from the 28 M LiTFSI—LiOTf “water-in-bisalt” and highly concentrated ZnCl₂·RH₂O electrolytes, Li₂ZnCl₄·RH₂O can stabilize water even at a low Li⁺:H₂O ratio (1:5) or a low cation:H₂O ratio (3:10). The strong dissociation of Li⁺/ZnCl₄²⁻ ion-pairs and more sufficient water solvation was also confirmed by the enthalpy change of solution during the mixing of LiCl and ZnCl₂ aqueous solutions at a fixed cation:H₂O ratio. An average energy of 36 joules per mole of water was released when LiCl·3H₂O was added to ZnCl₂·3H₂O until the Li:Zn ratio reached 2:1. As a reference, negligible enthalpy differences were detected in dilute dual-salt solutions and the single salt aqueous systems. The enthalpy change of mixing results from the redistribution of Cl⁻ and H₂O associations effectively suppressing Li⁺/ZnCl₄²⁻ ion-pairing and increasing hydration of Li⁺, making electrolyte more thermodynamically stable.

The rearrangement of the local solvation structure in the electrolyte is further studied by examining the activity coefficients of the water and cations. Water activity coefficients of Li₂ZnCl₄·RH₂O were measured from the vapor pressures ratio of Li₂ZnCl₄·RH₂O solutions to the saturated vapor pressure of pure water at 22° C. (2.69 kPa). FIG. 2F shows the dependence of the water activity coefficient on the mole fraction of water in Li₂ZnCl₄·RH₂O solutions. These coefficients may be overestimated because the complex salt Li₂ZnCl₄ is treated as two LiCl and one ZnCl₂ in the calculation of the water mol fraction. Despite this overestimation, the water in Li₂ZnCl₄·RH₂O (R≤9) exhibited much lower activity coefficients than LiCl—H₂O, ZnCl₂—H₂O and 21 m LiTFSI-H₂O, which are normally considered as highly hydrated systems. As water molar concentration decreases from 95 mol % to 67 mol %, equivalents to that salt concentration increase from 1.0 mol kg⁻¹ to 18.5 mol kg⁻¹ (Li₂ZnCl₄·6H₂O), the vapor pressure of water drops from 2.33 kPa to 0.088 kPa, and the water activity coefficient decreases from 0.92 to 0.09 (line in FIG. 2F) because of a sufficient hydration effect in the Li⁺ “sponge”. The reduced water activity largely serves to suppress freezing or boiling in Li₂ZnCl₄·RH₂O (R≤9) electrolytes as shown in the thermal analysis in FIG. 1.

The activity coefficient γ of Li⁺ and Zn²⁺ in Li₂ZnCl₄·RH₂O electrolytes were also estimated by the equilibrium potential of Li_{0.5}FePO₄ and Zn metal electrodes, respectively (FIG. 2G). Remarkably, the γ_{Li} in Li₂ZnCl₄·6H₂O are 5×10⁵ times higher than that in 1.0 mol kg⁻¹. The large increase in γ has been observed previously in other highly concentrated aqueous solutions and is closely related to the changes of electrolyte solvation structure. Such a trend is beyond the scope of conventional Debye-Hückel theory but can be rationalized qualitatively through the Stokes and Robinson hydration effect. The mean ionic activity increases with decreasing water activity. More interestingly, the increase rate of γ_{Li} for Li₂ZnCl₄·6H₂O (R<11) is much larger than that in LiCl solutions, while γ_{Zn} in Li₂ZnCl₄·6H₂O increases slower than that in ZnCl₂ solutions (FIG. 2G). The large difference in Li/Zn-ion activity between single-ion and dual-ion electrolytes is attributed to effectively suppressing the formation of LiCl ion pairs and Zn—H₂O contacts in Li₂ZnCl₄·RH₂O as the dissociated Li—Cl donates Cl⁻ to Zn²⁺, thus freeing up water from Zn²⁺ solvation shell to hydrate Li⁺ as observed in MD simulations.

### Example 3. Electrochemical Behavior of the Zn Anodes in Li₂ZnCl₄·9H₂O Electrolyte

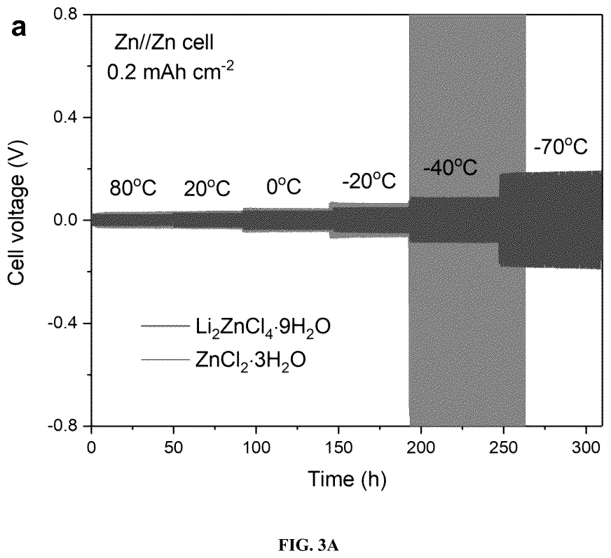

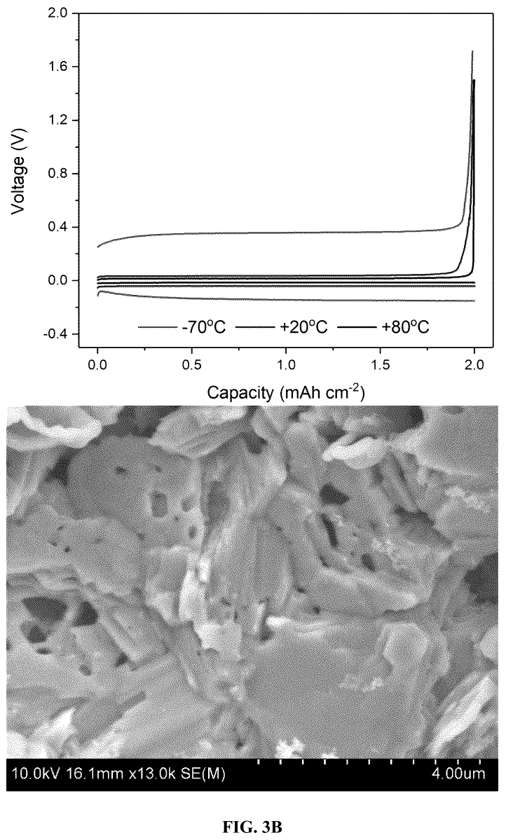

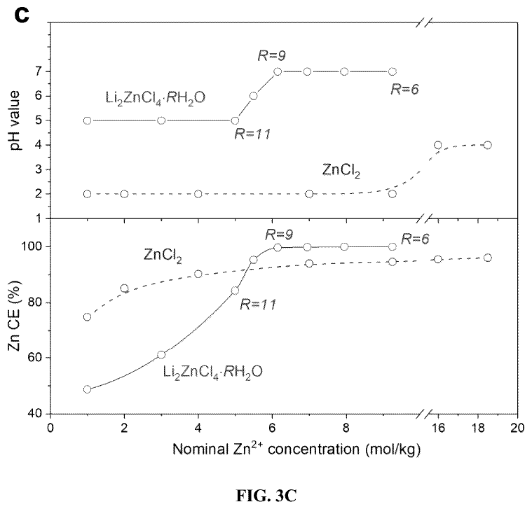

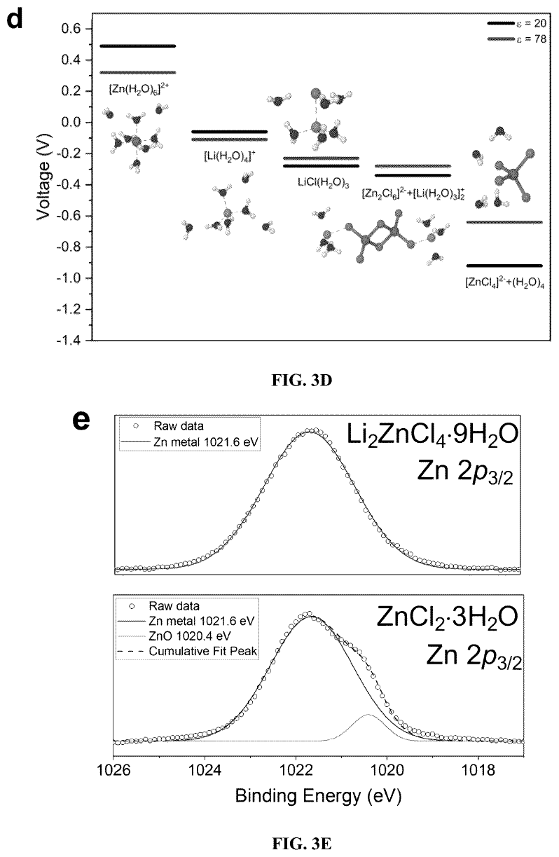

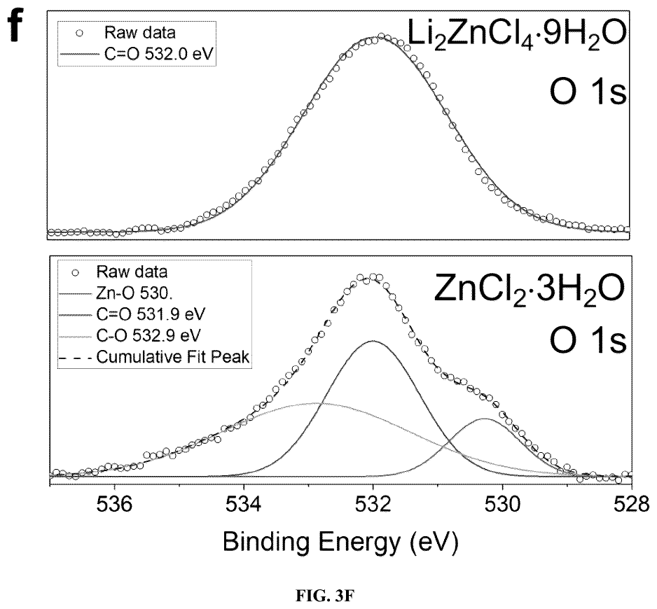

The electrochemical performance of the Zn metal anode in Li₂ZnCl₄·9H₂O electrolyte and ZnCl₂·3H₂O reference electrolyte were evaluated at a current of 0.2 mA cm⁻² with an aerial capacity of 0.2 mAh cm⁻² using the Zn∥Zn symmetric cells in the temperature range of 80° C. to −70° C. (FIG. 3A). The voltage profiles (a sum of the overpotentials for Zn stripping/plating) of the Zn∥Zn cells with both Li₂ZnCl₄·9H₂O and ZnCl₂·3H₂O electrolytes shows excellent stability with a negligible voltage fluctuation during repeated cycling at 20 and 80° C., similar to most non-alkaline electrolytes. However, when the temperature decreases from 20° C. to −70° C., the overpotential of the Zn∥Zn cell with Li₂ZnCl₄·9H₂O electrolyte only increased from 52 mV at 20° C. to 201 mV at −70° C. In sharp contrast, the Zn∥Zn symmetric cell with ZnCl₂·3H₂O electrolyte showed a dramatic polarization increase to >1.8 V at temperatures<−40° C. due to large reduction in conductivities (FIG. 1B) and transference numbers at a temperature of −40° C.

Coulombic efficiency (CE) of Zn plating/stripping in Li₂ZnCl₄·9H₂O at various temperatures was further evaluated using Ti∥Zn asymmetric cells at a current of 0.4 mA cm⁻² with a high capacity of 2.0 mAh cm⁻² (FIG. 3B). The initial Coulombic efficiency (CE) of 97.50% was achieved at 20° C. It quickly increased to ˜99.99% after 20 cycles and maintained this high CE for over 100 cycles. The average Zn plating/stripping CE can even increase to ˜100% at −70° C. due to further reduced activity of water. When the temperature was raised to 80° C., the Zn CE is higher than 99.95%, presenting the highest Zn CE reported in all temperature with aqueous electrolytes. After 100 cycles, the Zn plated on the Ti substrates still exhibited a dense and dendrite-free morphology (FIG. 3B). CEs of Zn anode strongly correlated with pH values and the water content (R) in Li₂ZnCl₄·RH₂O and ZnCl₂·RH₂O electrolytes due to water reduction reaction. FIG. 3C showed the coordination between pH values and CEs of Zn anode at 20° C. For ZnCl₂·RH₂O electrolytes, even at the highest concentrations (18 mol/kg), the pH value was only around 4 with a low CE of 95%. In sharp contrast, when the water content R is <9, Li₂ZnCl₄·RH₂O, the pH reaches neutral and a high Zn CE of ˜99.99% was achieved because the exclusive tetrahedral coordination of water-free ZnCl₄²⁻ and water molecules are confined in the solvation shells of supporting cations.

Water reduction potentials are dependent on the solvate structure as revealed by DFT calculations (FIG. 3D). The water in aqua Zn ions such as Zn²⁺(H₂O)₆, which are the most common in regular aqueous Zn²⁺ solution, is the most reductively unstable, followed by the one in the hydrated Li⁺ due to strong electric fields in the inner solvation shell. As Dubois et al reported that coordinated water indeed have higher reduction potential than free water microscopically in most cases, both solvates are expected to undergo H₂ evolution at typical overpotentials the electrolyte is experiencing during Zn plating. As water content drops to R<9 in Li₂ZnCl₄·RH₂O, the average coordination number of Li⁺ and Cl⁻ increases to at least 1 (FIG. 2C) as Li⁺(H₂O)₃ tends to share Cl⁻ ions that are bound to Zn²⁺. The presence of Cl⁻ in the Li⁺ shell further decreases the H₂ evolution potential, suppressing water decomposition.

With greatly extended electrochemical stability window of Li₂ZnCl₄·RH₂O, the strategy of a robust passivation layer on Zn anode was no longer called for with an added benefit of lower overpotentials due to lack of its contribution to interfacial resistance. It was even toxic for pursuing high CE for high depth of discharge (DoD) Zn anodes since the passivation layer had to break and reestablish due to the huge volume changes in every cycle. Solid electrolyte interphase (SEI) absent on cycled Zn surface in Li₂ZnCl₄·9H₂O electrolytes was confirmed by X-ray photoelectron spectroscopy (XPS) characterization. FIGS. 3E and 3F show the X-ray photoelectron spectroscopy (XPS) of the Zn anode surface after 20^{th} plating/stripping cycles in Li₂ZnCl₄·9H₂O and ZnCl₂·3H₂O electrolytes. No ZnO and Zn(OH)₂ were detected on cycled Zn surface by XPS. Zn 2p_{3/2} core-level of Zn anode cycled in Li₂ZnCl₄·9H₂O electrolyte has only one fitted Gaussian peak located at about 1021.6 eV attributed to zinc metal (Zn⁰). However, in the dilute ZnCl₂·3H₂O, an extra fitted peak at 1020.4 eV attributed to ZnO (Zn^{II}). Meanwhile, the fitting Gaussian peak with a binding energy of 529.8 eV can be ascribed to O²⁻ ions in the Zn—O bonding of the wurtzite structure of ZnO. The other peaks located at 532.0 eV and 532.9 eV were assigned to the presence of C═O and C—O bonding originating from surface adsorbed organic residue. Therefore ZnO SEI was formed on cycled Zn anode in in the dilute ZnCl₂·3H₂O electrolyte, but SEI was absent on cycled Zn in Li₂ZnCl₄·9H₂O electrolytes.

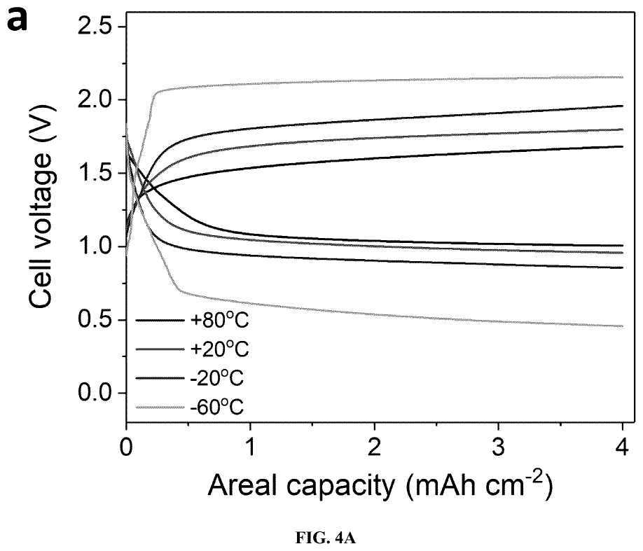

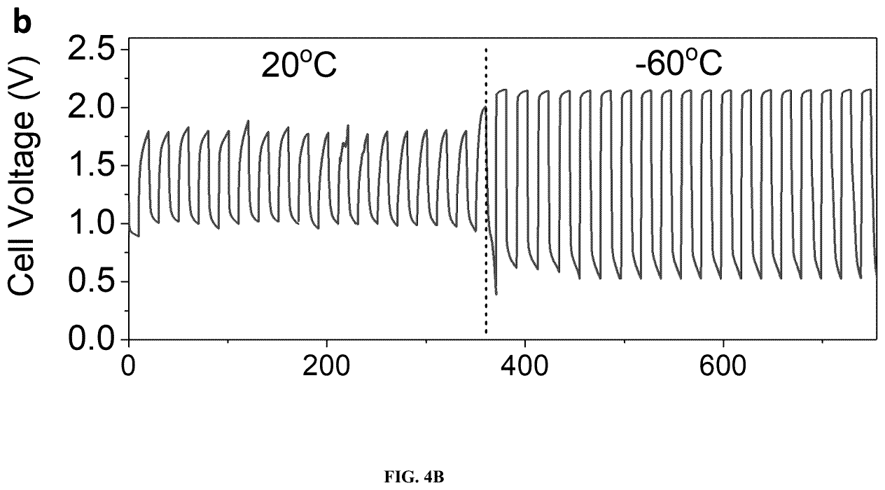

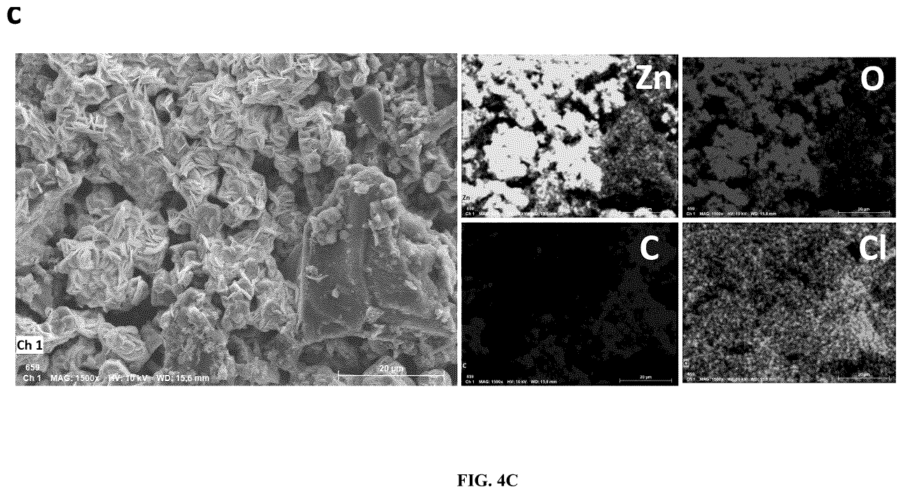

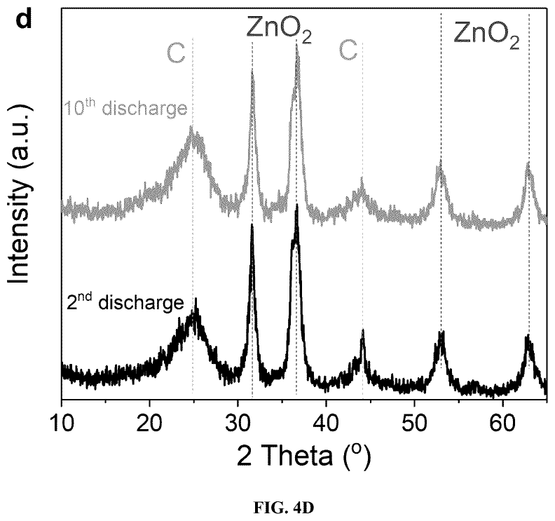

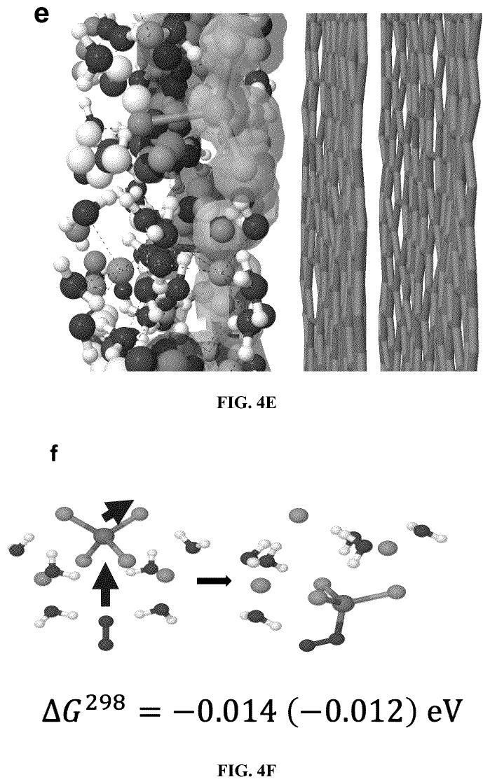

Zn-air pouch cells using platinum-carbon catalyst (5% Pt loading) coated porous carbon as an air cathode and commercial porous Zn metal as an anode were assembled to demonstrate the unprecedented thermal stability of Li₂ZnCl₄·9H₂O electrolyte between 80° C. and −60° C. (FIG. 4). FIG. 4A showed 10-hour charge/discharge profiles at a specific current of 0.4 mA cm 2 with a discharge potential of 1.07 V and a charge potential of 1.76 V at 20° C. Notably, the average discharge potentials only shifted to 0.84 V and 0.67 V after the temperature dropped to −40° C. and −60° C., respectively. The Zn-air cell operated stably in ambient air for 700 hours at both 20° C. and −60° C. with a 10-hour charge and discharge duration time per cycle (FIG. 4B), and a corresponding CE. Besides the excellent ionic conductivity retention, the uniqueness of Li₂ZnCl₄·9H₂O electrolyte also converts the cathode reaction from the 4e⁻/O₂ pathway (O₂+2H₂O+4e⁻↔4OH⁻) into a more facile 2e⁻/O₂ pathway (Zn²↔O₂+2e⁻↔ZnO₂) to guarantee the fast kinetics at low temperature. By contrast, all the commercial batteries fail to cycle properly because of a high cell impedance below −20° C. at the C/10 rate. Since the vapor pressure of water for Li₂ZnCl₄·9H₂O electrolyte was only 350 Pa, the water evaporation in an open atmosphere was negligible, ensuring a long-term practical operation.

The formation of ZnO₂ on air cathode through 2e⁻/O₂ reaction (Zn²⁺+O₂+2e⁻↔ZnO₂) was confirmed by SEM, Energy-dispersive X-ray (EDX) and X-ray diffraction. FIG. 4C shows SEM images of air cathodes obtained after the tenth discharge. The discharge reaction product had a disk-like morphology with a diameter of 1-2 micron (upper-left part) on top of chucky carbon black particles. Energy-dispersive X-ray (EDX) mapping showed the corresponding distribution of Zn and O elements in this reaction product and no Cl distribution, excluding the possibility of forming zinc chloride hydroxide monohydrate (Zn₅(OH)₈Cl₂·H₂O). To further identify the discharge products, air cathodes were examined by X-ray diffraction (FIG. 4D), showing only obvious patterns of ZnO₂ and carbon black. The ZnCl₄²⁻ species are expected to remain intact in the electric double layer (EDL) as predicted by MD simulation (FIG. 4E). The ZnCl₄²⁻ species are attracted towards the air cathode surface (carbon) under a positive polarization, in which water was excluded. The Zn ion was much closer to the electrode surface (˜4.3 Å) in Li₂ZnCl₄·9H₂O than regular electrolytes with one layer of Cl⁻ in-between, which indicated a facile reaction route between Zn ion and peroxide. In terms of reaction free energy (FIG. 4F), there is a minor preference of −0.14 eV (ε=20) and −0.13 (ε=78) for O₂ to replace a Cl⁻ which made it favorable to advance the 2e⁻/O₂ pathway (Zn²⁺+O₂+2e⁻↔ZnO₂). The smaller preference compared to a Zn(OTf)₂ electrolyte may also enhance the reversibility of this reaction in Li₂ZnCl₄·9H₂O electrolyte.

In addition to the Zn-air battery, Zn∥ZnₓVOPO₄·2H₂O zinc-ion batteries also demonstrated unprecedented performance in Li₂ZnCl₄·9H₂O electrolytes over a wide temperature range. At −70° C. and −80° C., the Li₂ZnCl₄·9H₂O electrolyte still provided a 90.0% and 81.1% discharge capacity retention relative to 20° C., respectively, which is superior to the other reported low-temperature rechargeable batteries.

The concept of nano-phase frustrated structure was also demonstrated for non-aqueous electrolytes using a mixture of aluminum chloride (AlCl₃) and magnesium chloride (MgCl₂) in 1:1 molar ratio in 1,2-dimethoxyethane (DME) with salt concentrations ranging from 0.1 mol/kg to 1.1 mol/kg. Similar as Li₂ZnCl₄·RH₂O, Cl⁻ is abstracted from MgCl₂ as viable Mg source to Al Lewis acid (AlCl₃), forming a dimer dication—[(μ-Cl)₂Mg₂(DME)ₓ]²⁺ and tetrahedral anion, AlCl₄⁻, which exhibited excellent transport properties at low temperature. At −20° C. and −60° C., Mo₆S₈/Mg battery with this electrolyte retained 81.0% and 60.1% of discharge capacity at 20° C. (105 mAh g⁻¹ at the C/10 rate based on Mo₆S₈ mass), respectively. This nano-phase segregation concept is believed to be a universal strategy for designing stable electrolyte at an ultra-wide temperature range, which offers a broader application of future battery as energy-dense and zero-carbon-emission power source.

### Example 4. Preparation of Electrodes and Electrolytes

All the chloride salts aqueous electrolytes were prepared by dissolving various molar ratios of anhydrous lithium chloride (LiCl; ≥99%; Sigma-Aldrich), anhydrous zinc chloride (ZnCl₂; ≥99%; Sigma-Aldrich), anhydrous magnesium chloride (MgCl₂; ≥99%; Sigma-Aldrich), aluminum chloride hexahydrate (AlCl₃·6H₂O; ≥99%; Sigma-Aldrich) in water (High-performance liquid chromatography, HPLC grade).

VOPO₄·2H₂O powder was synthesized by mixing 4.8 g of V₂O₅ powder (≥98%; Sigma-Aldrich) in 26.6 mL of 85% H₃PO₄ (ACS reagent, ≥85 wt. % in H₂O; Sigma-Aldrich) and 115.4 ml of distilled water. The mixture was refluxed at 110° C. for 16 h. The yellow-green VOPO₄·2H₂O powder was filtered, washed repeatedly with acetone for two times, and dried under ambient conditions. Zn pre-intercalated compound, ZnₓVOPO₄·2H₂O, was prepared by reaction at ambient temperature of as-prepared VOPO₄·2H₂O powder with stoichiometric amounts of a 0.5 mM solution of the zinc iodide (≥99%; Sigma-Aldrich) in distilled water with magnetic stirring for 12 h, after standing for 24 h in an open environment, the target product was collected. The reaction is illustrated as following:

$$\\ {VOPO}_{4} \cdot 2 {H}_{2} O + x {ZnI}_{2} {⟶}^{{H}_{2} O} {Zn}_{x} {VOPO}_{4} \cdot 2 {H}_{2} O + {I}_{2}$$

The air cathode for Zn/O₂ battery was prepared by doctor-blade coating the slurry of Ketjenblack carbon black (KB, AkzoNobel; 90%), polyvinylidene fluoride (PVDF; 10 wt %; Sigma-Aldrich) and N-Methyl-2-pyrrolidone (NMP; Sigma-Aldrich) on carbon paper (Thickness: 215 μm; FuelCellStore). The areal loading of catalysts was ˜11 mg/cm².

Chevrel Phase Mo₆S₈ was synthesized by recently reported iodine-assisted solid-state reaction. Briefly, MoS₂, Cu, and Mo powders (≥99%; Sigma-Aldrich) with the molar ratio of 2:1:1 were ball-milled (PM 100, Retsch) for 2 h at 300 rpm with stainless-steel balls in a stainless-steel vial under Ar. Then, the mixtures along with a small amount of iodine were pressed into pellets by a 14 mm diameter mold and sealed in a Swagelok stainless steel vessel, which was gradually heated to 900° C. at 2° C./min and kept for 24 h under Ar. Subsequently, the as-prepared Cu₂Mo₆S₈ precursors were dispersed into 6 M HCl solution for 12 h with oxygen bubbling to leach out Cu. After the reaction, the obtained Mo₆S₈ powder was centrifuged and washed with deionized water three times followed by drying at 60° C. overnight under vacuum.

### Example 5. Electrochemical Measurements and Raman Spectroscopy

The ionic conductivity measurements were conducted using home-made two Ti disk electrode cell calibrated by 0.1 mol/L NaCl standard electrolyte (Sigma-Aldrich). The four-point EIS measurements were performed with Gamry 345 interface 1000 using 5 mV perturbation with the frequency range of 0.01 Hz to 100,000 Hz an environmental test chamber (Thermal Product Solutions). VOPO₄·2H₂O and Mo₆S₈ cathodes were fabricated by compressing well-mixed active materials, carbon black (Sigma-Aldrich) and poly(vinylidenedifluoride) (PTFE; Sigma-Aldrich) at a weight ratio of 70:20:10 on a titanium metal mesh (Alfa Aesar, 100 mesh). The areal loading of cathode material was ˜18 mg cm⁻². Zn/Zn, Ti/Zn, and Mo₆S₈/Mg cells were assembled as CR2032-type coin cells (MTI corp.) using Zn metal disk (Alfa Aesar, 2 cm²), Mg metal (Alfa Aesar, 2 cm²), as-prepared Mo₆S₈ as electrodes, and glass fiber (VWR) as separator, respectively. These cells were then galvanostatically charged/discharged using a Land BT2000 battery test system (Wuhan, China) in an environmental test chamber (Thermal Product Solutions). VOPO₄·2H₂O/Zn and Zn—O₂ pouch cells (10 cm×10 cm) were assembled using VOPO₄·2H₂O, Zn on Ti disk, Ketjenblack carbon black (KB, AkzoNobel) carbon loaded on carbon paper as electrodes, and glass fiber as separator, respectively. Zn—O₂ pouch cell was cut open on cathode side and placed in a pure O₂ chamber. These cells were then galvanostatically charged/discharged using an Arbin electrochemical working station in an environmental test chamber (Thermal Product Solutions). In order to separate the Li-ion conduction contribution from the Zn-ion transport in this dual-salt system, the transference number t_{Zn}, defined as the net ratio of faradays of charge carried by the Zn constituent, was examined by the steady-state current method in a Zn/Zn symmetric cell⁴¹. Since the CE of Zn stripping/plating was close to 100% in Li₂ZnCl₄·RH₂O (R≥9), t_{Zn} could be estimated by following equation:

$$\\ {t}_{Zn} = \frac{{I}_{S} ( Δ V - {I}_{0} {R}_{0} )}{{I}_{0} ( Δ V - {I}_{S} {R}_{S} )}$$

where I_{S} and I₀ were the steady-state and initial currents respectively when 5 mV of polarization voltages ΔV are applied across the cell. The first data point was recorded at 0.05 second. R₀ and R_{S} were the initial and steady-state resistances measured by electrochemical impedance spectroscopy (EIS) to balance the potential change of interface resistance.

### Example 6. Measurements of Phase Transition, Glass Transition, and Solution Enthalpy

Phase transition, glass transition, and solution enthalpy measurements were conducted at a slow heating rate of 2° C./min using two differential scanning calorimeters (DSC250 or MDSC 2920, both by TA Instruments). A liquid nitrogen cooler was used for low-temperature control, and calibration was performed using the standards of cyclohexane −87.06° C. for a solid-solid transition and 6.45° C. for melting), indium (156.60° C. for melting), and tin (231.93° C. for melting). For differential scanning calorimetry (DSC) samples, about 10 mg of electrolyte liquid was enclosed in a pair of aluminum pan and lid (0219-0062, PerkinElmer Instruments) and hermetically sealed with a crimper (0219-0061, PerkinElmer). Vitrification of a sample was achieved by pre-dipping the sample into liquid nitrogen and subsequently scanning it up through its glass transition. Crystallization of a sample that was otherwise hard to crystalize was assisted by adding a small amount of mesocarbon microbeads (MCMBs; MTI corp.) into the DSC sample as a nucleating agent to induce the desired crystallization.

### Example 7. Molecular Dynamics Simulations

Polarizable force field simulations were performed with an in-house modified version of the TinkerHP v1.0 package and a locally modified AMOEBABIO 2018 force field. Ion charges were reduced by 2.5% and refit the Cl—OH₂ (3.925 Å, 0.32 kcal/mol), Li—Cl (3.7011 Å, 0.1451 kcal/mol), and Zn—Cl (3.48 Å, 0.28 kcal/mol) vdW terms. Scaling the charges slightly had a relatively large impact on the transport properties. All systems were generated with Materials Studio's amorphous cell packing utility at an initial density of 1 g/mL. An initial ˜100 ps NPT calculation was performed to ensure the simulation would be stable and to somewhat relax the box size.

For large cells consisting of ˜2200 waters, constant pressure dynamics were performed for a further 12 ns at 298.15 K and 1 atm with Berendsen thermostating and barostating and the Beeman integrator with 1.0 femtosecond timestep. Non-bonded terms were cutoff at 10.0 Å with a long-range correction applied to vdW interactions, A PME grid density of 60³ was used with 5^{th} order spline and the Ewald alpha was fixed at 0.386 Å⁻¹. The box of final frame of the trajectory was resized to match the average box size from the last 4 ns of the trajectory. Constant volume dynamics were then performed for 24 ns at 298.15 K with Berendsen thermostating and the RESPA integrator with 2.0 fs timestep. Coordinates were saved at a 2 ps frequency and the pressure stress tensor at an interval of 10 fs.

The smaller cells of R=6, 15 in Li₂ZnCl₄·RH₂O electrolytes for Born Oppenheimer MD were prepared just as the larger cells but using higher temperatures as discussed in SI. An initial set of four replicas were prepared. Equilibration under constant pressure conditions was performed for 6 ns with the average box size taken from the last 2 ns. The final frame was rescaled to this average box size before 8 ns of constant volume dynamics were performed (denoted as replica r4 of Li₂ZnCl₄·6H₂O in SI). Using the same box volume to create a different trajectory, a small 2% increase in the Zn—Cl repulsion term was added to slightly alter the solvation shell around the Zn (denoted as replicas r2 and r3 for Li₂ZnCl₄·6H₂O in SI). Replica r1 for Li₂ZnCl₄·6H₂O was prepared by further increasing the Zn—Cl repulsion to create an initial configuration with an equal contribution of water and Cl⁻ to Zn²⁺ solvation and investigate its evolution. The effect is more pronounced on the 15:1 system than 6:1, where little change in solvation structure is observed. The non-bonded cutoffs are set to at least 7.0 Å but 8.0 Å was used where possible and a 243 PME grid, Later, another set of trajectories for R=6, 9, 10, and 15 in Li₂ZnCl₄·RH₂O were added that were set up and run the same way but with 0% Zn—Cl repulsion scaling, 5%, and 7.5% scaling to sample very different Zn coordination environments. This set was run using both PBE and revPBE functionals, the former set used only PBE.

The final structures from the smaller cell NVT runs were then used as inputs for BOMD simulations. BOMD calculations were performed with CP2K v6.1 at the [PBE-D3 or revPBE-D3]/DZVP-MOLOPT-SR-GTH level of theory with PBE optimized pseudopotentials for core states using 600 Ry cutoff, Trajectories were heated in 100 K increments to their respective target temperatures using the Bussi velocity rescaling thermostat under constant volume conditions with 20 fs coupling constant. Total annealing time was 10 ps using a 0.5 fs timestep throughout. Up to 145 ps of isotropic constant pressure dynamics was performed starting from the thermalized NVT configurations, with 50 f coupling constant for the Bussi thermostat. The first 10 ps is discarded as additional equilibration and changes in the coordination number around Zn are monitored after that.

### Example 8. Activity Coefficient, SANS, and X-Ray Scattering Measurements and Spectroscopy

To study the activity of Li⁺ and Zn²⁺ as a function of the Li⁺ molality, the equilibrium potentials of the LiₓFePO₄ (x=0.5) electrode and Zn metal electrode in various electrolyte solutions were measured using a two-electrode cell with a Ag/AgCl (in saturated KCl aqueous solution) reference electrode, respectively. Water Activity measurements were performed using a custom-built vapor pressure measurement apparatus. Solutions were placed into a glass container, which had a sample-to-headspace ratio of approximately 1:1, that was connected to a vacuum system. For purging and degassing, the glass chamber was evacuated using a vacuum pump to P<0.1 kPa and flushed three times with nitrogen. The volume and mass of the solution were measured in control experiments to ensure that the amount of sample loss during purging was negligible. After purging, the chamber was sealed, and the total pressure was monitored as a function of time as the vapor phase equilibrated with the solution phase. When the total pressure reached a constant value, the pressure was recorded. A k-type thermocouple was inserted into the liquid mixture to ensure the temperature was 22° C. before recording the pressure. It was assumed that the vapor phase was pure water (i.e. no salt evaporation). Control experiments were conducted with pure milli-Q water and the tabulated saturated vapor pressure of 2.69 kPa was accurately measured. Raoult's law was used to calculate the water activity in the liquid phase from the measured water vapor pressure.

SANS measurements were performed on the very Small Angle Neutron Scattering (vSANS) instrument at the NIST Center for Neutron Research. Samples were contained in 1 mm path standard titanium demountable cells using titanium windows. A closed cycle refrigerator was employed for controlling the sample temperature with an accuracy better than 1 K. Data were collected using two incoming neutron wavelengths of 5 Å and 8.5 Å with a Δλ/λ of ≈0.13. With the combined use of two detector banks, a Q range from ≈10⁻³ Å⁻¹ to ≈0.2 Å⁻¹ was covered. Employing standard routines. Raw data were corrected for background, and empty cell scattering, and further reduced to 1D absolute intensity patterns using open beam intensity.

X-ray scattering spectra of aqueous solutions were collected with beamline 11-ID-C at the advanced photon source (APS) at Argonne National Laboratory with light wavelength of 0.11729 Å. Samples with an average volume of ˜0.2 mL were held in a 3 mm quartz tube, while 2D diffraction images were collected on a GE amorphous silicon-based detector. All the data above were acquired at 300 K. PDFs, G(r) were computed using GSAS II software. Scattering from an empty quartz tube was used for background subtraction. Corrections for fluorescence, X-ray polarization, Compton scattering and energy dependent were then applied.

### Example 9. Structure of Li₂ZnCl₄·RH₂O Solvent-in-Salt Electrolyte

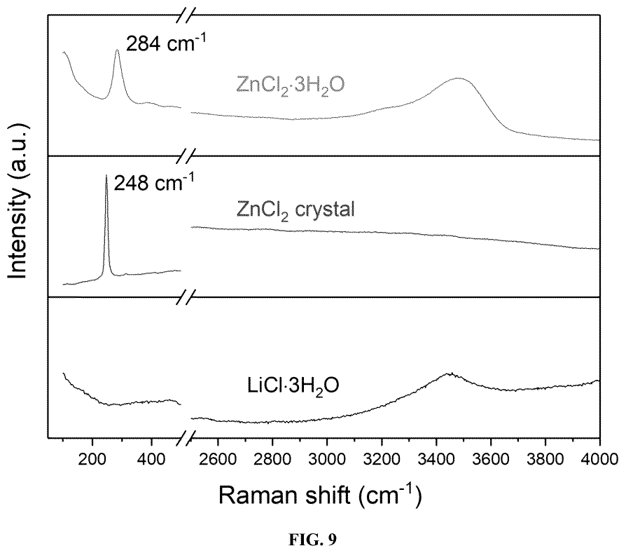

The structure of [ZnCl₄]²⁻ complex anion and hydrated Li⁺ cation in Li₂ZnCl₄·RH₂O (R=6, 10, 11) electrolytes was characterized using Raman spectroscopy (FIG. 5B). The bands at around 110 cm⁻¹ (component of v₂ and v₄ modes) and 279 cm⁻¹ (v₁ modes) in Li₂ZnCl₄·11H₂O electrolytes were assigned to the characteristic vibrational mode of zinc tetrachloride —[ZnCl₄]²⁻. Both the ZnCl₂ crystal-like structure with a band at 248 cm⁻¹ (FIG. 9), and [Zn(OH₂)₆]²⁺ at ˜290 cm⁻¹ as in ZnCl₂·xH₂O were not observed. With reducing the water concentration R to less than 10, the intensity of [ZnCl₄]²⁻ peaks at 279 cm⁻¹ and 110 cm⁻¹ greatly increases, indicating that the formation of Zn—Cl tetra-coordination is enhanced when water-content R Li₂ZnCl₄·RH₂O is less than 10. This evidence suggests that Zn²⁺ prefer to be coordinated by approximately four Cl⁻ rather than by water, especially at a high salt concentration. The Raman band between 3,000 cm⁻¹-3,800 cm⁻¹ shows the O—H stretching vibration modes of water molecules. In diluted solution (1 mol kg⁻¹), the O—H stretching vibration in FIG. 5B exhibited a same broad Raman band as the pure water, which are attributed to various hydrogen-bonding environments in free water clusters. With the water concentration reduced to R≤10, only a sharper band appeared at 3,561 cm⁻¹ assigned to the DDA (single donor-double acceptor) vibration mode of water molecules participating in the Li⁺ hydration shells, indicating that the abundance of hydrogen bonding water cluster was largely diminished. Different from the 28 M LiTFSI—LiOTf “water-in-bisalt” systems, this high-entropy electrolyte can stabilize water even at a low Li⁺/H₂O ratio (1:5) or a low cation/H₂O ratio (3:10), due to strong dissociation of Li⁺/ZnCl₄²⁻ ion-pairs.

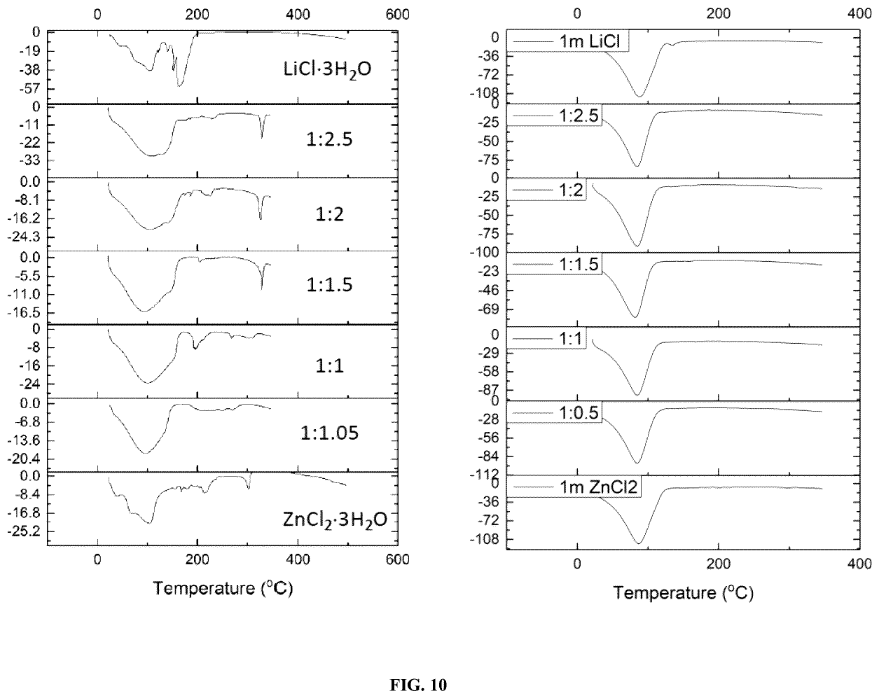

The formation of [ZnCl₄]²⁻ complex anion and largely hydrated Li⁺“water sponge” occurs as a result of the dissociation of ion-pairs and the exchange of water with Cl⁻, which can be evaluated by the enthalpy change of solution during the mixing of LiCl and ZnCl₂ aqueous solutions at a fixed cation/H₂O ratio. To quantify this enthalpy change, a well-calibrated differential scanning calorimeter (DSC) was employed to measure the overall vaporization enthalpy of water for both WiS and diluted LiCl and ZnCl₂ mixtures (FIG. 10). The enthalpy change of two solutions with molar ratios of Li/Zn is shown in FIG. 5C. The enthalpy linearly increases with the molar ratios of Li/Zn in the x(LiCl·3H₂—)—(ZnCl₂·3H₂O) WiS electrolytes (x=0.5-2.0), and then levels off after x=2 (Li₂ZnCl₄·9H₂O). Therefore, an average of 36 joules per mole of water is released when one mole LiCl·3H₂O WiS was added to ZnCl₂·3H₂O WiS. The redistribution of water and Cl⁻ during mixing of two WiS solutions (LiCl·3H₂O; ZnCl₂·3H₂O) increases the solution enthalpy which reaches the maximum at x=2 (Li₂ZnCl₄·9H₂O). When the x>2, no additional distribution of water and Cl⁻ occurs. Therefore Li₂ZnCl₄·9H₂O has the highest redistribution of H₂O and Cl⁻ in all LiCl—ZnCl₂—H₂O systems relative to single-salt LiCl—H₂O WiS and ZnCl₂—H₂O WiS electrolytes, and is named as a high entropy electrolyte characterized by dual-salts. As a reference, the negligible enthalpy differences were detected in the diluted dual-salt solutions, as the same as the other normal aqueous systems. This tremendous enthalpy changes of mixing from two single-salt WiS solutions with same water-content indicates that the redistributed Cl⁻ and H₂O associations effectively suppress Li⁺/ZnCl₄²⁻ ion-pairing and increase hydration of Li⁺, making this high-entropy electrolyte more thermodynamically stable.

The rearrangement of local solvation structure in high-entropy electrolyte is further studied by examining the activity coefficients of water and cations. Firstly, water activity coefficients of Li₂ZnCl₄·RH₂O were determined with different water concentration (R), from the ratio of the measured vapor pressures of Li₂ZnCl₄·RH₂O solutions to the saturated vapor pressure of pure water at 22° C. (2.69 kPa). FIG. 5D shows the dependence of the water activity coefficient on the mole fraction of water in Li₂ZnCl₄·RH₂O solutions. These coefficients may be slightly overestimated because the complex salt Li₂ZnCl₄ is treated as two LiCl and one ZnCl₂ in the calculation of the water mol fraction. Despite this overestimation, the water in Li₂ZnCl₄·RH₂O (R≤9) exhibited much lower activity coefficients than LiCl—H₂O, ZnCl₂—H₂O and 21 M LiTFSI-H₂O, which are normally considered as highly hydrated systems. As water molar concentration decreases from 95 mol % to 67 mol %, equivalent to that salt concentration increases form 1.0 mol kg⁻¹ to 18.5 mol kg⁻¹ (Li₂ZnCl₄·6H₂O), the vapor pressure of water dropped from 2.33 kPa to 0.088 kPa, and the water activity coefficients largely decreased from 0.92 to 0.09 (red line in FIG. 5D) because of a sufficient hydration effect in the Li⁺ “sponge”. It should be noted that there was a discontinuity point at R=9 where the activity coefficient greatly dropped and remained at a lower level, which could be attributed to deviations in the behavior of cation activities (FIG. 5E). The maximally reduced water activity largely suppresses the water freezing and boiling in Li₂ZnCl₄·RH₂O high-entropy electrolytes.

The activity coefficient of Li⁺ and Zn²⁺ in Li₂ZnCl₄·RH₂O electrolytes were also estimated by the equilibrium potential of Li_{0.5}FePO₄ and Zn metal electrodes, respectively. According to the Nernst equation, the equilibrium potential (E) of the electrochemical reactions for ions, both Li⁺ and Zn²⁺, depends on their activity coefficient (γ) in the electrolyte solution:

$$\\ E = {E}_{0} + \frac{RT}{F} ln ( n {}_{} γ )$$

where E⁰ and n denote the standard reaction potential and the nominal concentration in the solution of the ion, respectively. Since the activity term of nγ was 1, the actual reaction potential in a solution was reduced by ion-solvent and ion-ion interactions from the standard reaction potential. Here, by using the activity coefficient in 1 mol kg⁻¹ Li⁺ and Zn²⁺ aqueous solutions as standard γ_{std}, the relative activity coefficient γ/γ_{std} was calculated from the potential shift ((ΔE=E−E_{1 mol/kg}) in Li₂ZnCl₄·RH₂O electrolytes with different water concentrations of R (FIG. 5E). Remarkably, the equilibrium potential of Li_{0.5}FePO₄ is shifted upwards by 0.38 V when the Li-ion concentration increases from 1.0 mol kg⁻¹ to 18.5 mol kg⁻¹ (Li₂ZnCl₄·6H₂O), demonstrating that γ of Li⁺ in Li₂ZnCl₄·6H₂O is 2.2×10⁶ times higher than γ_{std}. The large increase in γ has been observed previously in other highly concentrated aqueous solutions and is closely related to the changes of electrolyte solvation structure. Such a trend is beyond the scope of conventional Debye-Hückel theory but can be rationalized qualitatively through the Stokes and Robinson hydration effect as mean ionic activity increases with decreasing water activity. According to the Gibbs-Duhem equation,

$$\\ \sum {x}_{i} d {μ}_{i} + {x}_{w} d {μ}_{w} = Δ G$$

the changes in the chemical potentials of the ions (μᵢ) are not only related to chemical potentials of water (μ_{w}), but also to the change of overall Gibbs free energy, which is the change of dissolution enthalpy for the solution system. As shown by the dash lines in FIG. 5E, the increase in Li-ion activity coefficient of single salt solutions becomes more gradual when the water content R decreases to <11 because of the ion-pairing formed in a highly concentrated range. However, at the same water concentration range of R<11, the Li-ion activity coefficient in Li₂ZnCl₄·RH₂O electrolytes is much larger than those in LiCl solutions, and Zn-ion activity coefficient in Li₂ZnCl₄·RH₂O electrolytes is much less than those in ZnCl₂ solutions (FIG. 5E). The large difference in Li/Zn-ion activity between single-ion and dual-ion electrolytes is attributed to effectively suppressing the formation of LiCl ion pairs and Zn—H₂O contacts in Li₂ZnCl₄·RH₂O as the dissociated Li—Cl donates Cl⁻ to Zn²⁺, thus freeing up water from Zn²⁺ solvation shell to hydrate Li⁺ as observed in MD simulations discussed below. Li₂ZnCl₄·RH₂O solution reaches the maximum separation among LiClₘ, ZnCl₂ and H₂O at the stoichiometry R=9 forming a high-entropy Li₂ZnCl₄·9H₂O electrolyte.

The rearrangement of local solvation structure in high-entropy electrolyte is also reflected by the evolution of its pH value (FIG. 5F). In regular aqueous solutions with hydrated Zn²⁺, the dominating aqua ions [Zn(OH₂)₆]² would have the electrons departing from the 3a₁ bonding molecular orbital of water towards the empty orbitals of Zn²⁺, resulting in a weakened O—H bond of water that promotes the hydrolysis reaction to release protons. This reduces the pH value of the electrolytes even in ultra-high concentrated ZnCl2·RH₂O, leading to severe hydrogen evolution on Zn metal anode. However, in Li₂ZnCl₄·RH₂O electrolyte, water molecules were confined in the solvation shells of Li⁺, while the inner shell of Zn²⁺ was dominated by Cl⁻. As a result, the pH values of Li₂ZnCl₄·RH₂O (R≤9) electrolyte approach neutral. This is highly beneficial since the H₂ evolution of Zn anode is suppressed, and high reversibility (CE˜100%) for Zn plating/stripping could be achieved in this electrolyte, as discussed below.

### Example 10. Electrolyte Molecular Dynamics Studies

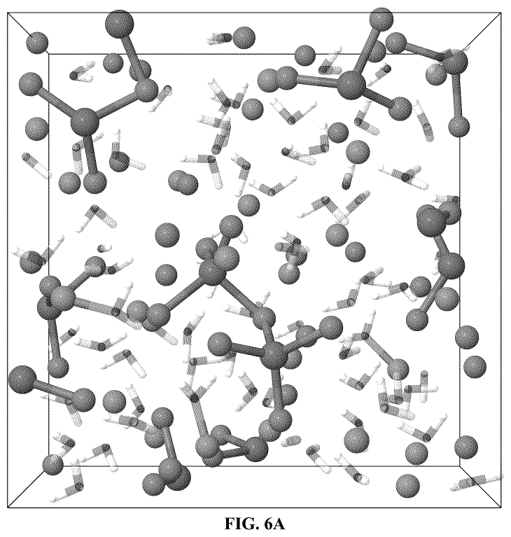

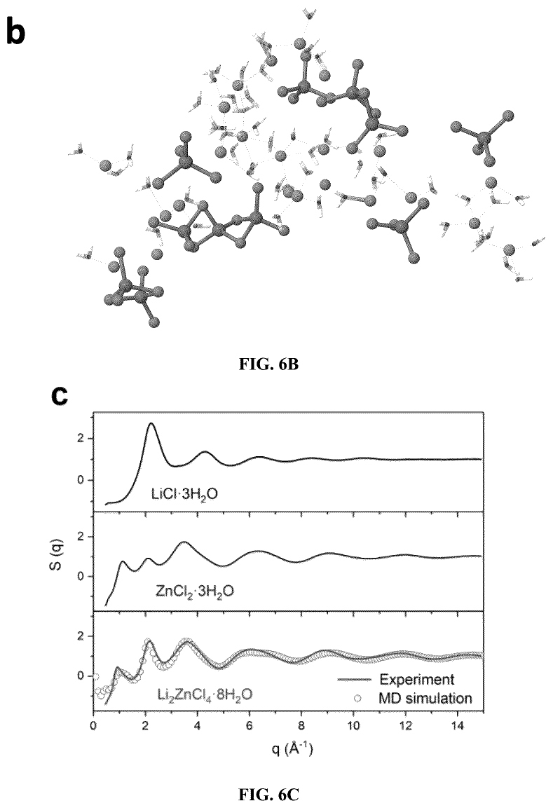

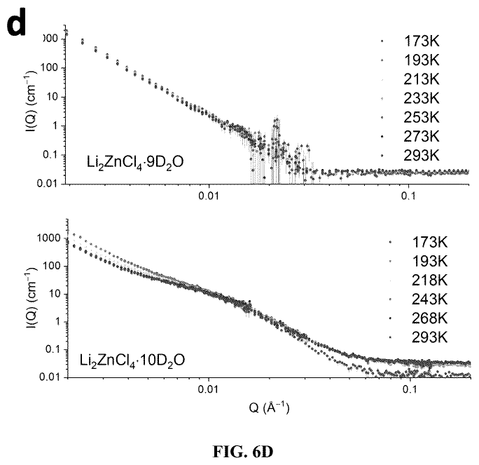

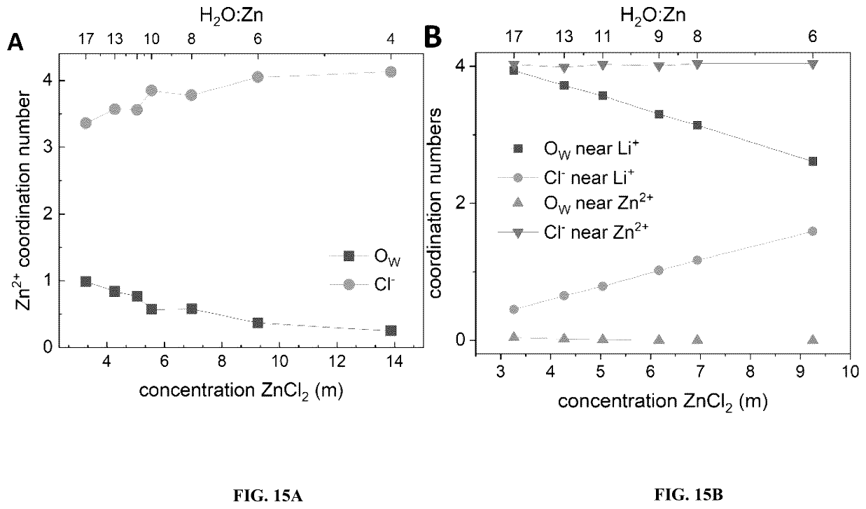

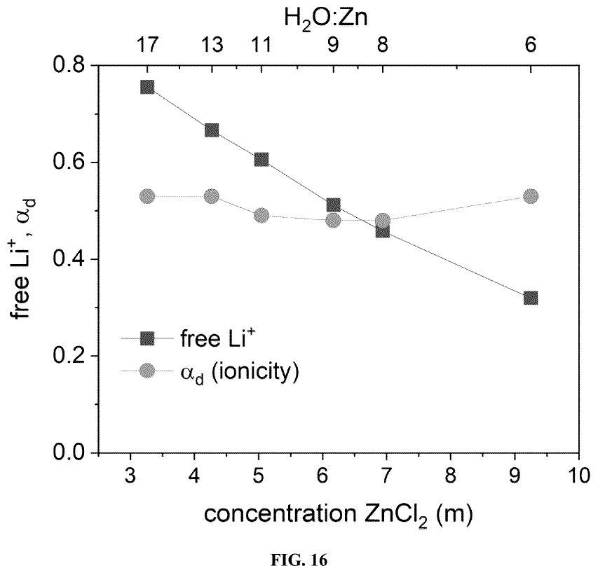

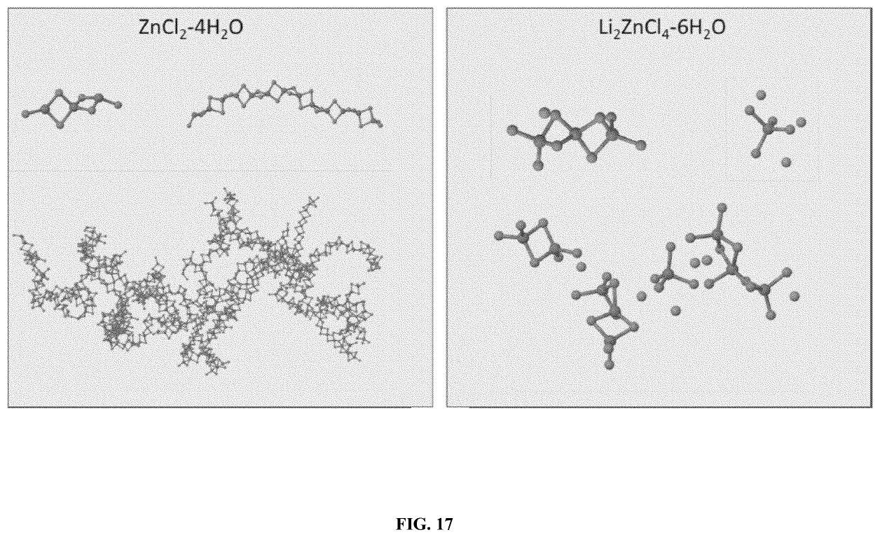

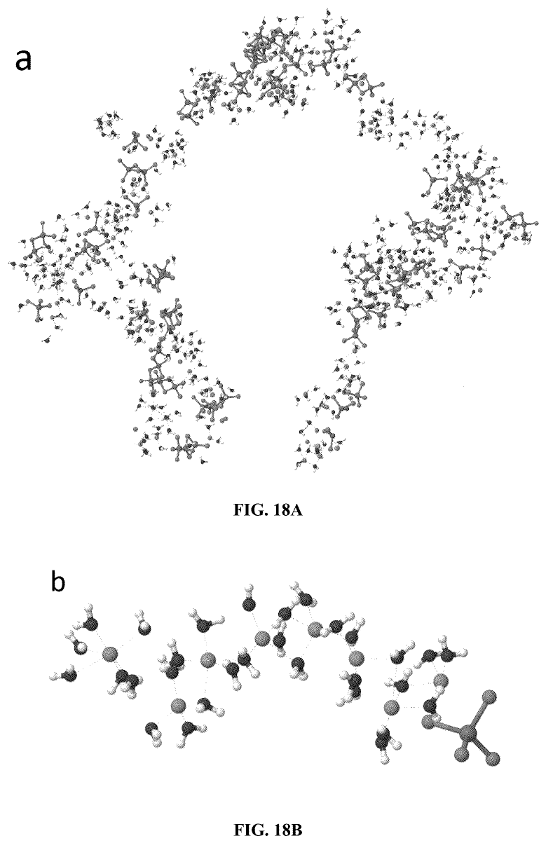

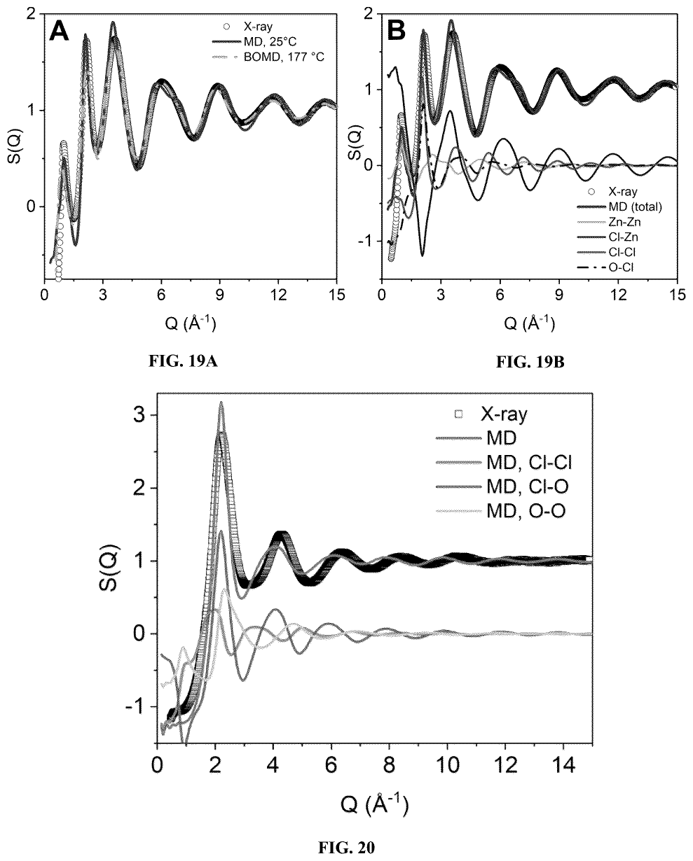

Further insight into electrolyte structure was obtained from density functional theory (DFT)-based Born-Oppenheimer Molecular Dynamics (BOMD) simulations with small cells at high temperature and force field-based MD simulations at room temperature (FIGS. 11-20). MD simulations showed a preference for Zn²⁺ for Cl⁻ (˜4) over water in its first solvation shell for ZnCl₂·RH₂O (R=6-17) electrolytes, in good agreement with previous reports. However, 0.3-1H₂O still coordinates Zn²⁺ (FIG. 15A) leading to water decomposition (low CE for Zn plating/stripping) and acidic pH (FIG. 5F). Upon addition of LiCl salt into ZnCl₂·RH₂O electrolyte, the LiCl salt largely dissociates, Li⁺ cations become hydrated and serve as halogen donor to Zn²⁺. Due to availability of these extra Cl⁻ donated by LiCl to ZnCl₂, Zn²⁺ doesn't have to share Cl⁻ to satisfy its tetrahedral Cl⁻ coordination. Thus, the long [ZnCl^{m-}]ₙ ionic networks observed in ZnCl₂·RH₂O break up into smaller anions such as ZnCl₄²⁻ that are bridged via the halogen and mobile Li⁺ hydrates in Li₂ZnCl₄·RH₂O (FIGS. 6A, 6B, and 8-19). At the highest salt concentration Li₂ZnCl₄·6H₂O, BOMD simulations predict that Li⁺ is coordinated with an average of 2.6-2.7 waters and 1.3 Cl⁻ on average, while Zn²⁺ is largely tetrahedrally coordinated by 3.75Cl⁻ with less than 0.2 water, which increased the Zn CE and pH value (FIG. 5F). Despite high salt concentration of Li₂ZnCl₄·6H₂O, a high fraction (>30%) of Li⁺ remains fully hydrated Li⁺(H₂O)₄ confirming that the Li⁺ acts as a “water sponge” and with little direct contact to Cl⁻ (FIG. 16), while more than 26% of Li⁺ have more than two Cl⁻ and bridge ZnCl₄ networks (FIGS. 6B and 17). The structure factors of single and bi-salt electrolytes from MD simulations are in good agreement with X-ray measurements (FIGS. 6C and 19-20), validating the simulation predictions. For fast Zn-ion transport, much shorter Li—Cl bond lifetime compared to the Zn—Cl lifetime, leads to frequent breaking and reforming of the Cl—Li—Cl bonds allowing fast rearrangement of ZnCl₄²⁻ and [ZnCl₄^{m-}]ₙ short aggregates. The rearrangement together with the transport of the smallest aggregates [ZnCl₄]²⁻ is beneficial for the Zn-ionic transport.

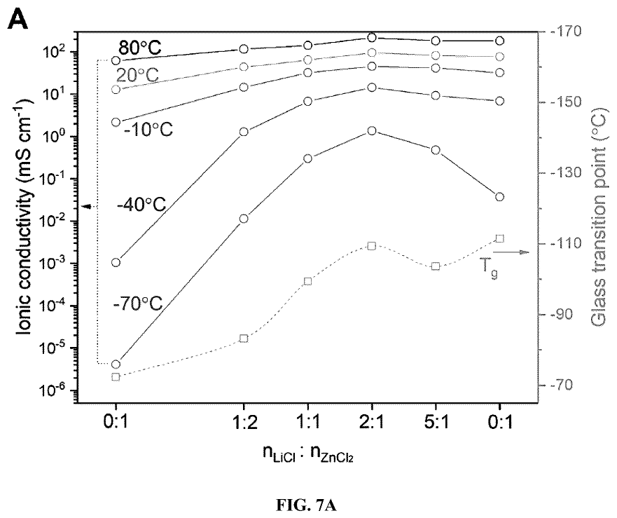

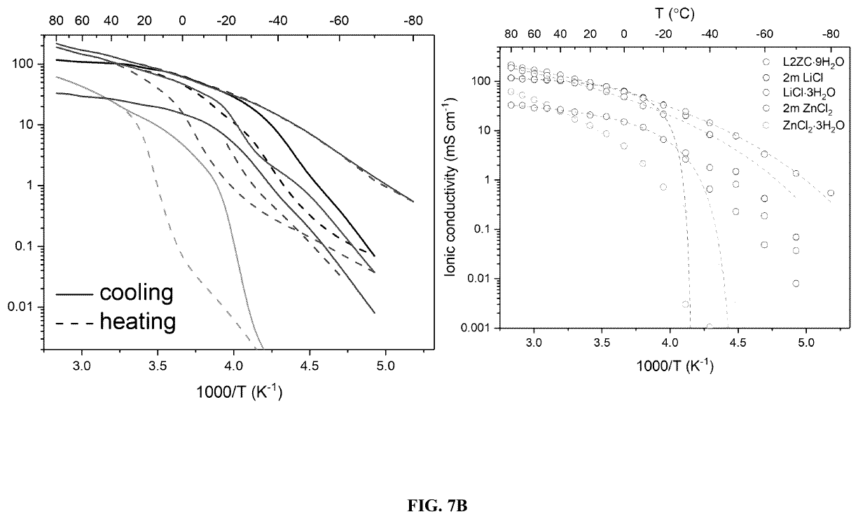

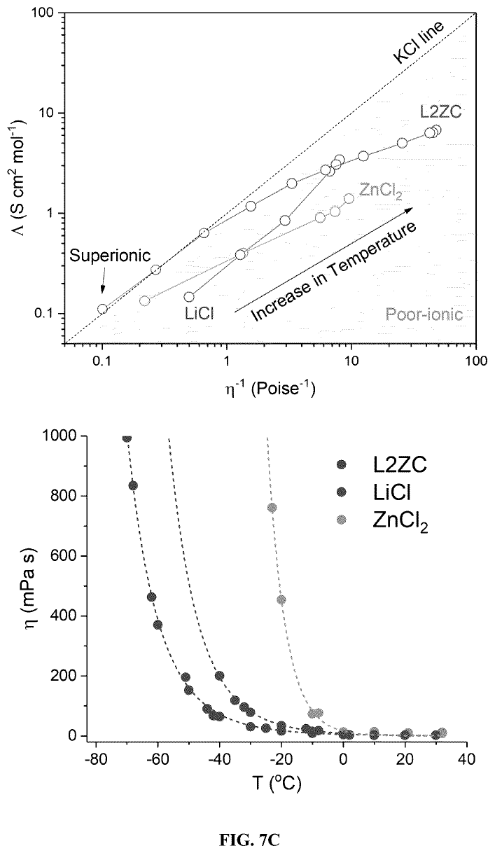

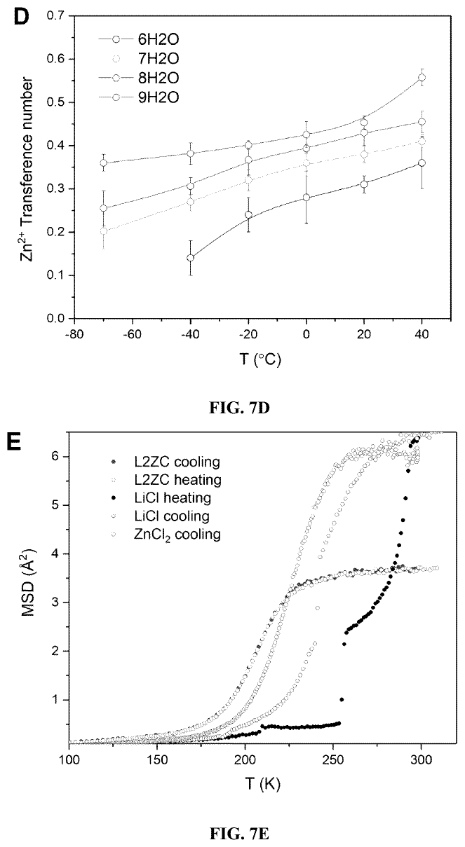

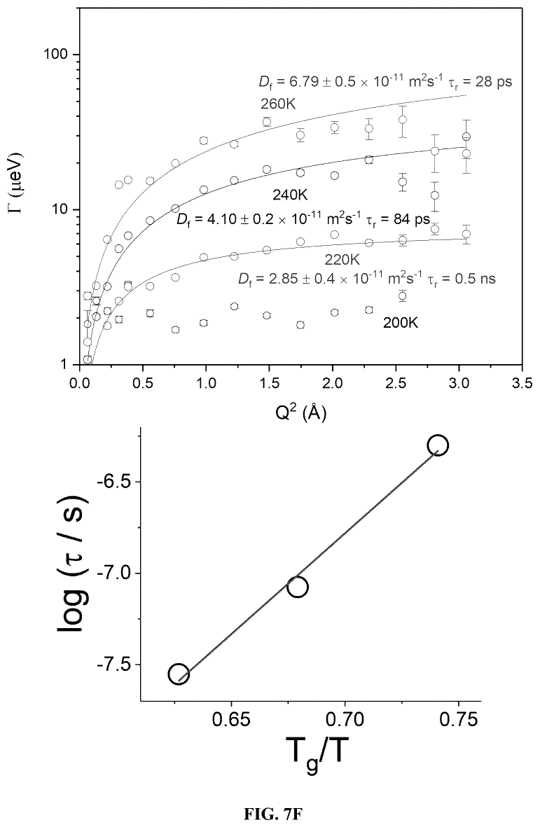

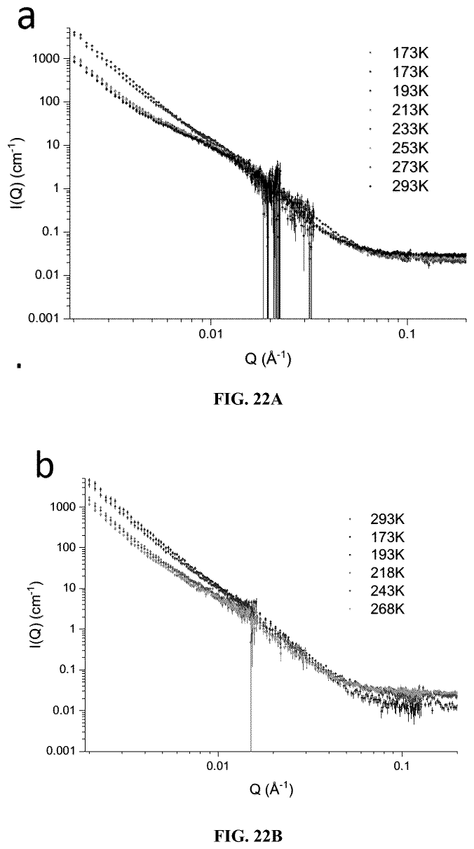

The water structure was investigated by neutron scattering, and its sensitivity was enhanced by deuterium isotope substitution of the water (D₂O). The mesoscopic structure changes of Li₂ZnCl₄·RD₂O (R=9 or 10) during cooling from 293 K to 173 K were observed using small angle neutron scattering (SANS). FIG. 6D demonstrates that all Li₂ZnCl₄·RD₂O electrolytes show a typical power law behavior at low Q (wave vector transfer of neutron) indicative of fractal structure at length scales of ≈100 nm and larger, which was attributed to the distribution of different-sized [ZnCl²⁻]. chains bridged via Cl—Li(H₂O)₂—Cl or other Li hydrates in the global liquid structure as predicted by MD simulations (FIGS. 17-19). The linear (in log-log scale) scattering profiles for Li₂ZnCl₄·9D₂O high-entropy electrolyte showed no temperature dependence, indicating that a homogeneous liquid phase remained in the whole investigated temperature range. However, Li₂ZnCl₄·10D₂O showed a gradual change in the mesoscopic (≈100 nm) structure of the sample below 243 K, as demonstrated by the low Q data. In addition, the sudden change of the background level at high Q showed another macroscopic change below 173 K. It indicates that a slight dilution of this aqueous system may introduce instability at low temperature, which may be due to changes in ion coordination structure which are discussed later. Moreover, Li₂ZnCl₄·10D₂O has a characteristic bump at ≈0.02 Å⁻¹ which is indicative of structures with characteristic distances of ≈10 nm, which was also seen in LiCl·3D20 sample (FIG. 22A). As points of reference, it is noted that sudden changes in the mesoscopic (≈100 nm) structure happened below 213 K and 218 K for single salt systems, LiCl·3D₂O and ZnCl₂·3D₂O, respectively (FIG. 22B). Since these discontinuities are observed also in ionic conductivity (FIG. 7A) and dynamic measurements (FIG. 7E), it is suspected these mesoscopic structure changes are due to ice nucleation.

### Example 11. Electrolyte Conductivity Studies

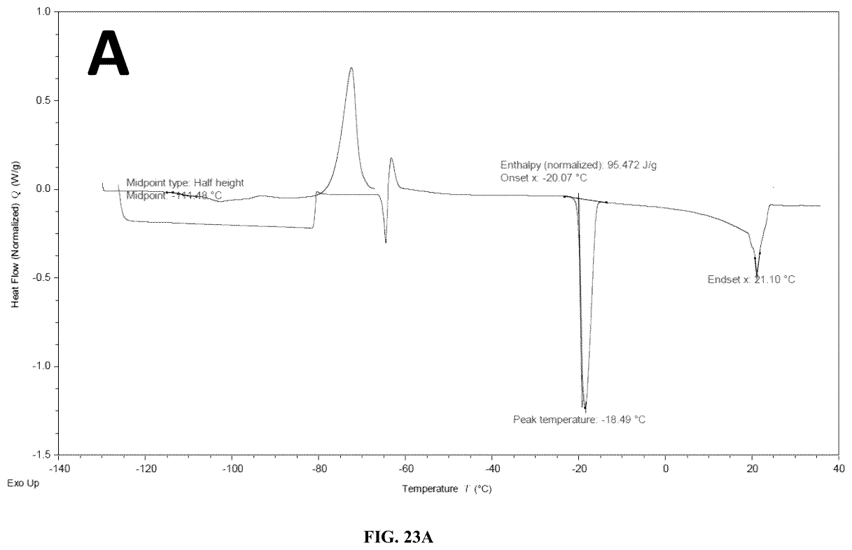

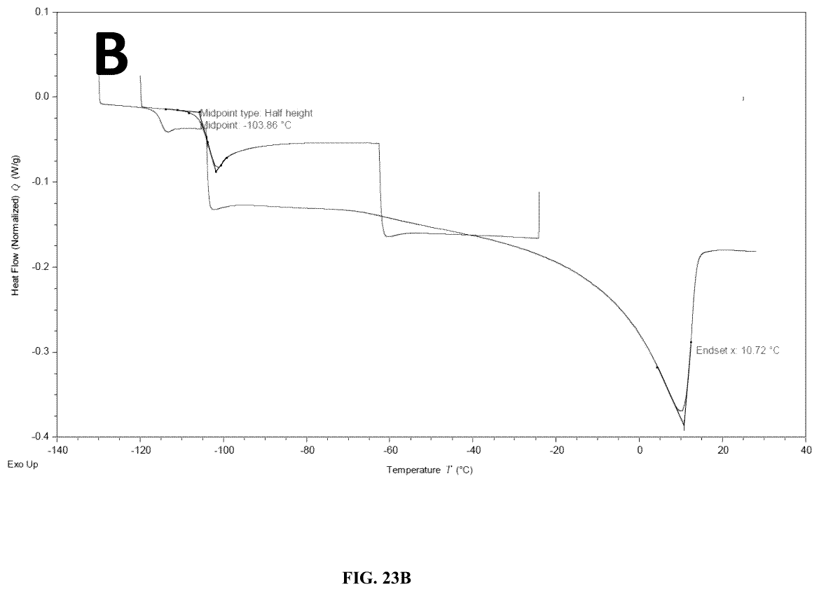

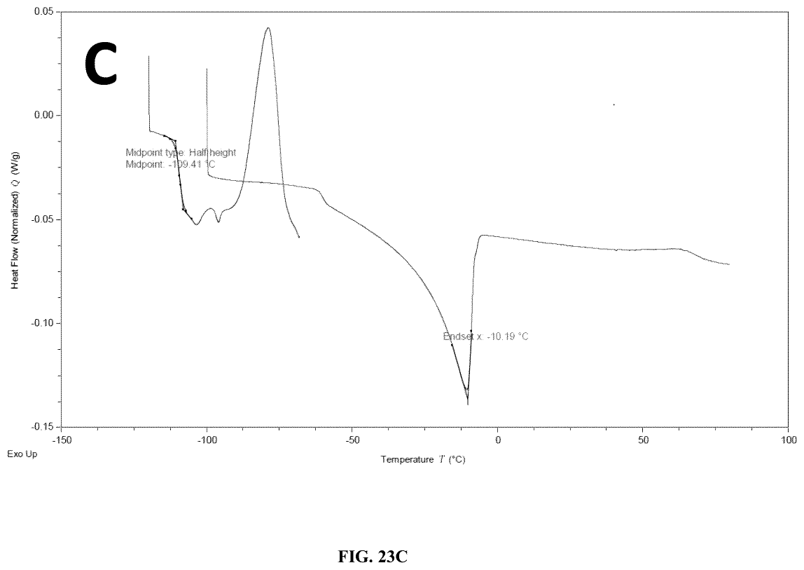

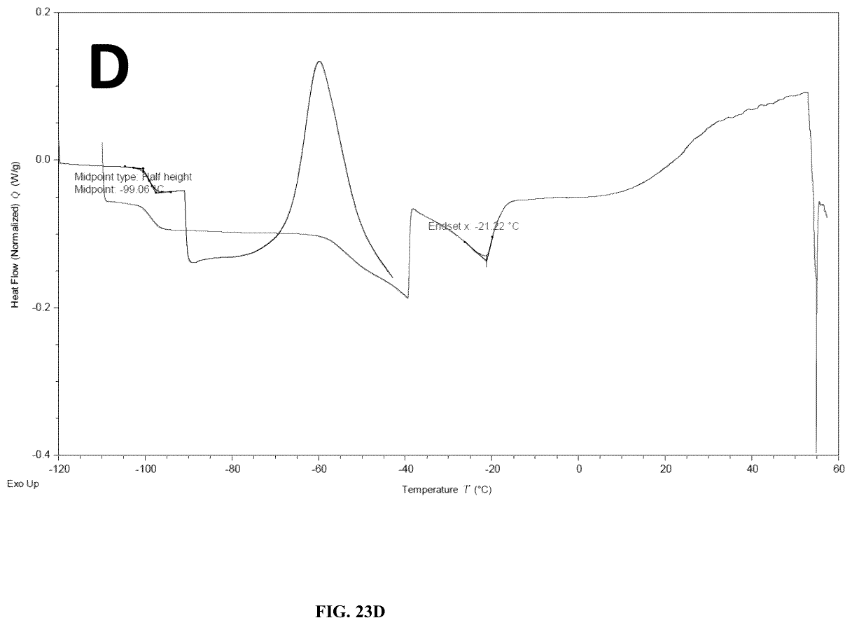

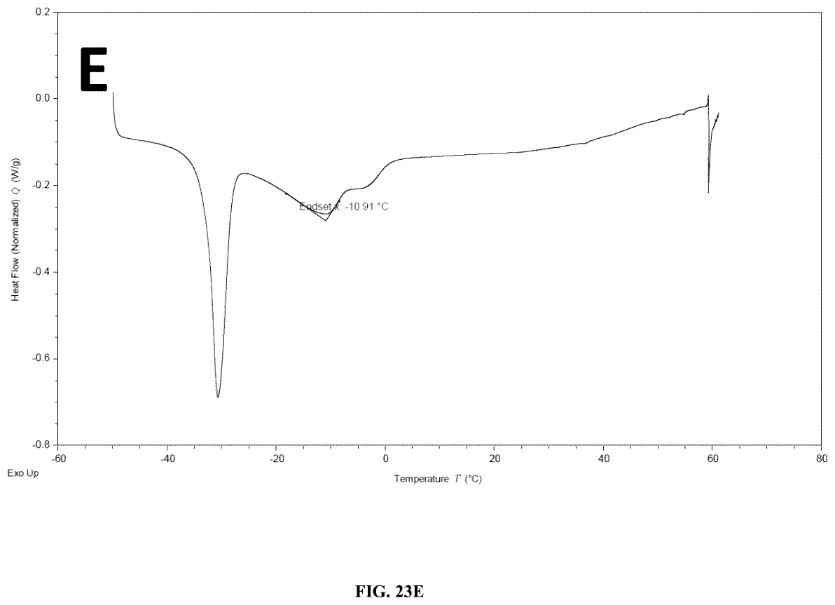

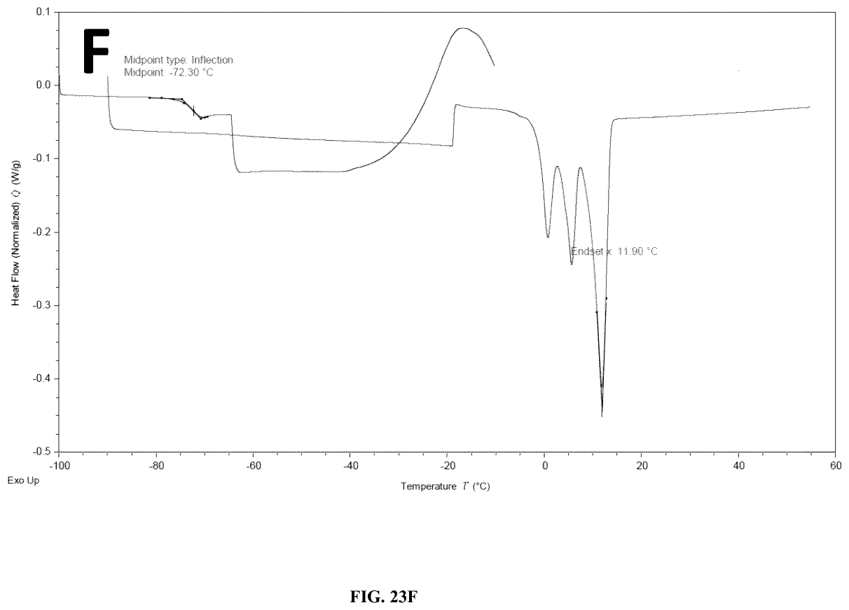

The overall ionic conductivities of LiCl—ZnCl₂—RH₂O were evaluated with different molar ratios of LiCl/ZnCl₂ and at different temperatures in FIG. 7A to understand the interaction between LiCl and ZnCl₂. With the fixed water content (LiₓZn₃₋ₓCl₆₋ₓ·9H₂O), the Li₂ZnCl₄·9H₂O high-entropy electrolyte showed the maximal ionic conductivity in the whole temperature range. This pattern also agreed with the T_{g} (yellow dash line in FIG. 7A) measured by differential scanning calorimetry (DSC, FIG. 23) and a previous report. Since the ion mobility is largely controlled by the viscosity, a lower T_{g} normally translates to a lower viscosity for the liquid electrolytes with a similar ionic strength. The only exception is LiCl·3H₂O (x=3), which has the lowest T_{g} but poor conductivity due to the high liquidus point of 21° C. and phase transition point of −20.1° C. (Tables 1-2). Hydrated zinc chloride is well-known as the liquid salt hydrate system with highest concentration at room temperature, in which hydrated Zn(H₂O)ₓ²⁺ and tetrahedral ZnCl₄²⁻ anion are the most prevalent species as confirmed by the simulations. The redistributed Cl⁻ (from Li⁺ to Zn²⁺) and H₂O (from Zn²⁺ to Li⁺) broke longer ZnClₙ-aggregates, resulting in a high degree (˜0.5) of ion uncorrelated motion (ionicity) at room temperature (FIG. 16). In Li₂ZnCl₄·9H₂O this phenomenon was maximized by LiCl providing excess chloride to Zn ion completely forming ZnCl₄²⁻, with the waters being associated with the Li⁺ cations and substantially dissociating LiCl salt.

TABLE 1
Thermodynamic and transport properties of LiCl•RH₂O
electrolytes predicted by MD simulations using revised
AMOEBA force field, previous experiments (in parentheses)
and experiments performed in this work [in brackets].

| | | | | | Ref. |
|---|---|---|---|---|---|
| | | | | | exper- |
| Composition | LiCl•4H₂O | | LiCl•3H₂O | | iments |
| Concentration (mol kg⁻¹) | 13.88 | | 18.50 | | |
| Simulation box length (Å) | 35.57 | | 57.492 | | |
| Density MD (exp.) | 1216 | (1228) | 1294 | (1279) | 1 |
| (kg m⁻³) | | | | | |
| D_{water}, MD (exp) | 4.4 | (4.0) | 1.5 | (2.4) | 2 |
| (10⁻¹⁰ m² s⁻¹) | | | | | |
| D_{Cl}, MD (exp) | 2.3 | (3.21) | 0.67 | (1.43) | 2 |
| (10⁻¹⁰ m² s⁻¹) | | | | | |
| D_{Li}, MD (exp) | 2.7 | (2.32) | 0.94 | (1.41) | 2 |
| (10⁻¹⁰ m² s⁻¹) | | | | | |
| conductivity MD (exp) | 164 | (105) | 61 | (70) [58] | 3 |
| (mS cm⁻¹) | | | | | |

TABLE 2
Low temperature DSC results of Li₂ZnCl₄•9H₂O

| | | | | Tg/ | Tl/ | Ttr/ | Enthalpy/ | Tk, lr | Tk, lr |
|---|---|---|---|---|---|---|---|---|---|
| Sample | LiCl | ZnCl₂ | xH₂O | ° C. | ° C. | ° C. | Jg⁻¹ | ° C. | stability |
| 1 | 1 | 0 | 3 | −112 | 21 | −20.1 | 95.5 | 5.4 | |
| 5 | 0.833333 | 0.166667 | 3 | −104 | 10.9 | — | | Tg | Crystn |
| | | | | | | | | | after |
| | | | | | | | | | Tg × 2 h |
| 4 | 0.666667 | 0.333333 | 3 | −109 | −10.1 | — | | −27.7 | |
| 3 | 0.5 | 0.5 | 3 | −99.4 | −18.2 | — | | Tg | Crystn |
| | | | | | | | | | after Tg |
| 2 | 0.333333 | 0.666667 | 3 | −83.2 | −10.8 | −33 | 7.5 | −36.2 | |

Tg > glass transition point
Tl > liquidous point
Ttr > phase transition point
Tk, lr > kinetic lower limit of liquid range
Crystn > Crystallization
Tg × 2 h > Crystn occurred on 2nd rescan on heating (or cooling) after first cooling through Tg
Consistent with conductivity drop observation (samples 1-3 and 6)
Inconsistent with conductivity drop observation (samples 4 and 4)

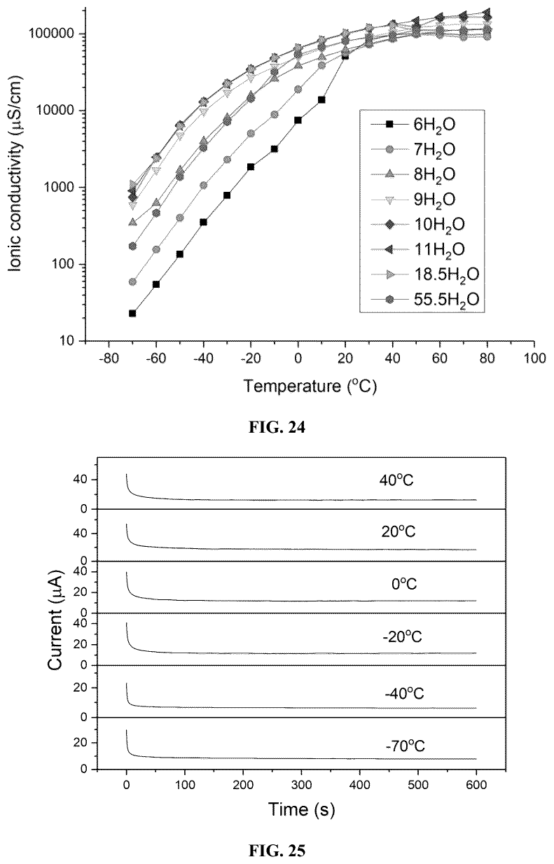

FIG. 7B shows ionic conductivities of Li₂ZnCl₄·9H₂O high-entropy electrolyte in a temperature range from +80 to −80° C., compared with LiCl and ZnCl₂ single salt solutions with the same salt/water ratio=1:3, and their diluted versions with molar concertation of 2 mol/kg. Ionic conductivity of Li₂ZnCl₄·9H₂O at +80° C. is quite high 200 mS·cm⁻¹ and drops only to 20 mS·cm⁻¹ at −20° C., which is still higher than the single salt aqueous solutions. Ionic conductivities fall off slightly faster below −30° C., but still retain conductivities of 1.36 and 0.66 mS·cm⁻¹ at the ultra-low temperatures of −70 and −80° C., respectively. The ionic conductivity of Li₂ZnCl₄·RH₂O high-entropy electrolyte is superior to the most organic electrolytes developed for low temperature operations. Further studies of Li₂ZnCl₄·RH₂O electrolyte system with various concentrations showed similar performances with R from 9 to 18 (FIG. 24). It should be noted that only Li₂ZnCl₄·9H₂O high entropy electrolyte exactly followed the Vogel-Tammann-Fulcher (VTF) equation (dash lines as fitting plots in FIG. 7B)

$$\\ σ = A exp ( - \frac{{E}_{a}}{R ( T - {T}_{0}} )$$

which was usually used to break down the temperature (T) dependence of overall conductivity □ into charge carrier concentration related to the prefactor, A, and structural relaxation and ionic mobility related to the activation energy, Eₐ. The Vogel temperature, T₀, equal to the glass transition in ideal glasses, is 12° C. lower than the measured Tg (−109° C.). This suggests that the high-entropy electrolyte is a fragile glass-former without any crystalline phase transition of water or salt in this temperature range, which is quite rare in aqueous systems33. As a result, Li₂ZnCl₄·9H₂O high-entropy electrolyte was the only electrolyte without thermal hysteresis in cooling-heating cycle between +80 to −80° C. (red line in insert of FIG. 7B), which is tied to battery performance in harsh environments.

As a fragile glass-former, the temperature-dependent conductivity mainly depends on viscosity rather than the charge carrier concentration because viscosity exponentially changes with temperature while charge carrier concentration varies with T^{-1/2}. In order to investigate the cation-anion dissociation or polarity of water at low temperature, the viscosities were measured and separated them from conductivities by the Walden rule (FIG. 7C)

Λη=k

where Λ is the molar conductivity and η is the viscosity; k is a temperature dependent constant. The VTF equation also described the temperature dependence of viscosity for Li₂ZnCl₄·9H₂O, LiCl·3H₂O and ZnCl₂·3H₂O (insert in FIG. 7C) before the crystalline phase transitions occurred.

$$\\ η = {η}_{0} exp ( \frac{B}{T - {T}_{0}} )$$

The Walden plots showed that, at room temperature, Li₂ZnCl₄·9H₂O was in the same “poor-ionic” zone with regular highly-concentrated aqueous systems, due to the massive ion-pairing. Interestingly, the plot of Li₂ZnCl₄·9H₂O was approaching the “KCl line” while the temperature was dropping, and reached the “superionic” zone at −70° C. This indicates that after eliminating ice nucleation and salt recrystallization, the conductivity and viscosity partially decoupled in Li₂ZnCl₄·9H₂O high-entropy electrolyte. The high polarity of water is maintained, translating to the superior transport properties measured for the Li₂ZnCl₄·9H₂O high-entropy electrolyte at ultra-low temperatures.

In order to separate the Li-ion conduction contribution from the Zn-ion transport in this dual-salt system, the transference number t_{Zn}, defined as the net ratio of faradays of charge carried by the Zn constituent, was examined by the steady-state current method in a Zn/Zn symmetric cell. Since the CE of Zn stripping/plating was close to 100% in Li₂ZnCl₄·RH₂O (R≥9), t_{Zn} could be estimated by following equation

$$\\ {t}_{Zn} = \frac{{I}_{s} ( Δ V - {I}_{0} {R}_{0} )}{{I}_{0} ( Δ V - {I}_{s} {R}_{s} )}$$

where I_{S} and I₀ were the steady-state and initial currents respectively when 5 mV of polarization voltages ΔV are applied across the cell (FIG. 25). R₀ and R_{S} were the initial and steady-state resistances measured by electrochemical impedance spectroscopy (EIS) to balance the potential change of interface resistance. Interestingly, all the t_{Zn} were found to be from 0.41 to 0.25 with the R from 9 to 6 at room temperature and deceased slowly while the temperature dropped to −70° C. (FIG. 7D). This large portion of Zn contribution to overall conductivity is likely due to high mobility of [ZnCl₄]²⁻ and back diffusion of Cl⁻ and/or fast moving (LiCl₂)⁻ complexes. In addition to ion transport, the overall feature of microscopic dynamics for water molecules was investigated using high flux neutron backscattering spectrometer (HFBS). FIG. 7E shows the elastic fixed window scans (EFWSs) of Li₂ZnCl₄·9H₂O high-entropy electrolyte, LiCl·3H₂O and ZnCl₂·3H₂O reference electrolytes, which determine the temperature at which different dynamic processes activate within the time window (˜100 ps-2 ns) of a given spectrometer. The main contribution to the intensity measured is from the incoherent scattering from H atoms, the mean square displacement, <Δr²>, is evaluated from the measured elastic intensity I(Q,T) equation:

$$( I ( Q , T ) / I ( Q , 4 K ) ) ∝ exp ( - 1 / 3 {Q}^{2} 〈 Δ {r}^{2} 〉 )$$

where Q is wave vector transfer. Similar to the overall conductivity and viscosity, Li₂ZnCl₄·9H₂O high-entropy electrolyte entered the time window until the temperature dropped to about −50° C. (red hollow circles) and exited the broad transition at the T_{g} point (about −110° C.), without any hysteresis during the heating cycle as well (solid circles). By contrast, both LiCl·3H₂O and ZnCl₂·3H₂O entered the time window much earlier at around 0° C. and −20° C. respectively, which correlate with deviation from VTF behavior (FIG. 7B). Moreover, a crystallization point was observed at −30° C. in cooling and −10° C. in heating for LiCl·3H₂O.

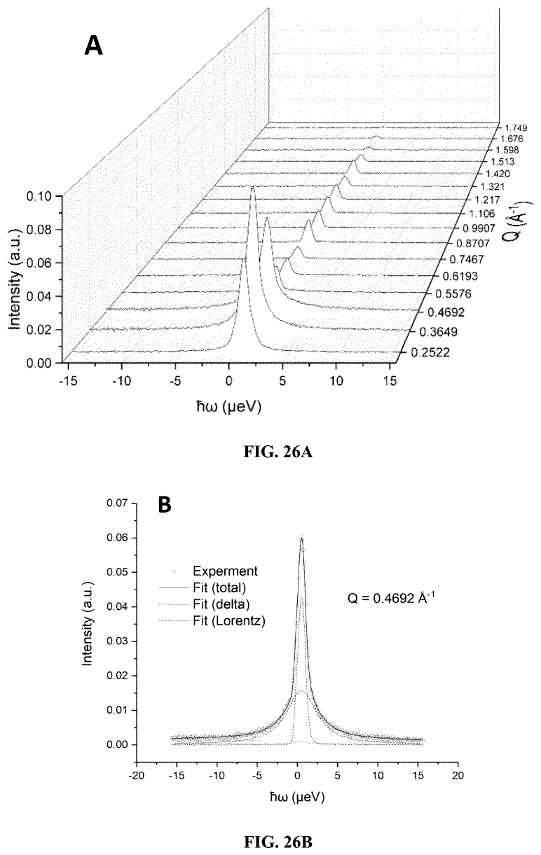

Quasielastic neutron scattering (QENS) was also used to examine the motions of water in Li₂ZnCl₄·9H₂O high-entropy electrolyte, probing relaxations in a wide time ranging from ˜100 ps to 2 ns at 200, 220, 240 and 260 K, respectively. FIG. 26 shows the dynamic structure factor as a function of momentum and energy transfer at different temperatures, which were dissociated into elastic and quasielastic intensities by fitting with delta and Lorentz functions. The quasielastic mode is extracted by a Lorentzian function, whose half width at half maximum (F) increases with Q² and could be reproduced by the ‘jump diffusion model’ (FIG. 7F)

$$Γ = \frac{{DQ}^{2}}{1 + {DQ}^{2} {τ}_{0}}$$

where D is the translational diffusion coefficient and to represents a characteristic residence time between jumps. The fast dynamics of H atoms in water molecules were retained at low temperatures, with the relaxation time of this mode only increasing from 28 to 500 ps while the temperature dropped from 260 to 220 K. The fragility of this water motion mode, which characterizes how rapidly the dynamics slows down upon cooling toward T_{g}, was roughly evaluated by an “Angell plot” with a following definition (inset in FIG. 7F):

$$m = \frac{d ( log {τ}_{0} )}{d ( \frac{{T}_{g}}{T} )} \vert T = {T}_{g}$$

where m is the “kinetic fragility index” with a value estimated to be 11. It should be noted that this “linear” fitting in a very narrow temperature range does not mean that it obeys Arrhenius behavior. However, this fragility estimation indicates that this high-entropy system can retain high kinetics until the temperature drops very close to T_{g}, as demonstrated in conductivity behavior (FIG. 7B).

### Example 12. Electrochemical Performance of Electrolytes

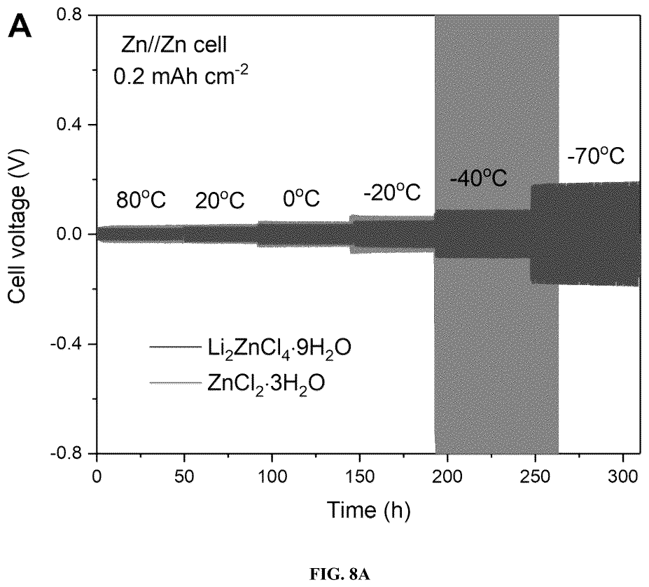

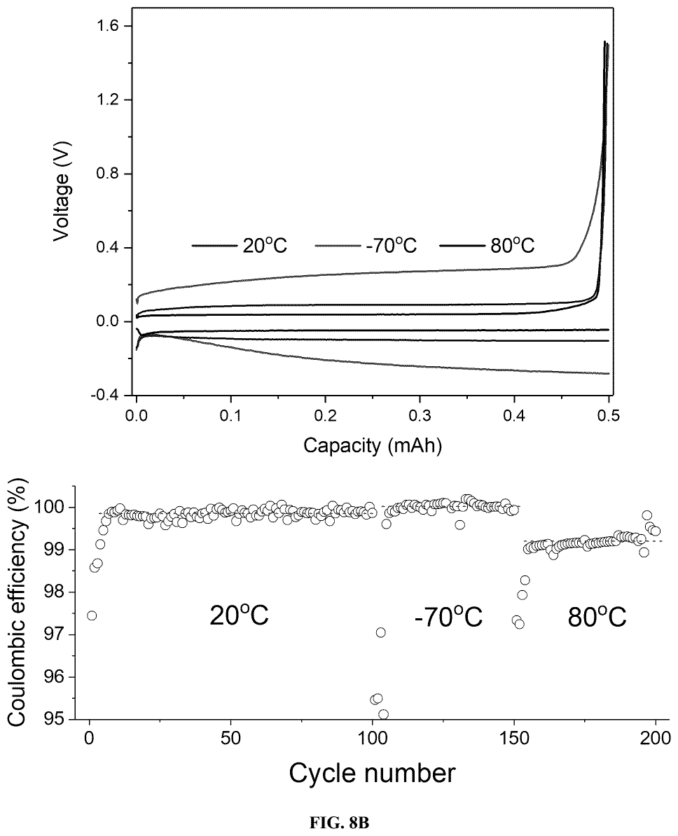

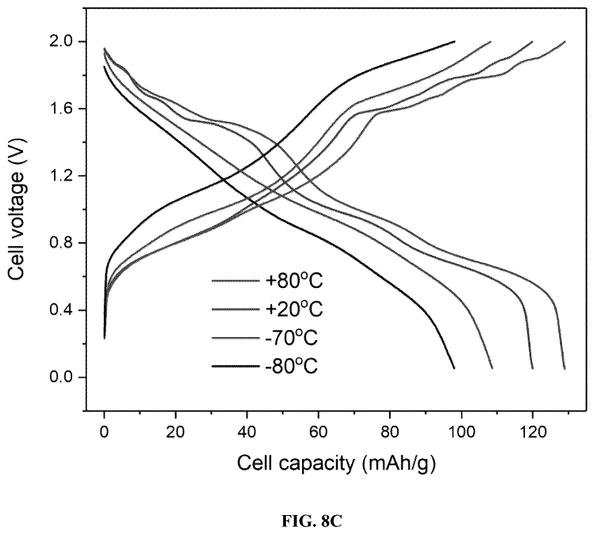

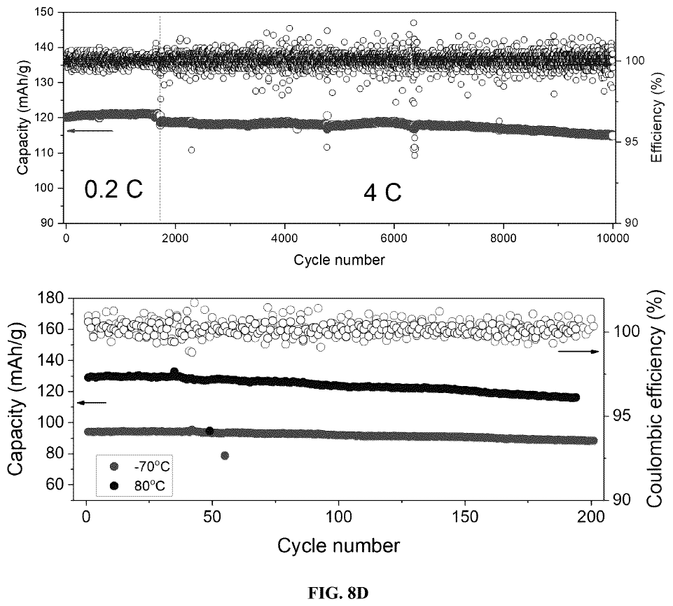

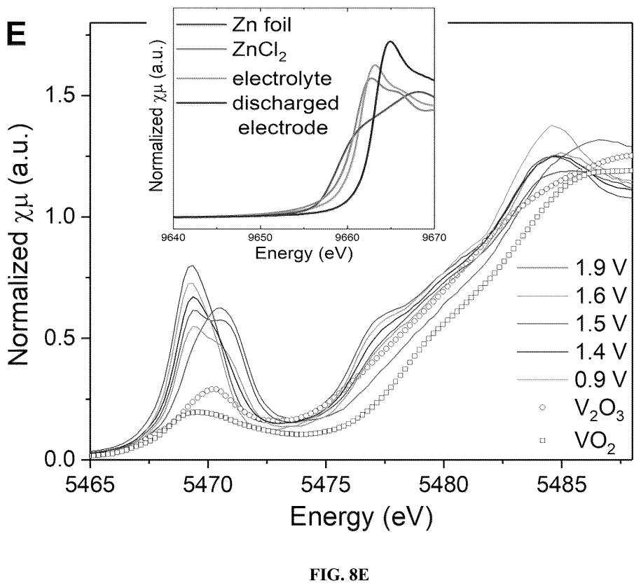

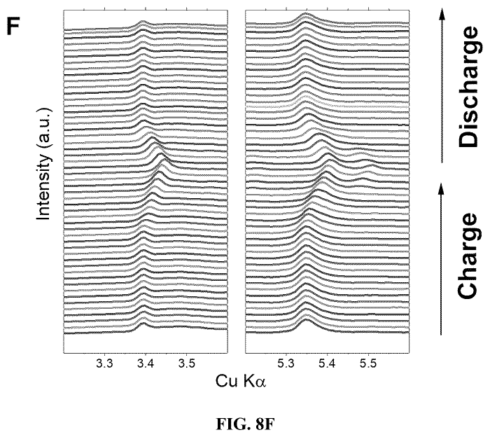

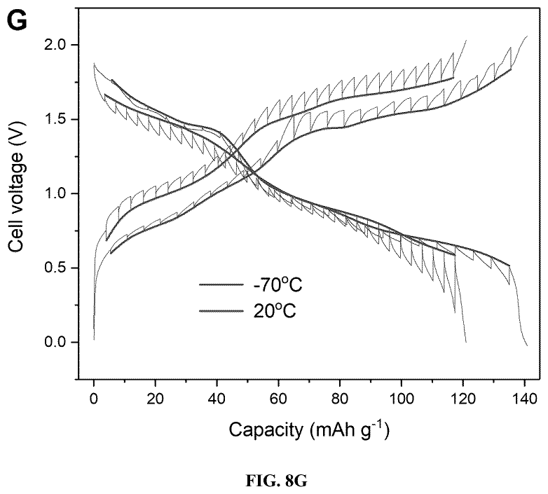

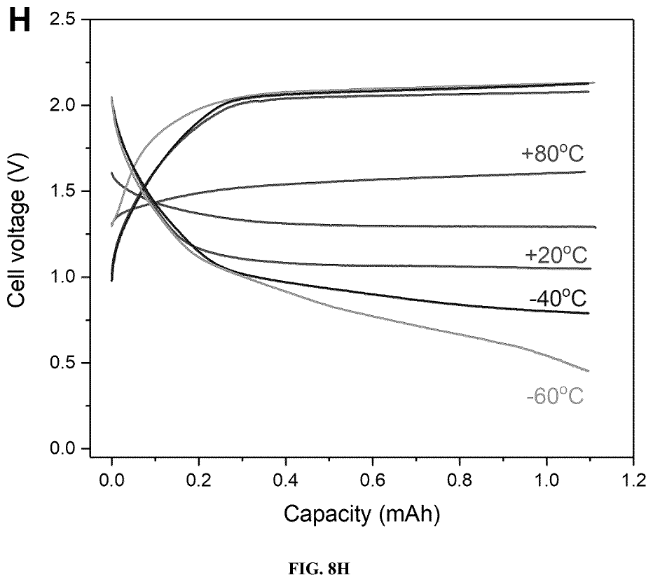

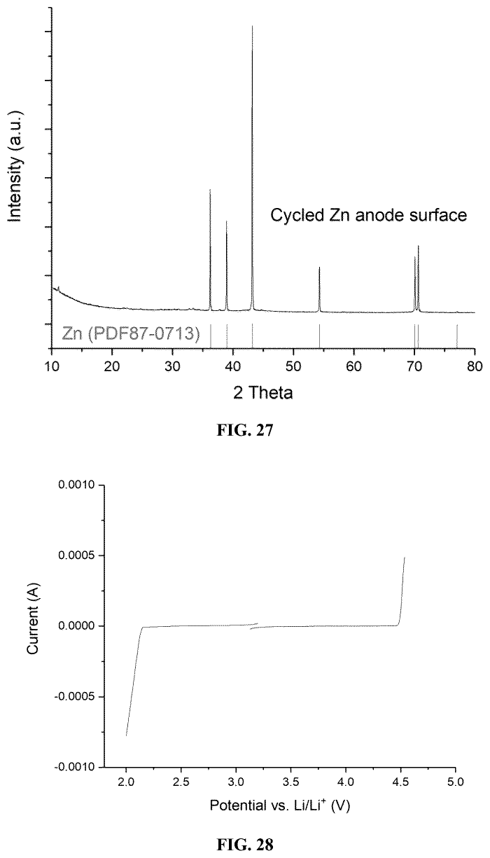

The electrochemical performance of the Zn metal anode in Li₂ZnCl₄·9H₂O high-entropy electrolyte and ZnCl₂·3H₂O reference electrolyte were evaluated at different temperatures using the Zn∥Zn symmetric cells. The Zn∥Zn symmetric cells were charged/discharged at a current density of 0.2 mA cm⁻² for 30 min (0.1 mAh cm⁻² capacity) in the temperature range of 80° C. to −70° C. (FIG. 8A). The Zn∥Zn symmetric cell voltage (a sum of the overpotentials for Li stripping/plating) in Li₂ZnCl₄·9H₂O high-entropy electrolyte shows excellent stability with a negligible voltage fluctuation during repeated cycling. The overpotential of the cell only increases from 52 mV at 20° C. to 201 mV at −70° C., in accordance with the change in conductivities and transference numbers with temperature (FIG. 7). Due to the strong coordination ability of Cl⁻ ions to Zn²⁺ and absence of water in the Zn²⁺ coordination shell, Li₂ZnCl₄·9H₂O high-entropy electrolyte did not form any solid electrolyte interphase (SEI) on the Zn metal anode, ensuring a fast surface charge transfer even at a low temperature. ZnO was not observed on the Zn anode neither since Zn-ion does not solvate with water (FIG. 27). Note that the high SEI resistance at low-temperature was identified as a critical limit for the low temperature performance of organic electrolyte Li-ion batteries in addition to low conductivity of organic electrolytes. By contrast, the Zn∥Zn symmetric cell with ZnCl₂·3H₂O electrolyte showed a dramatic increase in overpotential to >1.0 V at −40° C. due to formation of ZnO passivation layer.

CE of Zn plating/stripping with Li₂ZnCl₄·9H₂O high-entropy electrolyte at different temperatures were also evaluated using Ti∥Zn asymmetric cells at a current density of 0.5 mA cm⁻² for 1.0 h (FIG. 8B). Ti∥Zn asymmetric cells with Li₂ZnCl₄·9H₂O high-entropy electrolyte achieved a stable CE of ˜99.99% after 20 cycles at 20° C. and maintained this high CE over 100 cycles. The average CE increased to ˜100% at −70° C. due to further reduced activity of water. Meanwhile, the CE dropped slightly to 99.95% after the temperature was raised to 80° C., due to increased kinetics for water reactivity on Zn metal anode. A high and stable CE of Zn electrode across the whole temperature range of −80° C. to +80° C. has not previously been reported in aqueous electrolytes. The CE of Zn anodes at 25° C. and −80° C. with Li₂ZnCl₄·9H₂O high-entropy electrolyte are also among the highest reported for Zn anodes in aqueous electrolytes at the same condition. The high CE in Li₂ZnCl₄·9H₂O high-entropy electrolyte is attributed to the exclusive tetrahedral coordination of water-free ZnCl₄²⁻ in Li₂ZnCl₄·9H₂O electrolyte that effectively suppresses hydrogen evolution, providing a 2.3 V electrochemical stability window, which was only limited by the reduction of Zn²⁺ and the oxidization of Cl⁻ instead of water decomposition (FIG. 28).

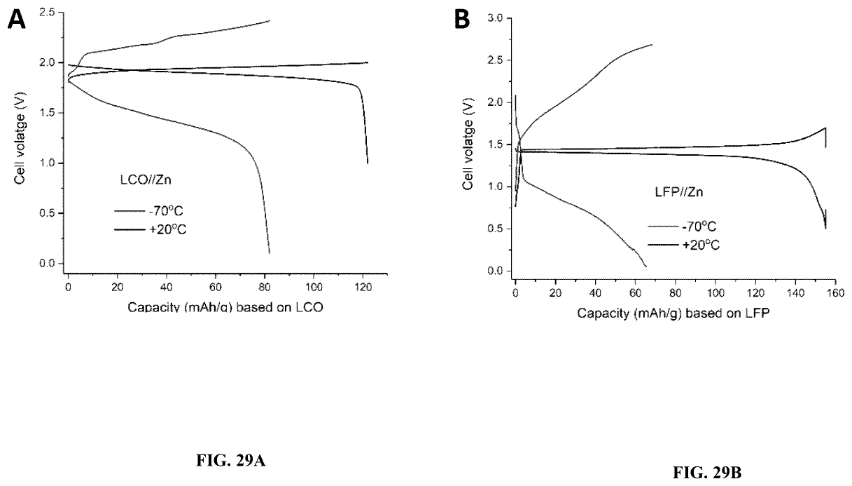

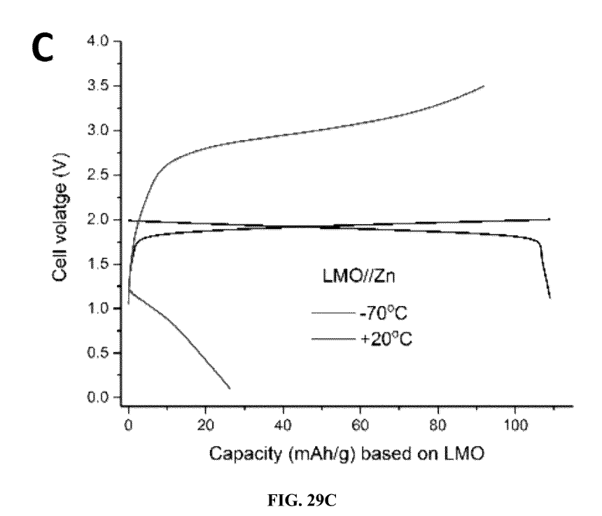

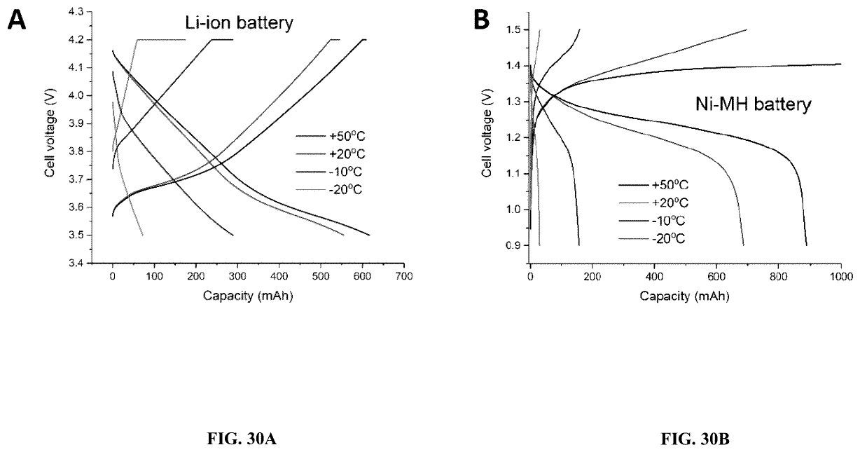

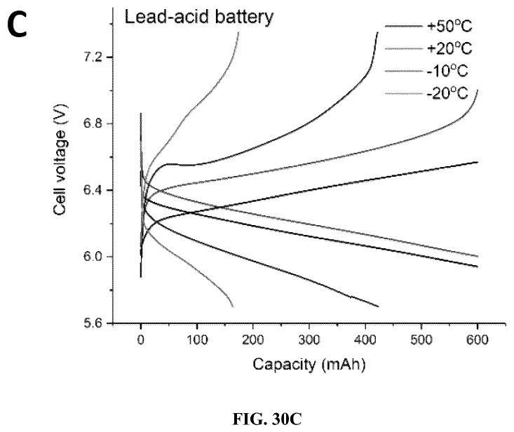

The ZnₓVOPO₄·2H₂O cathode showed much better Zn insertion/extraction performance than other delithiated Li-ion battery cathodes in Li₂ZnCl₄·9H₂O electrolyte at a low temperature of −70° C. due to fast Zn-ion diffusivity in ZnₓVOPO₄·2H₂O cathode (FIG. 29). Therefore, ZnₓVOPO₄·2H₂O cathode was chosen to assemble Zn∥ZnₓVOPO₄·2H₂O pouch full cells, which demonstrated the unprecedented cycling stability in Li₂ZnCl₄·9H₂O high-entropy electrolytes at a wide operation temperature ranges (FIG. 7C). A 100 mAh ZnₓVOPO₄·2H₂O∥Zn pouch cell with Li₂ZnCl₄·9H₂O high-entropy electrolytes showed specific capacities of 121 mAh g⁻¹ (of ZnₓVOPO₄·2H₂O mass) at 20° C. and 130 mAh g⁻¹ at 80° C. at a C/10 rate (1.5 mA cm⁻²). Notably, at −70° C. and −80° C., the Li₂ZnCl₄·9H₂O electrolyte still provided a 90.0% and 81.1% discharge capacity retention relative to 20° C., respectively, which is superior to other reported low-temperature rechargeable batteries. By contrast, all the commercial batteries fail to cycle properly because of a high cell impedance below −20° C. at the C/10 rate (FIG. 30). Even with perfect thermal insulation and management without any energy loss during heat transfer, the energy output of a commercial Li-ion battery with an energy density of 250 Wh kg⁻¹ was estimated to waste more than 75% on its own heating system at the operating temperature of −70° C., which makes this aqueous battery more energy efficient and safer for extreme applications.

Besides of the high capacity retention at a low-temperature, the ZnₓVOPO₄·2H₂O∥Zn full cell with Li₂ZnCl₄·9H₂O high-entropy electrolyte also exhibited excellent cycling stability, rate capability and CE in all temperatures (FIG. 8D). At 20° C. and C/5 rate, almost zero capacity decay was observed during 1800 charge/discharge cycles, and only 0.0005% capacity decay per cycle was observed in the following 8200 cycles at 4 C. At −70° C. and 80° C., 97.3% and 92.7% of the initial capacity were retained after 200 cycles at a C/10 rate. A slightly faster capacity decay at the high temperatures is possibly attributed to the elevated corrosion by Cl⁻ ions, which can be prevented by a surface coating. Remarkably, average CEs of >99.99% were achieved at room-temperature and low-temperatures, which promotes a long lifetime for zinc batteries. Otherwise, excess Zn anode mass, a component to compensate for Zn²⁺ consumption, would bring down the overall cell energy density, since the capacity ratio of positive/negative electrodes is 1:1.5.

The mechanism for Zn cation insertion into the ZnₓVOPO₄·2H₂O cathode in Li₂ZnCl₄·9H₂O electrolyte was investigated using X-ray absorption near-edge structure (XANES) spectra (FIG. 8E). For the Zn K-edge, the absorption edge of the fully discharged cathode (full Zn insertion) at 0.0V (vs. Zn) showed a strong blue shift from Zn metal. Using Zn metal, ZnCl₂ crystal, and Li₂ZnCl₄·9H₂O electrolyte as reference samples, Zn inserting into the crystal structure of cathode with oxidization valence of +2 (inset in FIG. 8E) was confirmed. On the other hand, the V K-edge of the cathodes extracted at different cell voltages could precisely describe the redox process of V, which also reflected the cation insertion behavior (FIG. 8E). Two spectra of VO₂ and V₂O₃ were used as references for V^{IV} and V^{III}, respectively, although the coordination environments for V in pure oxides and phosphate would be slightly different. Interestingly, the pre-edge peak and absorption edge of the cathode at a fully charged state (1.9 V) suggested that most of V stayed in +4 of oxidization valence, instead of V⁺⁵ implied by its formula of VOPO₄·2H₂O. The reason for this discrepancy might be due to the presence of hydronium ions (H₃O⁺) instead of water molecules resulting from its synthesis in an acidic aqueous environment. The greenish color and reaction potential of ˜4 V vs. Li/Li⁺ are also typical of V^{IV}. During discharge of the cathode, the pre-edge peak and absorption edge shifted towards V^{III}, indicating one-electron transfer redox with a theoretical capacity of ˜120 mAh g⁻¹ which is consistent with this observation. Notably, the oxidization valence of V changes much faster above 1.4 V, implying at least two different cation insertion phases existing in the charging process.

The detailed structural evolution of the ZnₓVOPO₄·2H₂O cathode during the charge/discharge process was also investigated using in-situ X-ray powder diffraction (XRD) (FIG. 8F). Due to the exchange of water molecules and hydronium ions (H₃O⁺) in the interlayer along with cation insertion/extraction, the (0 0 c) diffraction corresponding to the change in interlayer distance was not as sensitive as regular layered materials. Hence, two diffraction peaks associated to unit cell parameter a were closely examined, which were indexed as (2 0 0) (left in FIG. 8F) and (3 0 1) (right in FIG. 8F) at the fully discharged state of VOPO₄·2H₂O (JCPDS card No. 84-0111). Interestingly, the d-spacings only shifted slightly from 3.13 Å to 3.19 Å for (2 0 0) and 2.00 Å to 2.02 Å for (3 0 1), when the cell discharged from 2.0 V to 1.4 V, and were unchanged with continued discharging to 0 V. The same two-phase charge/discharge process observed by XANES and in-situ XRD implied two different modes for insertion/extraction of cations, which are related to the exchange of water of constitution. Previous studies have reported that two types of water molecules exist inside of VOPO₄·2H₂O structure. One is directly bonded with V-O octahedron (type A) and the other (type B) formed the Van der Waals gap with type A water. Thus, at the first stage of discharge (2.0 V to 1.4 V), the inserted cations replace type A water, inducing a more substantial change in the average oxidation state of V and the ab plane distortion than the subsequent replacement of type B water in the following insertion (1.4 V to 0 V). The extraction of water occurs simultaneously with cation insertion in both phases of discharging, sparing the cations from overcoming the energy barrier of interlayer expansion. As a result, the galvanostatic intermittent titration technique (GITT) of ZnₓVOPO₄·2H₂O showed an ultra-low overpotential of 25 45 mV at 20° C. and 90-131 mV at −70° C. (FIG. 8G), where the diffusion coefficients in the solid phase were estimated to be 2×10⁻¹³ cm² s⁻¹ at 20° C. and 4×10⁻¹³ cm² s⁻¹ at −70° C., respectively. After eliminating all the polarizations, the quasi-equilibrium profiles (bold curves) at −70° C. showed both capacity and potential close to room-temperature performance, which proves ZnₓVOPO₄·2H₂O an excellent candidate material for an all-temperature aqueous battery.

Air cathodes were also used to assemble Zn-air pouch cells to demonstrate the versatility of Li₂ZnCl₄·9H₂O high-entropy electrolyte. Alkaline Zn-air batteries have very high energy density, but suffers from poor kinetics and cycle life due to reaction of CO₂ in air with KOH electrolyte, and cannot operate at a low temperature. Here, the Zn-air cell using a (Pt—C) catalyst loaded porous carbon cathode and Li₂ZnCl₄·9H₂O electrolyte was examined at the temperature range between 80° C. and −70° C. with a current density of 50 mA g⁻¹ (based on the catalyst mass in the cathode). FIG. 8H shows 11-hour charge/discharge profiles of this cell with an average discharge potential of 1.15 V, followed by the 1.98 V charge potential at 20° C. Notably, the average discharge potentials only shifted to 0.85 V and 0.74 V after the temperature dropped to −40° C. and −60° C., respectively, along with unmoved charge potentials. The Li₂ZnCl₄·9H₂O electrolyte enables a Zn-air battery with an excellent temperature range which has not observed in any other known electrolytes.

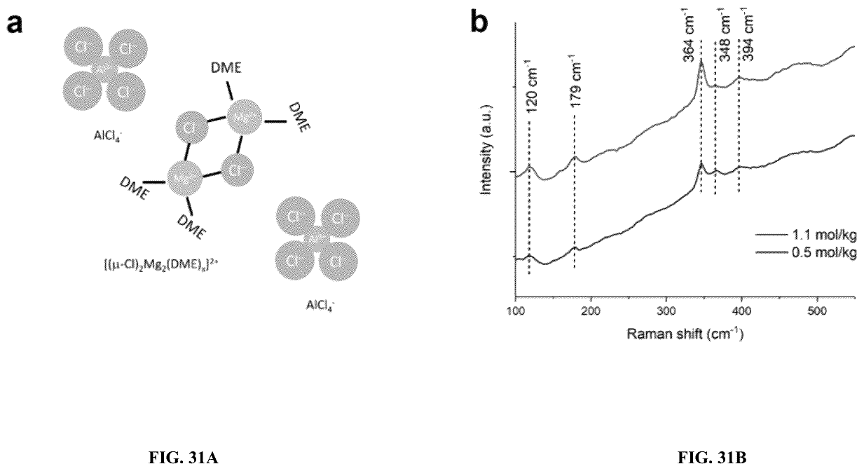

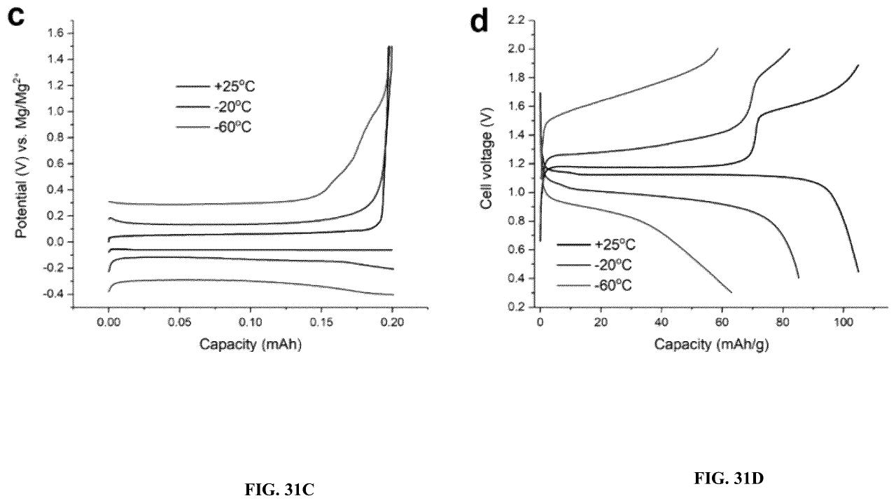

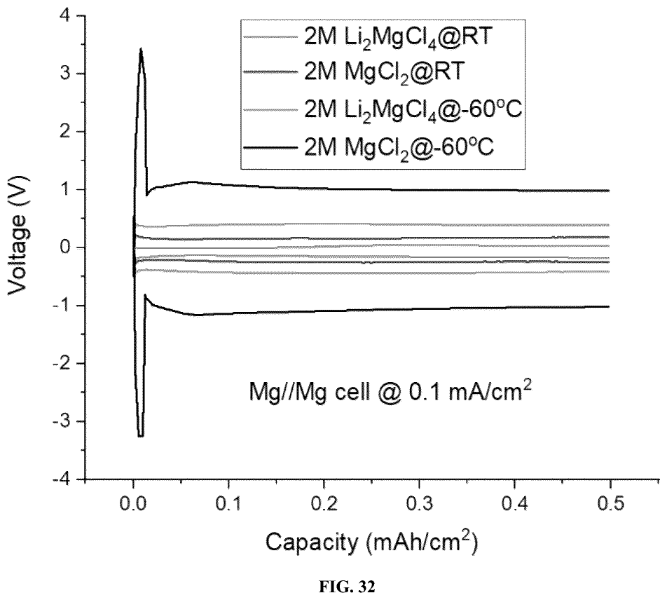

The concept of high entropy electrolyte was also demonstrated for non-aqueous electrolytes using a mixture of aluminum chloride (AlCl₃) and magnesium chloride (MgCl₂) in 1:1 molar ratio in 1,2-dimethoxyethane (DME) that formed high-entropy non-aqueous electrolytes with salt concentrations ranging from 0.1 mol/kg to 1.1 mol/kg. These electrolytes also exhibit excellent transport properties at low temperature. Just as the Li₂ZnCl₄·RH₂O high-entropy electrolytes, Cl⁻ is abstracted from MgCl₂ as viable Mg source to Al Lewis acid (AlCl₃), forming a dim-r dication [(μ-Cl)₂Mg₂(DME)ₓ]²⁺ and tetrahedral anion, AlCl₄— (FIGS. 31A and 31B). The complex dimer dication dramatically increases the concentration of the MgCl⁺ monomer, which exhibits weaker interactions with solvent molecules, resulting in extraordinary reaction kinetics (<50 mV) and CE>99% of Mg deposition/stripping at a current density of 0.1 mA/cm2 (FIG. 31C). The solvation structure in the MgAlCl₅·10DME electrolyte enable the DME solvent to dissolve up to 1.1 mol kg⁻¹, which is much higher than the solubility of single salts of MgCl₂ and AlCl₃ in DME. The MgAlCl₅·10DME (1.1 mol kg⁻¹) non-aqueous high-entropy electrolytes achieved high ionic conductivities of 7.28 and 9.14 mS·cm⁻¹ at 20° C. and 0.81 and 1.33 mS·cm⁻¹ at −70° C., respectively. Additionally, the freezing point of DME (−58° C. at 1 atm) and recrystallization of chlorine salt in both MgAlCl₅·10DME non-aqueous electrolytes are completely suppressed. A Chevrel phase molybdenum sulfide (Mo₆S₈) cathode coupled with Mg metal anode with MgAlCl₅·10DME high-entropy electrolyte was cycled with a wide operation temperature window (FIG. 31D). At −20° C. and −60° C., the Mo₆S₈/Mg battery retained 81.0% and 60.1% of discharge capacity at 20° C. (105 mAh g⁻¹ at the C/10 rate based on Mo₆S₈ mass), respectively. However, the active cation Mg²⁺ in the MgAlCl₅·10DME high-entropy electrolyte is still partially solvated by a few DME solvent due to the relatively weak coordinates between the supporting cation Al³⁺ and DME compared with Al³⁺ and Cl⁻. To further reduce the amount of DME in the Mg²⁺ solvation sheath thus achieves a higher-entropy electrolyte, completely non-solvating of active cation Mg²⁺ can be achieved by adding supporting cation Li⁺ to fully solvate the DME, enabling high ionic conductivity across an ultra-wide liquidus temperature range and a wide electrochemical stability window. Thus, the performance of high-entropy non-aqueous electrolytes can be further improved by introducing lithium chloride (LiCl) as a support salt into a stronger Lewis acid—magnesium chloride (MgCl₂) non-aqueous electrolyte.

### Example 13. Preparation of Electrodes and Electrolytes

All the chloride salts aqueous electrolytes were prepared by dissolving various molar ratios of anhydrous lithium chloride (LiCl; ≥99%; Sigma-Aldrich), anhydrous zinc chloride (ZnCl₂; ≥99%; Sigma-Aldrich), anhydrous magnesium chloride (MgCl₂; ≥99%; Sigma-Aldrich), aluminum chloride hexahydrate (AlCl₃·6H₂O; ≥99%; Sigma-Aldrich) in water (HPLC grade).

VOPO₄·2H₂O powder was synthesized by mixing 4.8 g of V₂O₅ powder (≥98%; Sigma-Aldrich) in 26.6 mL of 85% H₃PO₄ (ACS reagent, ≥85 wt. % in H₂O; Sigma-Aldrich) and 115.4 ml of distilled water. The mixture was refluxed at 110° C. for 16 h. The yellow-green VOPO₄·2H₂O powder was filtered, washed repeatedly with acetone for two times, and dried under ambient conditions. Zn pre-intercalated compound, ZnₓVOPO₄·2H₂O, was prepared by reaction at ambient temperature of as-prepared VOPO₄·2H₂O powder with stoichiometric amounts of a 0.5 mM solution of the zinc iodide (≥99%; Sigma-Aldrich) in distilled water with magnetic stirring for 12 h, after standing for 24 h in an open environment, the target product was collected. The reaction is illustrated as following:

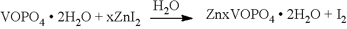

The air cathode for Zn/O₂ battery was prepared by doctor-blade coating the slurry of platinum(20%)/carbon catalysts powder (FuelCellStore), polyvinylidene fluoride (PVDF; 10 wt %; Sigma-Aldrich) and N-Methyl-2-pyrrolidone (NMP; Sigma-Aldrich) on carbon paper (Thickness: 215 μm; FuelCellStore). The areal loading of catalysts was ˜11 mg/cm².

Chevrel Phase Mo₆S₈ was synthesized by recently reported iodine-assisted solid-state reaction58. Briefly, MoS₂, Cu, and Mo powders (≥99%; Sigma-Aldrich) with the molar ratio of 2:1:1 were ball-milled for 2 h at 300 rpm under Ar. Then, the mixtures along with a small amount of iodine were pressed into pellets by a 14 mm diameter mold and sealed in a Swagelok stainless steel vessel, which was gradually heated to 900° C. at 2° C./min and kept for 24 h under Ar. Subsequently, the as-prepared Cu₂Mo₆S₈ precursors were dispersed into 6 M HCl solution for 12 h with oxygen bubbling to leach out Cu. After the reaction, the obtained Mo₆S₈ powder was centrifuged and washed with deionized water three times followed by drying at 60° C. overnight under vacuum.

### Example 14. Electrochemical Measurements

The ionic conductivity measurement was conducted using home-made two Ti disk electrode cell calibrated by 0.1 mol/L NaCl standard electrolyte (Sigma-Aldrich). The four-point EIS measurement was performed with Gamry 345 interface 1000 using 5 mV perturbation with the frequency range of 0.01 Hz to 100,000 Hz an environmental test chamber (Thermal Product Solutions). VOPO₄·2H₂O and Mo₆S₈ cathodes were fabricated by compressing well-mixed active materials, carbon black and poly(vinylidenedifluoride) (PTFE) at a weight ratio of 70:20:10 on a titanium metal mesh (Alfa Aesar, 100 mesh). The areal loading of cathode material was −18 mg cm⁻². Zn/Zn, Ti/Zn, and Mo₆S₈/Mg cells were assembled as CR2032-type coin cells using Zn metal disk (Alfa Aesar, 2 cm²), Mg metal (Alfa Aesar, 2 cm²), as-prepared Mo₆S₈ as electrodes, and glass fiber as separator, respectively. These cells were then galvanostatically charged/discharged using a Land BT2000 battery test system (Wuhan, China) in an environmental test chamber (Thermal Product Solutions). VOPO₄·2H₂O/Zn and Zn—O₂ pouch cells (10 cm×10 cm) were assembled using VOPO₄·2H₂O, Zn on Ti disk, Pb/C catalyst (Fuel cell store) loaded on carbon paper as electrodes, and glass fiber as separator, respectively. Zn—O₂ pouch cell was cut open on cathode side and placed in a pure O₂ chamber. These cells were then galvanostatically charged/discharged using an Arbin electrochemical working station in an environmental test chamber (Thermal Product Solutions). The GITT experiment was performed in a three-electrode device with the same electrode configuration. The cycling protocol consists of 80 mA g⁻¹ (0.2 C) current pulses for 20 min alternated with 120 min OCV periods to reach quasi-equilibrium potentials. The apparent ionic diffusion coefficients (D) of reactants in the LBC-G cathode at the different state of charge and discharge were estimated by the GITT measurement using the following relations:

$$D = \frac{4}{π} {( \frac{{IV}_{m}}{FS} )}^{2} {( \frac{\frac{dE}{dx}}{\frac{dE}{{dt}^{\frac{1}{2}}}} )}^{2}$$

where I is the applied constant current density, Vm is the molar volume of partially hydrated LiBr/LiCl, F is the Faraday constant (96,486 C mol⁻¹), S is the contact area between electrolyte and active materials, dE/dx is the slope of the coulometric titration curve at composition x and dE/dt1/2 can be obtained from the plot of the transient voltage versus the square root of time during constant current pulse.

### Example 15. Raman Spectroscopy

For the solution structure measurements, Raman spectra were collected with a Horiba Jobin Yvon Labram Aramis Raman spectrometer using a laser (wavelength of 532 nm) at frequencies between 3,500 cm⁻¹ and 60 cm⁻¹. 6 spectra per sample were collected and integrated to get a high signal-to-noise ratio.

### Example 16. Measurement of Phase Transition, Glass Transition and Solution Enthalpy

Phase transition, glass transition, and solution enthalpy measurements were conducted at a slow heating rate of 2° C./min using two differential scanning calorimeters (DSC250 or MDSC 2920, both by TA Instruments). A liquid nitrogen cooler was used for low-temperature control, and calibration was performed using the standards of cyclohexane −87.06° C. for a solid-solid transition and 6.45° C. for melting), indium (156.60° C. for melting), and tin (231.93 for melting). For differential scanning calorimetry (DSC) samples, about 10 mg of electrolyte liquid was enclosed in a pair of aluminum pan and lid (0219-0062, PerkinElmer Instruments) and hermetically sealed with a crimper (0219-0061, PerkinElmer). Vitrification of a sample was achieved by pre-dipping the sample into liquid nitrogen and subsequently scanning it up through its glass transition. Crystallization of a sample that was otherwise hard to crystalize was assisted by adding a small amount of mesocarbon microbeads (MCMBs) into the DSC sample as a nucleating agent to induce the desired crystallization.

### Example 17. Molecular Dynamics Simulations

Polarizable force field simulations were performed with an in-house modified version of the TinkerHP v1.0 package and a locally modified AMOEBABIO 2018 force field. Ion charges were reduced by 2.5% and refit the Cl—OH₂ (3.925 Å, 0.32 kcal/mol), Li—Cl (3.7011 Å, 0.1451 kcal/mol), and Zn—Cl (3.48 Å, 0.28 kcal/mol) vdW terms. Scaling the charges slightly had a relatively large impact on the transport properties. All systems were generated with Materials Studio's amorphous cell packing utility at an initial density of 1 g/mL. An initial ˜100 ps NPT calculation was performed to ensure the simulation would be stable and to somewhat relax the box size.

For large cells consisting of ˜2200 waters, constant pressure dynamics were performed for 12 ns at 298.15 K and 1 atm with Berendsen thermostating and barostating and the Beeman integrator with 1.0 femtosecond timestep. Non-bonded terms were cutoff at 10.0 Å with a long-range correction applied to vdW interactions. A PME grid density of 603 was used with 5th order spline and the Ewald alpha was fixed at 0.386 Å⁻¹. The box of final frame of the trajectory was resized to match the average box size from the last 4 ns of the trajectory. Constant volume dynamics were then performed for 24 ns at 298.15 K with Berendsen thermostating and the RESPA integrator with 2.0 fs timestep. Coordinates were saved at a 2 ps frequency and the pressure stress tensor at an interval of 10 fs.

The smaller cells prepared for Born Oppenheimer MD were prepared just as the larger cells but using higher temperatures. Four replicas were prepared. Equilibration under constant pressure conditions was performed for 2-6 ns with the average box size taken from the last 1-2 ns. The final frame was rescaled to this average box size before 8 ns of constant volume dynamics were performed (denoted as replica r4 of Li₂ZnCl₄·6H₂O). Using the same box volume to create a different trajectory, a small 2% increase in the Zn—Cl repulsion term was added to slightly alter the solvation shell around the Zn (denoted as replicas r2 and r3 for Li₂ZnCl₄·6H₂O). Replica r1 for Li₂ZnCl₄·6H₂O was prepared by further increasing the Zn—Cl repulsion to create an initial configuration with an equal contribution of water and Cl⁻ to Zn²⁺ solvation and investigate its evolution. The effect is more pronounced on the 15:1 system than 6:1, where little change in solvation structure is observed. The non-bonded cutoffs are set to at least 7.0 Å but 8.0 Å was used where possible and a 24³ PME grid.

The final structures from the smaller cell NVT runs were then used as inputs for BOMD simulations. All BOMD calculations were performed with CP2K v6.1 at the PBE-D3/DZVP-MOLOPT-SR-GTH level of theory with PBE optimized pseudopotentials for core states using 600 Ry cutoff. Trajectories were heated in 100 K increments to their respective target temperatures using the Bussi velocity rescaling thermostat under constant volume conditions with 20 fs coupling constant. Total annealing time was 10 ps using a 0.5 fs timestep throughout. Up to 145 ps of isotropic constant pressure dynamics was performed starting from the thermalized NVT configurations, with 50 fs coupling constant for the Bussi thermostat. The first 10 ps is discarded as additional equilibration and changes in the coordination number around Zn are monitored after that.

### Example 18. Activity Coefficient Measurements

To study the activity of Li⁺ and Zn²⁺ as a function of the Li⁺ molality, the equilibrium potentials of the LiₓFePO₄ (x=0.5) electrode and Zn metal electrode in various electrolyte solutions were measured using a two-electrode cell with a Ag/AgCl (in saturated KCl aqueous solution) reference electrode, respectively. Water activity measurements were performed using a custom-built vapor pressure measurement apparatus. Solutions were placed into a glass container, which had a sample-to-headspace ratio of approximately 1:1, that was connected to a vacuum system. For purging and degassing, the glass chamber was evacuated using a vacuum pump to P<0.1 kPa and flushed three times with nitrogen. The volume and mass of the solution were measured in control experiments to ensure that the amount of sample loss during purging was negligible. After purging, the chamber was sealed, and the total pressure was monitored as a function of time as the vapor phase equilibrated with the solution phase. When the total pressure reached a constant value, the pressure was recorded. A k-type thermocouple was inserted into the liquid mixture to ensure the temperature was 22° C. before recording the pressure. It was assumed that the vapor phase was pure water (i.e. no salt evaporation). Control experiments were conducted with pure milli-Q water and the tabulated saturated vapor pressure of 2.69 kPa was accurately measured. Raoult's law was used to calculate the water activity in the liquid phase from the measured water vapor pressure.

### Example 19. SANS Measurements

SANS measurements were performed on the very Small Angle Neutron Scattering (vSANS) instrument at the NIST Center for Neutron Research. Samples were contained in 1 mm path standard titanium demountable cells using titanium windows. A closed cycle refrigerator was employed for controlling the sample temperature with an accuracy better than 1 K. Data were collected using two incoming neutron wavelengths of 5 Å and 8.5 Å with a Δλ/λ of ≈0.13. With the combined use of two detector banks, a Q range from ≈10⁻³ Å⁻¹ to 0.2 Å⁻⁴ was covered. Employing standard routines. Raw data were corrected for background, and empty cell scattering, and further reduced to 1D absolute intensity patterns using open beam intensity.

### Example 20. QENES Measurements

QENS measurements were carried out at the high flux backscattering (HFBS) at NIST. Titanium annular cans were used for these measurements as these salts are corrosive to standard aluminum sample holders. The instrument was used in both modes to acquire elastic fixed window scans (EFWS) as well as full quasi-elastic spectra as a function of energy transfers. For EFWS samples were cooled to 4 K and heated back to room temperature at 0.8 K/min with temperature accuracy of better than 0.1 K. Data was collected every 60 seconds while ramping up or down. In this mode, all neutrons that do not exchange energies are recorded and data provides information about phase changes in the samples as well as provide the temperature range for full quasi-elastic spectra. For full quasi-elastic spectra, measurements were made between 8 h-10 h in order to acquire good statistics and Doppler was operated to achieve ±16 eV dynamic range. Sample temperature was equilibrated for 30 mins before measurements. Data was collected in the standard Q range of 0.25 Å⁻¹ to 1.75 Å⁻¹. The instrument resolution was measured by measuring sample at 4 K where sample is expected to scatter elastically. The measured data was fitted to a combination of elastic and quasi-elastic signals

$$I ( Q , ω ) = [ A ( Q ) δ ( E ) + ( 1 - A ( Q ) L ( Γ , ω ) ] ⊗ R ( Q , ω )$$

In the eq. above, A(Q) is the elastic incoherent structure factor while L(Γ,ω) represent a Lorentzian function whose full width at half maximum is Γ(Q). As measured data is broadened due to instrumental resolution, the above entails convolution with instrument resolution function R(Q,ω). The measured intensity was fitted using DAVE software.

### Example 21. X-ray Scattering Spectra

X-ray scattering spectra of aqueous solutions were collected with beamline 11-ID-C at the advanced photon source (APS) at Argonne National Laboratory with light wavelength of 0.11729 Å. Samples with an average volume of ˜0.2 mL were held in a 3 mm quartz tube, while 2D diffraction images were collected on a GE amorphous silicon-based detector. All the data above were acquired at 300 K. PDFs, G(r) were computed using GSAS II software. Scattering from an empty quartz tube was used for background subtraction. Corrections for fluorescence, X-ray polarization, Compton scattering and energy dependent were then applied.

### Example 22. In Situ XRD

In situ XRD measurements was performed at 28-ID-2 beamline of the National Synchrotron Light Source II (NSLS II) at Brookhaven National Laboratory (BNL) using a Perkin Elmer amorphous-Si flat panel detector. The in situ cell is made by assembling active material, carbon black and PTFE binder into a small pouch cell with kapton window. Collected raw image data was then integrated to yield the 2theta-intensity XRD pattern using software Fit2D.

### Example 23. XAFS

XAFS measurements were carried out at the 7-BM (QAS) beamline of NSLS II, Brookhaven National Laboratory. Data was collected in transmission mode using Si (111) double-crystal monochromator detuned to 45-55% (for V) and 70-80% (for Zn) of its original maximum intensity to eliminate the high-order harmonics. Helium-filled tubes were placed before and after the sample to minimize air absorption. Reference spectra of V and Zn foils were simultaneously collected for energy calibration by using the first inflection point as the K-edge. The XAS data was normalized using the ATHENA software package.

### Example 24. Vogel-Tammann-Fulcher Equation

Vogel-Tammann-Fulcher (VTF) equation (dash lines as fitting plots in FIG. 1B),

$$σ = A exp ( - \frac{{E}_{a}}{R ( T - {T}_{0} )} )$$

is used to break down the temperature (T) dependence of overall conductivity σ into a charge carrier concentration term related to a prefactor (A) and structural relaxation and ionic mobility related to the activation energy, Eₐ. The Vogel temperature (T₀) equals the glass transition temperature in ideal glasses.

### Example 25. Walden Rule

The Walkden Rule is given by the following:

Λη=k

where Λ is the molar conductivity and η is the viscosity. k is a temperature dependent constant that quantifies two factors: a) ion motion relative to media fluidity and b) the degree of ion correlation (a_{d}) that is often call ionicity in the literature and is defined using the equation below.

$${α}_{d} = Λ / {Λ}^{N - E}$$

where Λ^{N-E} is conductivity calculated using the Nernst-Einstein relation that does not explicitly include ionic correlations

$${Λ}^{N - E} = \frac{{F}^{2}}{RT} ( {v}_{+} {z}_{+}^{2} {D}_{+} + {v}_{-} {z}_{-}^{2} {D}_{-} )$$

where F is the Faraday constant, R is the gas constant, T is the thermodynamic temperature, v₊ and v₋ are the number of cations and anions per formula unit of electrolyte, z₊ and z₋ are the valences of the ions, and D₊ and D₋ are the diffusion coefficients of the ions. A relation between ad and Walden coefficient (k) could be illustrated by expressing ion diffusion via electrolyte viscosity and ion hydrodynamic sizes using Stokes-Einstein equation D=RT/(6πηr), where r is the radius of the solvated ion shell. Substitution of Stokes-Einstein diffusion coefficients into the Nernst-Einstein equation yields,

$$k = ηΛ = {α}_{d} \frac{{F}^{2}}{6 π} ( \frac{{v}_{+} {z}_{+}^{2}}{{r}_{+}} + \frac{{v}_{-} {z}_{-}^{2}}{{r}_{-}} )$$

The above equation provides a connection between Walden product and degree of ion correlation (cd), hydrodynamic sizes of ions, and valence of charge carriers. Application of this equation for LiCl, ZnCl₂ and ZnCl₂+2LiCl yields,

$${k}_{LiCl} = ηΛ = {α}_{d} \frac{{F}^{2}}{6 π} ( \frac{1}{{r}_{Li}} + \frac{1}{{r}_{Cl}} ) , using {v}_{+} = 1 , {z}_{+}^{2} = 1 , {v}_{-} = 1 , {z}_{-}^{2} = 1 \\ {k}_{{ZnCl}_{2}} = ηΛ = {α}_{d} \frac{{F}^{2}}{6 π} ( \frac{4}{{r}_{Zn}} + \frac{2}{{r}_{Cl}} ) , using {v}_{+} = 1 , {z}_{+}^{2} = 4 , {v}_{-} = 2 , {z}_{-}^{2} = 1 \\ {k}_{{ZnCl}_{2} + 2 LiCl} = ηΛ = {α}_{d} \frac{{F}^{2}}{6 π} ( \frac{4}{3 {r}_{Zn}} + \frac{2}{3 {r}_{Li}} + \frac{4}{3 {r}_{Cl}} ) , \\ using {v}_{Zn} = 1 / 3 , {z}_{Zn}^{2} = 4 , {v}_{Li} = 2 / 3 , {z}_{Li}^{2} = 1 , {v}_{cl} = 4 / 3 , {z}_{cl}^{2} = 1$$

If ion sizes are assumed to be similar to rᵢ one obtains

$${k}_{LiCl} = {k}_{KCl} = ηΛ = {α}_{d} \frac{{F}^{2}}{6 π} ( \frac{2}{{r}_{i}} ) \\ {k}_{{ZnCl}_{2}} = ηΛ = {α}_{d} \frac{{F}^{2}}{6 π} ( \frac{6}{{r}_{i}} ) \\ {k}_{{ZnCl}_{2} + 2 LiCl} = ηΛ = {α}_{d} \frac{{F}^{2}}{6 π} ( \frac{10}{3 {r}_{i}} )$$

These relations indicate that the ideal representing line for ZnCl₂ should be shifted by a factor of 3 that is obtained by dividing the first two equations, while the ideal line for ZnCl₂+2LiCl should be shifted by a factor of 10/6 (assuming 3 moles of salt in calculating molar conductivity).

### Example 26. Activity Coefficient Calculation of Li⁺ and Zn²⁺

The absolute value of the activity coefficient (γ) should be measured based on the assumption that γ is very close to 1 when the concentration is infinitely low. According to the Nernst equation, the equilibrium potential (E) of the electrochemical reactions for ions, both Li⁺ and Zn²⁺, depends on their activity coefficient (γ) in the electrolyte solution:

$$E = {E}_{0} + \frac{RT}{zF} ln ( n γ )$$

where E₀ and n denote the standard reaction potential and the nominal concentration in the solution of the ion, respectively. z is the number of electrons transferred in the cell reaction. Since the activity term of nγ was always ≤1, the actual reaction potential in a solution was reduced by ion-solvent and ion-ion interactions from the standard reaction potential. The obtained γ value of 0.79 for LiCl and 0.22 for ZnCl₂ at 1 mol/L concentration are consistent with the reported values [Journal of the American Chemical Society 56, 1830-1835; J Solution Chem 36, 405-435]. The dilute limit base line was obtained by measuring the equilibrium potential of Li_{0.5}FePO₄ and Zn metal electrodes in 0.005 mol/kg solutions. The error should be very small since the γ value in the high concentration solution is 5×10⁵ times higher than that in 1 mol/kg. The whole calculation process is shown below.

TABLE 3
Li₂ZnCl₄ (Li⁺)

| | | | | | | | | | | |
|---|---|---|---|---|---|---|---|---|---|---|
| Li | 0.005 | 1 | 2 | 6 | 10 | 11 | 12.3 | 13.9 | 15.9 | 18.5 |
| Concentration | | | | | | | | | | |
| (mol/kg) | | | | | | | | | | |
| Equilibrium | 0.340 | 0.205 | 0.23 | 0.322 | 0.392 | 0.437 | 0.472 | 0.5 | 0.54 | 0.58 |
| potential - | | | | | | | | | | |
| E (V) | | | | | | | | | | |
| Li+ activity - | 1.00E+04 | 4.54E+01 | 1.21E+02 | 3.46E+03 | 6.71E+04 | 3.89E+05 | 1.52E+06 | 4.54E+06 | 2.16E+07 | 1.03E+08 |
| a | | | | | | | | | | |
| Li+ fractional | 0.00011 | 0.0175 | 0.0342 | 0.0929 | 0.1417 | 0.1527 | 0.1662 | 0.1819 | 0.2002 | 0.2221 |
| concentration - | | | | | | | | | | |
| n | | | | | | | | | | |
| Li+ activity | | 0.7953 | 0.0720 | 5.6284 | 166.4668 | 1038.2360 | 4430.2881 | 14462.9641 | 75836.7600 | 400679.5470 |
| coefficient - [symbol] | | | | | | | | | | |

TABLE 4
LiCl

| | | | | | | | | |
|---|---|---|---|---|---|---|---|---|
| Li Concentration | 0.005 | 1 | 3 | 6 | 9 | 12 | 15 | 18.5 |
| (mol/kg) | | | | | | | | |
| Equilibrium | 0.336 | 0.200 | 0.250 | 0.307 | 0.361 | 0.404 | 0.4364 | 0.460 |
| potential - E (V) | | | | | | | | |
| Li+ activity - a | 10000 | 44.6890 | 314.5272 | 2909.1088 | 23933.9399 | 128182.2101 | 453921.0234 | 1140200.0000 |
| Li+ fractional | 0.0001 | 0.0177 | 0.0512 | 0.0975 | 0.1394 | 0.1776 | 0.2126 | 0.2498 |
| concentration - n | | | | | | | | |
| Li+ activity | 1 | 0.7902 | 16.1143 | 283.5596 | 3336.7484 | 22769.2271 | 96502.9707 | 284836.3727 |
| coefficient - [symbol] | | | | | | | | |

TABLE 5
LiTFSI

| | | | | | | | | | |
|---|---|---|---|---|---|---|---|---|---|
| Li Concentration | 0.005 | 1 | 4 | 7 | 10 | 13 | 16 | 19 | 21 |
| (mol/kg) | | | | | | | | | |
| Equilibrium | 0.358 | 0.220 | 0.280 | 0.315 | 0.362 | 0.387 | 0.425 | 0.447 | 0.461 |
| potential - E (V) | | | | | | | | | |
| Li+ activity - a | 10000 | 41.6916 | 433.4920 | 1699.0313 | 9838.1457 | 28218.9188 | 124339.2279 | 293419.8713 | 487336.0123 |
| Li+ fractional | 0.0001 | 0.0177 | 0.0672 | 0.1119 | 0.1525 | 0.1896 | 0.2236 | 0.2548 | 0.2743 |
| concentration - n | | | | | | | | | |
| Li+ activity | 1 | 0.7372 | 29.1152 | 190.1227 | 1500.7354 | 5351.0797 | 27802.5819 | 74776.2077 | 133681.529 |
| coefficient - [symbol] | | | | | | | | | |

TABLE 6
LizZnCl4 (Zn²⁺)

| | | | | | | | | | |
|---|---|---|---|---|---|---|---|---|---|
| Zn | 0.005 | 1 | 3 | 5 | 5.5 | 6.15 | 6.95 | 7.95 | 9.25 |
| Concentration | | | | | | | | | |
| (mol/kg) | | | | | | | | | |
| Equilibrium | −0.891 | −0.9734 | −0.9242 | −0.8920 | −0.8880 | −0.8820 | −0.8777 | −0.8700 | −0.860 |
| potential - E (V) | | | | | | | | | |
| Zn2+ activity - a | 10000 | 14.2131 | 539.5096 | 6955.7503 | 9555.9753 | 15387.6242 | 21649.4782 | 39899.2446 | 88265.759 |
| Zn2+ fractional | 0.0001 | 0.0171 | 0.0512 | 0.0826 | 0.0901 | 0.0997 | 0.1112 | 0.1252 | 0.1427 |
| concentration - n | | | | | | | | | |
| Zn2+ activity | 1 | 0.2427 | 27.6409 | 574.3285 | 860.8211 | 1533.6378 | 2407.2101 | 4994.8271 | 12598.595 |
| coefficient - [symbol] | | | | | | | | | |

ZnCl₂

| | | | | | | | |
|---|---|---|---|---|---|---|---|
| Li Concentration | 0.005 | 1.0 | 2.0 | 4.0 | 6.0 | 8.0 | 9.3 |
| (mol/kg) | | | | | | | |
| Equilibrium | −0.886 | −0.970 | −0.946 | −0.906 | −0.865 | −0.824 | −0.802 |
| potential - E (V) | | | | | | | |
| Li+ activity - a | 10000 | 1.25E+01 | 8.39E+01 | 2.01E+03 | 5.21E+04 | 1.35E+06 | 7.75E+06 |
| Li+ fractional | 0.0001 | 0.0177 | 0.0347 | 0.0672 | 0.0975 | 0.1259 | 0.1427 |
| concentration - n | | | | | | | |
| Li+ activity | 1 | 0.2210 | 2.9154 | 135.0001 | 5078.3439 | 169930.2185 | 1106194.6903 |
| coefficient - [symbol] | | | | | | | |

According to the Gibbs-Duhem equation,

$$\sum {x}_{i} d {μ}_{i} + {x}_{w} d {μ}_{w} = Δ G$$

the changes in the chemical potentials of the ions (μᵢ) are not only related to the chemical potential of water (μ_{w}), but also to the change in overall Gibbs free energy, which is the change of dissolution enthalpy for the solution system.

### Example 27. Estimation of Energy Efficiency for Li-Ion Battery with Thermal Management

To maintain the full capacity of Li-ion battery at −70° C., the thermal management system should heat the cells to around 20° C. Even with perfect thermal insulation and zero energy loss during heat generation and transfer, the thermal management system still calls for the consumption of a certain amount of electric energy (Eh) to counter the thermal energy loss into the environment.

Take a 100 Wh cuboid-shaped commercial Li-ion punch cell, for example. Its volumetric energy density is around 700 Wh L⁻¹, which gives a cell volume of around 143 cm³ and surface area 334 cm². Assuming a 3 mm thick thermal insulator, such as polyurethane foam with a thermal conductivity of 0.022 Wm⁻¹K⁻¹, is used for heat preservation, the volumetric energy density will be reduced to 438 Wh L⁻¹ and the battery pack losses to temperature regulation are:

$${E}_{l} = 0.022 {Wm}^{- 1} {K}^{- 1} \times 334 {cm}^{2} \times \frac{293 K - 203 K}{5 mm} = 22. W$$

Hence, a C/3 rate discharge process was estimated to waste more than 66% on its own heating system at −70° C.

### Example 28. Electrolyte Structure from Born-Oppenheimer Molecular Dynamics Simulations

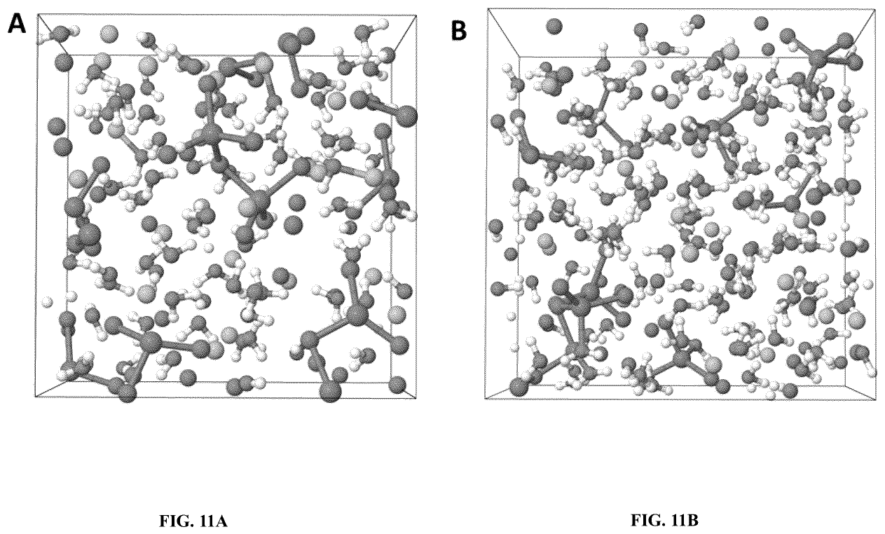

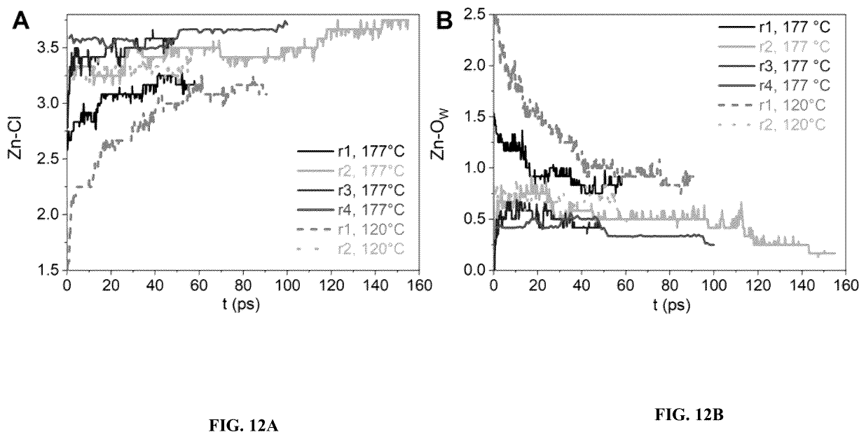

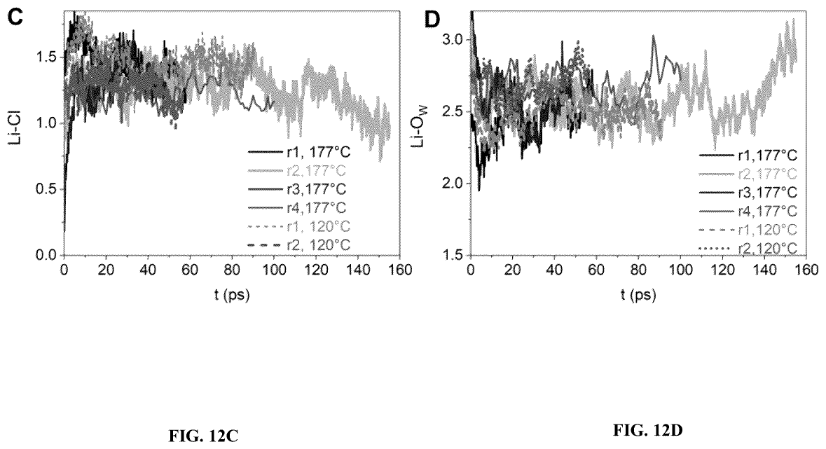

Born-Oppenheimer Molecular Dynamics (BOMD) simulations were performed on Li₂ZnCl₄·6H₂O and Li₂ZnCl₄·15H₂O electrolytes in order to examine the Li⁺ and Zn²⁺ solvation structure in the highly concentrated and relatively dilute regimes, respectively. A simulation cell of Li₂ZnCl₄·6H₂O consisted of 72 H₂O, 24 LiCl and 12 ZnCl₂, while Li₂ZnCl₄·15H₂O simulation cell consisted of 150 H₂O, 20 LiCl, 10 ZnCl₂. FIGS. 11A and 11B shows the representative snapshots of BOMD simulation cells. Four independent replicas of Li₂ZnCl₄·6H₂O electrolyte with quite different initial structures were simulated using BOMD in order to ensure that results are independent from initial configurations. Initially, two independent replicas (r1,r2) were setup using the force field-based MD simulations at 120° C. with an extra Zn—Cl repulsion added for replica r1 yielding a similar number of H₂O and Cl⁻ coordinating the Zn²⁺ cations. Thus, BOMD simulations were started for replicas r1 and r2 using quite different Zn²⁺ coordination environments as shown in FIG. 12A.

After 30 ps of the initial BOMD simulations of Li₂ZnCl₄·6H₂O at 120° C., it became clear that the estimated relaxation time scales for the Zn—Cl coordination exceed ins and equilibrium cannot be completely reached during typical 100 ps BOMD simulations at 393 K. Thus, additional simulations were setup at higher temperature of 177° C. to speed up relaxation and equilibration. The initial configurations for replicas r1 and r2 at 177° C. were taken from BOMD simulations after 30 ps at 120° C., while the initial configurations for replicas r3 and r4 were generated using the force field-based MD simulations. A slightly increased Zn—Cl repulsion was used in MD simulations to generate replica r3.

The time evolution of Zn²⁺ and Li⁺ average coordination shells (see FIGS. 12A and 12B) clearly shows that the Zn—Cl coordination number increases over the course of simulations beyond 3.7 for r2 and r4, while the Zn—H₂O hydration number systematically decreases during BOMD simulations dropping below 0.2 at 177° C. Similar trends are also observed in BOMD simulations at 120° C. but the longer Zn—Cl relaxation times preclude complete equilibration of the ionic environments. Replica r1 that was intentionally setup with the least number of Cl⁻ around Zn²⁺ showed the most pronounced increase of the Zn—Cl coordination number during BOMD simulations. Over the last 20 ps of simulations at 177° C., the potential energy (E) followed the trend E(r1)>E(r3)>E(r2)=E(r4) with replicas r2 and r4 having the lowest potential energy, which indicates that the Zn²⁺ coordination shell with the most Cl⁻ and least H₂O is the most energetically stable. The most energetically favorable replicas r2 and r4 have ˜75% of Zn²⁺ coordinated by 4 Cl⁻ with the probability of such ZnCl₄ coordination increasing during BOMD simulations.

In contrast to the Zn²⁺ clear preference for Cl⁻ over water, the Li⁺ coordination is dominated by water with only 1.0-1.4 Cl⁻ found within 2.8 Å of Li⁺ (the cutoff distance used to define the first solvation shell) (see FIGS. 12C and 12D). The Li-Ow and Li—Cl residence times were around 25-40 ps at 177° C. and 100 ps at 120° C., both of which are substantially shorter than the Zn—Cl residence times. Thus, the composition of the Li⁺ solvation shell is largely equilibrated during BOMD simulations. This is consistent with all replicas yielding similar compositions of the Li⁺ coordination shell with strong preference for water over Cl⁻.

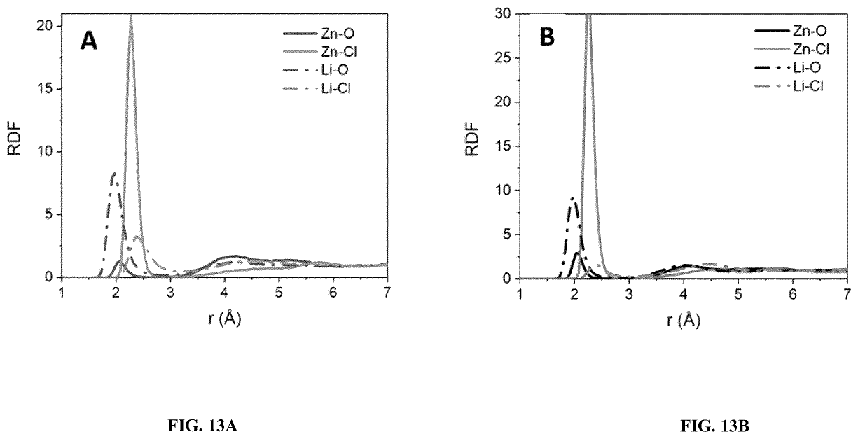

Radial distribution functions (RDF) shown in FIG. 13A further demonstrate strong affinity of Zn²⁺ to Cl⁻ compared to water, and Li⁺ to water vs. Cl⁻ with the Zn—Cl RDF having the highest first peak and Li-Ow having second highest peak. BOMD simulations yield a picture wherein Li₂ZnCl₄·6H₂O electrolyte water preferentially coordinates Li⁺. With only 3 waters per Li⁺ available in Li₂ZnCl₄·6H₂O electrolyte, the Li⁺ cation is coordinated by 2.8-3.0 H₂O, leaving more or less no water to coordinate Zn and no free water. This is similar to previous observations for 20 m LiTFSI+1 m Zn(TFSI)₂ aqueous electrolyte where water had strong preference for Li⁺ and the anion largely coordinated Zn²⁺ with little or no water in the highly concentrated (water-deficient) regime. An X-ray study of the ZnCl₂·2NaCl·RH₂O with a Cl⁻/Zn²⁺ ratio of 7:1 also reported that all of the water molecules in the first coordination sphere of Zn²⁺ are replaced by the Cl⁻ anion and ZnCl₄ is the only complex present in solution. This finding is in agreement with the results for ZnCl₂HCl·RH₂O solution with a Cl⁻:Zn²⁺ ratio of 6 where ZnCl₄ was found to be the only species. Such behavior is consistent with Bjerrum theory that indicates a preference for monovalent ions to serve as anion donors to multivalent ions of the same size due to stronger ion pairing for multivalent cations despite that Bjerrum theory only considers ion pairs. The highly concentrated electrolyte Li₂ZnCl₄·6H₂O gives an example of an extreme behavior where all available water partitions to Li⁺ and all anions to Zn²⁺, possibly excluding water from the plating/intercalation reactions at electrodes.

Another interesting observation is that the number of Cl⁻ around Zn²⁺ and Li⁺ are 3.8 and 1-1.2, respectively, totaling 4.8-5.0 Cl⁻ coordinating cations, while only 4 Cl⁻ are available per cations (2Li⁺ and 1 Zn²⁺) in Li₂ZnCl₄·6H₂O electrolyte. Therefore, some of the Cl⁻ anions are shared between Zn²⁺, connecting them in networks. Indeed, in small BOMD cells with a limited number of ions, numerous Cl₃Zn—Cl—ZnCl₃ configurations were observed, where Cl⁻ is bridging two Zn²⁺ (see FIG. 11).

Next, BOMD simulations of the less concentrated Li₂ZnCl₄·15H₂O electrolyte were analyzed. It was simulated for 100 ps at 393 K using two replicas (r1,r2). Multiple water and Cl⁻ exchanges in the Li⁺ solvation shell were observed during 100 ps of simulations and calculated residence times for both Cl⁻ and H₂O around Li⁺ on the order of 100 ps indicating that the Li⁺ solvation is largely equilibrated. Only slight Li—Cl ion pairing is observed with a Li⁺ being coordinated by 0.26-0.33 of Cl⁻ and 3.74-3.83 waters on average, forming a tetrahedral arrangement around Li⁺. The Zn²⁺ coordination shell relaxation was much slower than that for Li⁺ and is outside of the simulation window. Only one replacement of water for Cl⁻ within the 2.8 Å cutoff defining the coordination shell of Zn²⁺ was observed, indicating that the resulting composition of the Zn²⁺ coordination of 0.8-1.25 water and 2.9-3.2 Cl⁻ is likely not fully converged during 100 ps BOMD simulations. Nevertheless, a comparison of the RDF for Li₂ZnCl₄·6H₂O and Li₂ZnCl₄·15H₂O electrolytes (see FIG. 13B) shows a strong preference of Zn²⁺ to Cl⁻ vs. water and for Li⁺ to water vs. Cl⁻ in both relatively dilute and very concentrated electrolytes.

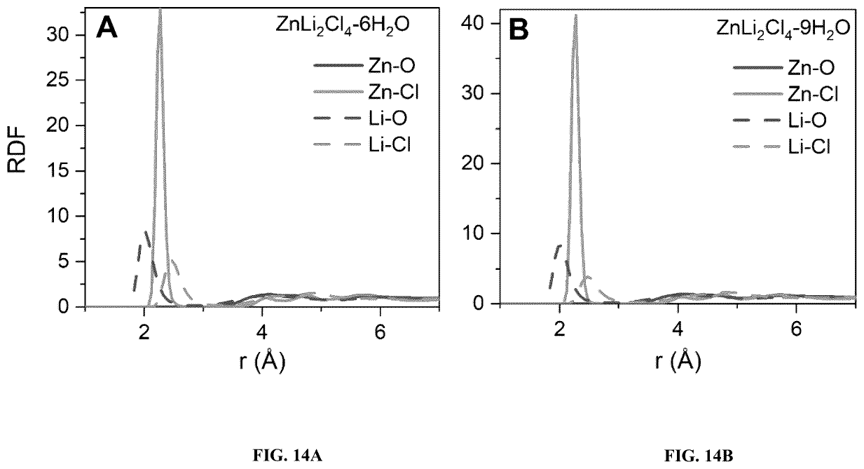

Additional BOMD simulations were performed for Li₂ZnCl₄·RH₂O, R=15, 10, 8, 6 for 100 ps using PBE-D3BJ and revPBE-D3BJ functionals. Initial configurations were taken from simulations using the AMOEBA force field with 0% Zn—Cl repulsion scaling (denoted as r1), 5% increase (denoted as r2), and 7.5% increase (denoted as r3). The scaling is used to produce dissociated Zn—Cl solvation shells dominated by Zn(H₂O)₆ initially. During 100 ps BOMD at 450 K, the Zn²⁺ and Li⁺ solvation environment did not greatly change for replica r1 (0% scaling) as shown in FIG. 14, while a strong association of Zn—Cl was observed for replicas r2 and r3. BOMD simulations using both PBE-D3BJ and revPBE-D3BJ density functionals showed the Zn—Cl coordination number approaching four and being weakly dependent on salt concentration for R between 15 and 6 as shown in FIG. 15B, while the number of Cl⁻ coordinating Li⁺ showed an approximately linear increase with increasing salt concentration and remained below 1.3 even for the most concentrated electrolyte (see FIG. 15B).

### Example 29. Force Field-Based Molecular Dynamics Simulations

Because of the long relaxation time scales (˜ns at 177° C.) of the Zn—Cl ionic aggregates observed in BOMD DFT simulations of Li₂ZnCl₄·RH₂O electrolytes, R=6 or 15, these simulations are too computationally expensive to reliably equilibrate at room temperature and examine ion transport in them. Therefore, force field-based MD simulations were performed. The many-body polarizable AMEOBA force field that includes dipole and quadrupole components of electrostatic interactions was adopted with the following revisions: the Cl—O and Zn—Cl repulsion-dispersion parameters were fit to QC energies for Cl⁻(H₂O)ₙ, n=1-4, 6 and ZnClₙ, n=1-4 obtained using the complete basis set extrapolation composite methodology CBS-QB3. Li—Cl parameters were fit to reproduce the maximum diffusion coefficient in LiCl(H₂O)₄ (increased Rᵢⱼ by 0.2%). The ion charges were reduced by 2.5% to account for charge transfer effects. Simulations were performed using ˜2200 water molecules and between 130 and 550 ZnCl₂ and 260 and 736 LiCl ions depending on the salt concentration with one exception for LiCl3·H₂O electrolyte where a larger simulation cell containing 1536 LiCl and 4608 H₂O was used to better sample low-Q values of the structure factor. The equilibration procedure and simulation parameters are given in the Methodology section.

RDFs for the Li₂ZnCl₄·6H₂O and Li₂ZnCl₄·9H₂O electrolytes from AMEOBA-based MD simulations are shown in FIGS. 13C and 13D. MD simulations predict that the Zn—Cl RDF has the largest peak centered around 2.27 Å with the Li—O RDF having the second most pronounced peak centered at 2 Å in accordance with the DFT-based BOMD simulations of Li₂ZnCl₄·6H₂O (see FIGS. 13A and 13B). The Li—Cl peak centered at 2.45 Å is smaller than the Li—O peak. A very good agreement between RDFs from the force field-based MD simulations and DFT-based BOMD simulations demonstrates the ability of the force field to adequately predict the cation solvation environment, specifically, a strong preference of Zn²⁺ to Cl⁻ with little or no water present and the opposite trend observed for the Li⁺ cation that prefers water over Cl⁻ coordination. Similar trends with a slightly enhanced preference of Li⁺ to water vs. Cl⁻ are observed for Li₂ZnCl₄·9H₂O as shown in FIG. 13. A similar picture showing a strong preference of Li⁺ to coordinate water vs. Cl⁻ was observed in MD simulations of single salt LiCl·RH₂O, R=3, 4 without ZnCl₂, which is in excellent agreement with the previous DFT-based MD simulation results. Density of LiCl·RH₂O, R=3, 4 was predicted within 1.2% of experiments (see Table 8).

TABLE 8
Thermodynamic and transport properties of LiCl•RH₂O
electrolytes predicted by MD simulations using revised
AMOEBA force field, previous experiments (in parentheses)
and experiments performed in this work [in brackets].

| Composition | LiCl•4H₂O | | LiCl•3H₂O | |
|---|---|---|---|---|
| Concentration (m) | 13.88 | | 18.50 | |
| Simulation box length (Å) | 35.57 | | 57.492 | |
| Density MD (exp.) (kg m⁻³) | 1216 | (1228) | 1294 | (1279) |
| D_{water}, MD (exp) (10⁻¹⁰ m² s⁻¹) | 4.4 | (4.0) | 1.5 | (2.4) |
| D_{Cl}, MD (exp) (10⁻¹⁰ m² s⁻¹) | 2.3 | (3.21) | 0.67 | (1.43) |
| D_{Li}, MD (exp) (10⁻¹⁰ m² s⁻¹) | 2.7 | (2.32) | 0.94 | (1.41) |
| conductivity MD (exp) (mS cm⁻¹) | 164 | (105) | 61 | (70) [58] |

The composition of the cation coordination shell for the Li₂ZnCl₄·RH₂O and ZnCl₂·RH₂O electrolytes are compared in FIG. 15. Despite a strong preference for the Zn²⁺ cation to coordinate Cl⁻ in both electrolytes, in the LiCl-free ZnCl₂·RH₂O electrolyte the Zn²⁺ cations have between 0.25 and 1 water in their coordination shell, while in the Li₂ZnCl₄·RH₂O electrolytes the Zn²⁺ cations have no water for R<9. Small amounts of water (0.01-0.04) start appearing in the Zn²⁺ first coordination shell as the electrolyte is diluted past 11 H₂O per ZnCl₂·2LiCl. A strong preference of Li⁺ to water vs. Cl⁻ leads to a relatively high fraction of fully hydrated Li⁺(H₂O)₄ that is solvent separated from the Cl⁻ anions as shown in FIG. 16. Addition of 2LiCl to ZnCl₂·RH₂O provides extra Cl⁻ to complete Zn²⁺ coordination shell. With a sufficient number of Cl⁻ per Zn²⁺ to complete the [ZnCl₄]²⁻ coordination shell there is less driving force for Zn²⁺ to share Cl⁻ via [ZnCl₂] aggregate formation as shown in FIG. 17. Instead, much smaller [ZnCl₄]²⁻, [Cl₂ZnCl₂ZnCl₂]²⁻ complexes are bridged via the Cl—Li—Cl transient bonds or LiCl(H₂O)₃ hydrates with a much shorter bond lifetime compared to the Zn—Cl bonds yielding a less correlated ionic motion as discussed below and observed experimentally in Walden plot FIG. 3C.

The structure factor S(Q) predicted from MD simulations is in good agreement with X-ray measurements (see FIGS. 2C, 19, and 20). The first peak of S(Q) at 1 Å⁻ is mainly due to Zn—Zn, Zn—Cl and a small contribution from the Cl—Cl correlations. The second peak at 2.1 Å⁻ is largely due to Cl—Cl and O—Cl correlations and large negative contribution due to Zn—Zn, while the third peak at 3.5 Å⁻¹ is largely due to Zn—Zn correlations. For LiCl·3H₂O partials show that O—Cl has the largest contribution to the first peak with smaller contributions from the 0-0 and Cl—Cl.

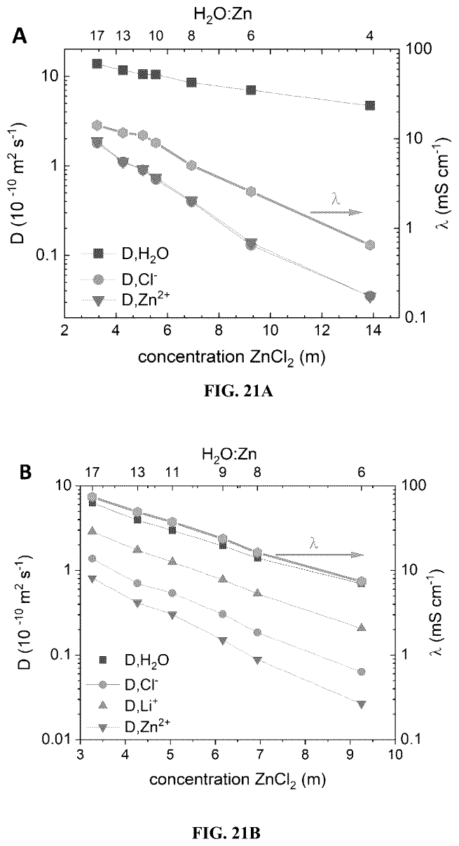

Ionic conductivity and self-diffusion coefficients are shown in FIG. 21 and Table 8. MD simulations slightly underestimate ion diffusion in the concentrated LiCl·3H₂O and LiCl·4H₂O electrolytes (see Table 8), however this prediction is much better compared to underestimation by an order of magnitude or more by 27 classical force fields. In the ZnCl₂·RH₂O electrolytes ion self-diffusion coefficients drop sharply with increasing salt concentration compared to water self-diffusion coefficient that decreases only a factor of three with increasing salt concentration from 3.3 M to 13.9 M. Strong Zn—Cl association leads to similar Zn²⁺ and Cl⁻ diffusion coefficients and low degree of ion uncorrelated motion (ionicity, ad)=0.1-0.13 that is largely concentration independent as a result of the Cl-bridged Zn aggregate formation. MD simulations yield trends for ionicity α_{d} (LiCl·3H₂O)=0.76>α_{d} (Li₂ZnCl₄·9H₂O)=0.48>>α_{d} (LiCl·4H₂O)=0.1 in good agreement with the experimental trends shown in the Walden plot FIG. 2C for these electrolytes at room temperature.

Self-diffusion coefficients in the mixed electrolytes Li₂ZnCl₄-xH₂O electrolytes follow the order D(H₂O)>D(Li⁺)>D(Cl⁻)>D(Zn²⁺) in accordance with the tracer diffusion measurements. The higher degree of ion uncorrelated motion (ionicity, α_{d}) ˜0.5 is due to lower Li—Cl aggregation, much faster Li—Cl exchange, and incorporation of the Li—Cl ion bonds in the longer Cl₂(Zn—Cl₂—Zn—Cl₂—)ₙ aggregates present in ZnCl₂·4H₂O. This results in shorter-lived Cl₂(Zn—Cl₂—Zn—Cl₂)ₘ—Li—Cl—)ₙ aggregates due to faster Li—Cl exchange than Zn—Cl.

### Example 30. LUMO Energies, Reduction Potentials, and Cl⁻/O2⁻ Swapping Free Energies

All calculations were performed at the M052X/6-311++G(3df,3pd) level of theory and used PCM(acetone) or PCM(water) for implicit solvation. These calculations were performed in Gaussian 16 rev C. Especially for the reduction potentials, a partial second solvation shell was added to explicitly solvate either the cation or dissociated anion. There is a noted tendency for undercoordinated cations in particular to produce quite elevated reduction potentials even when implicit solvation models are used. LUMO energies and the free energy differences for swapping Cl⁻/O₂⁻ were abstracted directly from the relevant calculation output files. Reduction potentials for the hydrogen evolution reaction require optimization of a non-reduced species, followed by sampling of the conversion of one of the waters to OH⁻ with subsequent reoptimization. The free energy of the H₂ molecule at the same level of theory and with the same solvation model is computed as well. The expression used for the reduction potential is as follows,

$${E}^{red} = \frac{- [ Δ G ( AOH ) + 0.5 Δ G ( {H}_{2} ) - Δ G ( A ) ]}{nF} - 3.68$$

where, n is the number of electrons, F is Faraday's constant, and species AOH refers to the structure where a water was converted to OH, and species A is the structure with this water intact. The ΔG terms here refer to the free energies taken from the calculation output files in units of Hartree, Faraday's constant can be equivalently taken (to within rounding error) as 23.061 kcal/mol-V after conversion from Hartree to kcal/mol or 27.2114 to convert from Hartree to eV. A 3.68 V shift is used to convert to the Zn scale and assumes an absolute voltage of 4.44 V for the standard hydrogen electrode.

### REFERENCES

A number of patents and publications are cited above in order to more fully describe and disclose the invention and the state of the art to which the invention pertains. Full 10 citations for these references are provided below. Each of these references is incorporated herein by reference in its entirety into the present disclosure, to the same extent as if each individual reference was specifically and individually indicated to be incorporated by reference.
Suo, L. et al. “Water-in-salt” electrolyte enables high-voltage aqueous lithium-ion chemistries. Science 350, 938-943 (2015).
Wang, J. et al. Superconcentrated electrolytes for a high-voltage lithium-ion battery. Nat Commun 7, 12032 (2016).
Suo, L. et al. How Solid-Electrolyte Interphase Forms in Aqueous Electrolytes. Journal of the American Chemical Society 139, 18670-18680 (2017).
Yang, C. et al. Aqueous Li-ion battery enabled by halogen conversion-intercalation chemistry in graphite. Nature 569, 245-250 (2019).
Yang, C. et al. Unique aqueous Li-ion/sulfur chemistry with high energy density and reversibility. Proc Natl Acad Sci USA 114, 6197-6202 (2017).
Suo, L., Hu, Y.-S., Li, H., Armand, M. & Chen, L. A new class of Solvent-in-Salt electrolyte for high-energy rechargeable metallic lithium batteries. Nat Commun 4, 1481 (2013).
Angell, C. A., Ngai, K. L., McKenna, G. B., McMillan, P. F. & Martin, S. W. Relaxation in glassforming liquids and amorphous solids. Journal of Applied Physics 88, 3113-3157 (2000).
Rodrigues, M.-T. F. et al. A materials perspective on Li-ion batteries at extreme temperatures. Nature Energy 2, 17108 (2017).
Scherer, G. W. Editorial Comments on a Paper by Gordon S. Fulcher. Journal of the American Ceramic Society 75, 1060-1062 (1992).
Fan, X. et al. All-temperature batteries enabled by fluorinated electrolytes with non-polar solvents. Nature Energy 4, 882-890 (2019).
Dong, X. et al. High-Energy Rechargeable Metallic Lithium Battery at −70 degrees C. Enabled by a Cosolvent Electrolyte. Angew Chem Int Ed Engl 58, 5623-5627 (2019).
Zhang, Q. et al. Modulating electrolyte structure for ultralow temperature aqueous zinc batteries. Nature communications 11, 1-10 (2020).
Borodin, O. et al. Liquid Structure with Nano-Heterogeneity Promotes Cationic Transport in Concentrated Electrolytes. ACS Nano 11, 10462-10471 (2017).
Horne, R. The Adsorption of Zinc (II) on Anion-Exchange Resins. I. The Secondary Cation Effect. The Journal of Physical Chemistry 61, 1651-1655 (1957).
Kraus, C. A. The Ion-Pair Concept, Its Evolution and Some Applications. The Journal of Physical Chemistry 60, 129-141 (1956).
Sosso, G. C. et al. Crystal Nucleation in Liquids: Open Questions and Future Challenges in Molecular Dynamics Simulations. Chemical Reviews 116, 7078-7116 (2016).
Gu, G. Y. et al. 2-Methoxyethyl (methyl) carbonate-based electrolytes for Li-ion batteries. Electrochimica Acta 45, 3127-3139 (2000).
Angell, C. A. Liquid Fragility and the Glass Transition in Water and Aqueous Solutions. Chemical Reviews 102, 2627-2650 (2002).
Wilcox, R. J. et al. Crystalline and liquid structure of zinc chloride trihydrate: a unique ionic liquid. Inorg Chem 54, 1109-1119 (2015).
Brehler, B. & Jacobi, H. Die Kristallstruktur des Li2ZnCl4·2H2O. Naturwissenschaften 51, 11-11 (1964).
Xu, W., Cooper, E. I. & Angell, C. A. Ionic Liquids: Ion Mobilities, Glass Temperatures, and Fragilities. The Journal of Physical Chemistry B 107, 6170-6178 (2003).
Marcus, Y. & Hefter, G. Ion Pairing. Chemical Reviews 106, 4585-4621 (2006).
Ansell, S., Dupuy-Philon, J., Jal, J. F. & Neilson, G. W. Ionic structure in the aqueous electrolyte glass. Journal of Physics: Condensed Matter 9, 8835-8847 (1997).
Quicksall, C. O. & Spiro, T. G. Raman spectra of tetrahalozincates and the structure of aqueous ZnCl42. Inorganic Chemistry 5, 2232-2233 (1966).
Wilcox, R. J. et al. Crystalline and Liquid Structure of Zinc Chloride Trihydrate: A Unique Ionic Liquid. Inorganic Chemistry 54, 1109-1119 (2015).
Irish, D. E., McCarroll, B. & Young, T. F. Raman Study of Zinc Chloride Solutions. The Journal of Chemical Physics 39, 3436-3444 (1963).
KAJINAMI, A., KUBOTA, M., MIZUHATA, M. & Shigehito, D. The Variation of Structure with Composition for Mixed Molten Hydrate. ECS Proceedings Volumes 1999, 263 (1999).
Maeda, M., Ito, T., Hori, M. & Johansson, G. The structure of zinc chloride complexes in aqueous solution. Zeitschrift für Naturforschung A 51, 63-70 (1996).
Yamaguchi, T., Hayashi, S. & Ohtaki, H. X-ray diffraction and Raman studies of zinc (II) chloride hydrate melts, ZnCl2. rH2O (r=1.8, 2.5, 3.0, 4.0, and 6.2). The Journal of Physical Chemistry 93, 2620-2625 (1989).
Sun, Q. The Raman OH stretching bands of liquid water. Vibrational Spectroscopy 51, 213-217 (2009).
Robinson, R. A. The water activities of lithium chloride solutions up to high concentrations at 25°. Transactions of the Faraday Society 41, 756-758 (1945).
Yamada, Y. et al. Hydrate-melt electrolytes for high-energy-density aqueous batteries. Nature Energy 1, 16129 (2016).
Gislason, E. A. Thermodynamics and Chemistry (DeVoe, Howard). Journal of Chemical Education 78, 1186 (2001).
Stokes, R. H. & Robinson, R. A. Ionic Hydration and Activity in Electrolyte Solutions. Journal of the American Chemical Society 70, 1870-1878 (1948).
Cao, L. et al. Fluorinated interphase enables reversible aqueous zinc battery chemistries. Nature nanotechnology, 1-9 (2021).
Zhang, C. et al. A ZnCl 2 water-in-salt electrolyte for a reversible Zn metal anode. Chemical communications 54, 14097-14099 (2018).
Wang, F. et al. Highly reversible zinc metal anode for aqueous batteries. Nature Materials 17, 543-549 (2018).
Dubouis, N. et al. The fate of water at the electrochemical interfaces: electrochemical behavior of free water versus coordinating water. The journal of physical chemistry letters 9, 6683-6688 (2018).
Biesinger, M. C., Lau, L. W., Gerson, A. R. & Smart, R. S. C. Resolving surface chemical states in XPS analysis of first row transition metals, oxides and hydroxides: Sc, Ti, V, Cu and Zn. Applied surface science 257, 887-898 (2010).
Das, J. et al. Micro-Raman and XPS studies of pure ZnO ceramics. Physica B: Condensed Matter 405, 2492-2497 (2010).
Al-Gaashani, R., Radiman, S., Daud, A., Tabet, N. & Al-Douri, Y. XPS and optical studies of different morphologies of ZnO nanostructures prepared by microwave methods. Ceramics International 39, 2283-2292 (2013).
Sun, W. et al. A rechargeable zinc-air battery based on zinc peroxide chemistry. Science 371, 46-51 (2021).
Rustomji, C. S. et al. Liquefied gas electrolytes for electrochemical energy storage devices. Science 356 (2017).
Dong, X., Guo, Z., Guo, Z., Wang, Y. & Xia, Y. Organic Batteries Operated at −70° C. Joule (2018).
He, S., Nielson, K. V., Luo, J. & Liu, T. L. Recent advances on MgCl2 based electrolytes for rechargeable Mg batteries. Energy Storage Materials 8, 184-188 (2017).
Barile, C. J., Nuzzo, R. G. & Gewirth, A. A. Exploring Salt and Solvent Effects in Chloride-Based Electrolytes for Magnesium Electrodeposition and Dissolution. The Journal of Physical Chemistry C 119, 13524-13534 (2015).
Jacobson, A., Johnson, J. W., Brody, J., Scanlon, J. & Lewandowski, J. Redox intercalation reactions of vanadium oxide phosphate dihydrate (VOPO4·2H2O) with mono- and divalent cations. Inorganic Chemistry 24, 1782-1787 (1985).
Mao, M. et al. Iodine Vapor Transport-Triggered Preferential Growth of Chevrel Mo6S8 Nanosheets for Advanced Multivalent Batteries. ACS Nano 14, 1102-1110 (2020).
Lagardere, L. et al. Tinker-HP: a massively parallel molecular dynamics package for multiscale simulations of large complex systems with advanced point dipole polarizable force fields. Chemical Science 9, 956-972 (2018).
Ren, P. & Ponder, J. W. Polarizable Atomic Multipole Water Model for Molecular Mechanics Simulation. The Journal of Physical Chemistry B 107, 5933-5947 (2003).
Biovia, D. S. Discovery studio modeling environment. San Diego: Dassault Systemes (2015).
Berendsen, H. J., Postma, J. v., van Gunsteren, W. F., DiNola, A. & Haak, J. Molecular dynamics with coupling to an external bath. The Journal of chemical physics 81, 3684-3690 (1984).
Tuckerman, M., Berne, B. J. & Martyna, G. J. Reversible multiple time scale molecular dynamics. The Journal of Chemical Physics 97, 1990-2001 (1992).
Hutter, J., Iannuzzi, M., Schiffmann, F. & VandeVondele, J. CP2K: atomistic simulations of condensed matter systems. Wiley Interdisciplinary Reviews-Computational Molecular Science 4, 15-25 (2014).
Perdew, J. P., Burke, K. & Ernzerhof, M. Generalized gradient approximation made simple. Physical Review Letters 77, 3865-3868 (1996).
Grimme, S., Antony, J., Ehrlich, S. & Krieg, H. A consistent and accurate ab initio parametrization of density functional dispersion correction (DFT-D) for the 94 elements H—Pu. Journal of Chemical Physics 132, 154104 (2010).
Grimme, S., Ehrlich, S. & Goerigk, L. Effect of the damping function in dispersion corrected density functional theory. Journal of Computational Chemistry 32, 1456-1465 (2011).
Goedecker, S., Teter, M. & Hutter, J. Separable dual-space Gaussian pseudopotentials. Physical Review B Condens Matter 54, 1703-1710 (1996).
Hartwigsen, C., Goedecker, S. & Hutter, J. Relativistic separable dual-space Gaussian pseudopotentials from H to Rn. Physical Review B 58, 3641-3662 (1998).
VandeVondele, J. et al. Quickstep: Fast and Accurate Density Functional Calculations Using a Mixed Gaussian and Plane Waves Approach. Comput. Phys. Commun. 167, 103 (2005).
VandeVondele, J. & Hutter, J. Gaussian basis sets for accurate calculations on molecular systems in gas and condensed phases. Journal of Chemical Physics 127, 114105 (2007).
Bussi, G., Donadio, D. & Parrinello, M. Canonical sampling through velocity rescaling. The Journal of chemical physics 126, 014101 (2007).
Martyna, G., Tuckerman, M., Tobias, D. & Klein, M. Explicit Reversible Integrators for Extended Systems Dynamics. Mol. Phys. 87, 1117 (1996).
Kline, S. R. Reduction and analysis of SANS and USANS data using IGOR Pro. Journal of applied crystallography 39, 895-900 (2006).
George, E. P., Raabe, D. & Ritchie, R. O. High-entropy alloys. Nature Reviews Materials 4, 515-534 (2019).
Liu, Y., Zhu, Y. & Cui, Y. Challenges and opportunities towards fast-charging battery materials. Nature Energy (2019).
Fuoss, R. M. & Kraus, C. A. Properties of Electrolytic Solutions. III. The Dissociation Constant. Journal of the American Chemical Society 55, 1019-1028 (1933).
Easteal, A. J., Giaquinta, P. V., March, N. H. & Tosi, M. P. Chemical effects in diffusion and structure of zinc chloride in aqueous solution. Chemical Physics 76, 125-128 (1983).
Choe, C., Lademann, J. & Darvin, M. E. Depth profiles of hydrogen bound water molecule types and their relation to lipid and protein interaction in the human stratum corneum in vivo. Analyst 141, 6329-6337 (2016).
Easteal, A. J., Sare, E. J., Moynihan, C. T. & Angell, C. A. Glass-transition temperature, electrical conductance, viscosity, molar volume, refractive index, and proton magnetic resonance study of chlorozinc complexation in the system ZnCl2+LiCl+H2O. Journal of Solution Chemistry 3, 807-821 (1974).
Diederichsen, K. M., Buss, H. G. & McCloskey, B. D. The Compensation Effect in the Vogel-Tammann-Fulcher (VTF) Equation for Polymer-Based Electrolytes. Macromolecules 50, 3831-3840 (2017).
Evans, J., Vincent, C. A. & Bruce, P. G. Electrochemical measurement of transference numbers in polymer electrolytes. Polymer 28, 2324-2328 (1987).
Kofu, M. et al. Microscopic insights into ion gel dynamics using neutron spectroscopy. Soft Matter 8 (2012).
Angell, C. A. Formation of Glasses from Liquids and Biopolymers. Science 267, 1924-1935 (1995).
Ratnakumar, B. V., Smart, M. C. & Surampudi, S. Effects of SEI on the kinetics of lithium intercalation. Journal of Power Sources 97-98, 137-139 (2001).
Zhang, S. S., Xu, K. & Jow, T. R. Electrochemical impedance study on the low temperature of Li-ion batteries. Electrochimica Acta 49, 1057-1061 (2004).
Casañ, N. et al. Vanadyl phosphate dihydrate, a solid acid: the role of water in VOPO4·2H2O and its sodium derivatives Na x (V IV x V V 1-x O)PO 4·(2-x) H2O. Journal of inclusion phenomena 6, 193-211 (1988).
Kundu, D., Adams, B. D., Duffort, V., Vajargah, S. H. & Nazar, L. F. A high-capacity and long-life aqueous rechargeable zinc battery using a metal oxide intercalation cathode. Nature Energy 1, 16119 (2016).
R'kha, C., Vandenborre, M., Livage, J., Prost, R. & Huard, E. Spectroscopic study of colloidal VOPO4·2H2O. Journal of solid state chemistry 63, 202-215 (1986).
Wu, C. et al. Two-dimensional vanadyl phosphate ultrathin nanosheets for high energy density and flexible pseudocapacitors. Nature Communications 4, 2431 (2013).
Liu, F., Chung, H.-J. & Elliott, J. A. W. Freezing of Aqueous Electrolytes in Zinc-Air Batteries: Effect of Composition and Nanoscale Confinement. ACS Applied Energy Materials 1, 1489-1495 (2018).
Chakkaravarthy, C., Waheed, A. K. A. & Udupa, H. V. K. Zinc—air alkaline batteries—A review. Journal of Power Sources 6, 203-228 (1981).
Azuah, R. T. et al. DAVE: A Comprehensive Software Suite for the Reduction, Visualization, and Analysis of Low Energy Neutron Spectroscopic Data. J Res Natl Inst Stand Technol 114, 341-358 (2009).
Hammersley, A., Svensson, S., Hanfland, M., Fitch, A. & Hausermann, D. Two dimensional detector software: from real detector to idealised image or two-theta scan. International Journal of High Pressure Research 14, 235-248 (1996).
Ravel, B. & Newville, M. ATHENA, ARTEMIS, HEPHAESTUS: data analysis for X-ray absorption spectroscopy using IFEFFIT. Journal of synchrotron radiation 12, 537-541 (2005).
P. D'Angelo, A. Zitolo, F. Ceccacci, R. Caminiti, G. Aquilanti, Structural characterization of zinc(II) chloride in aqueous solution and in the protic ionic liquid ethyl ammonium nitrate by x-ray absorption spectroscopy. J. Chem. Phys. 135, 154509 (2011).
D. L. Wertz, J. R. Bell, Solute species and equilibria in concentrated zinc chloride/hydrochloric acid solutions. Journal of Inorganic and Nuclear Chemistry 35, 861-868 (1973).
M. Soniat, S. W. Rick, The effects of charge transfer on the aqueous solvation of ions. J. Chem. Phys. 137, 044511 (2012).
L. Petit, R. Vuilleumier, P. Maldivi, C. Adamo, Ab Initio Molecular Dynamics Study of a Highly Concentrated LiCl Aqueous Solution. J. Chem. Theory Comput. 4, 1040-1048 (2008).
J. M. Wimby, T. S. Berntsson, Viscosity and density of aqueous solutions of lithium bromide, lithium chloride, zinc bromide, calcium chloride and lithium nitrate. 1. Single salt solutions. J. Chem. & Eng. Data 39, 68-72 (1994).
K. Tanaka, M. Nomura, Measurements of tracer diffusion coefficients of lithium ions, chloride ions and water in aqueous lithium chloride solutions. J. Chem. Soc. Farad. Trans. 1: Phys. Chem. Conds. Phases. 83, 1779-1782 (1987).
C. H. Yim, Y. A. Abu-Lebdeh, Connection between Phase Diagram, Structure and Ion Transport in Liquid, Aqueous Electrolyte Solutions of Lithium Chloride. J. Electrochem. Soc. 165, A547-A556 (2018).
I. Pethes, A comparison of classical interatomic potentials applied to highly concentrated aqueous lithium chloride solutions. J. Mol. Liquids 242, 845-858 (2017).

We claim:

1. A high entropy solvent-in-salt electrolyte composition, said electrolyte composition comprising a combination of a solvent (S) and 2 or more metal salts chosen from M⁺Y⁻, M²⁺Y₂, and M³⁺Y₃,
wherein said 2 or more metal salts are different metal cations, and
wherein said 2 or more metal salts are different Y ions.

2. The electrolyte composition of claim 1, wherein said metal salts are in present in a stoichiometry chosen from M⁺_{z}M²⁺_{3-z}Y_{6-z}, M²⁺_{z}M²⁺_{2-z}Y₄, M⁺_{z}M³⁺_{2-z}Y_{6-2z}, M²⁺_{z}M³⁺_{2-z}Y_{6-z}, or M³⁺_{z}M³⁺_{2-z}Y₆.

3. The electrolyte composition of claim 1, wherein said metal salt has one or more cations chosen from Li⁺, Na⁺, K⁺, Mg²⁺, Ca²⁺, Al³⁺, Zn²⁺, Fe (II), Fe (III), and other transition metals cations.

4. The electrolyte composition of claim 1, wherein Y is Cl⁻, Br⁻, I⁻, FSI⁻, TFSI⁻, PF₆⁻, or OTf⁻.

5. The electrolyte composition of claim 1, wherein said solvent (S) is chosen from water, dimethoxyethane, diglyme, triglyme, pentaglyme, tetraethyleneglycol, ethyl acetate, methyl acetate, ethylene glycol monopropyl ether, ethylene carbonate, ethyl methyl carbonate, dimethylcarbonate, propylene carbonate, tetrahydrofuran, polytetrahydrofuran, 2-methyltetrahydrofuran, dipropylene glycol monoethyl ether, and dimethyl succinate.

6. The electrolyte composition of claim 1, wherein said metal salts are LiCl and ZnCl₂.

7. The electrolyte composition of claim 6, wherein the composition comprises a combination of LiCl and ZnCl₂ in a solvent (e.g., water), wherein the number of solvent molecules, R, is in the range of about 5 to about 56.

8. The electrolyte composition of claim 1, wherein each stoichiometry also comprises a number, R, of solvent molecules.

9. The electrolyte composition of claim 8, wherein R is in the range of about 10 to about 200.

10. The electrolyte composition of claim 8, wherein said solvent is water.

11. The electrolyte composition of claim 1,
wherein M⁺ is Li⁺;
wherein M²⁺ is Zn²⁺; and
wherein Y is chloride.

12. The electrolyte composition of claim 2, wherein z is 1-3.

13. The electrolyte composition of claim 12, wherein z is 2.

14. The electrolyte composition of claim 1, wherein the electrolyte composition comprises Li₂ZnCl₄·9H₂O.

15. A battery, said battery comprising a cathode, an anode, and the electrolyte composition of claim 1.

16. The battery of claim 15, wherein the operating temperature of the battery is in the range of about −100° C. to about 100° C., about −80° C. to about 80° C., or about −60° C. to about 80° C.

17. The battery of claim 15, further comprising a separator material, wherein the separator material is chosen from polyethylene, polypropylene, polyimides, polyamides, cellulose, silica-based fiber, or a combination thereof.

18. A method of assembling a battery, said method comprising layering a cathode, the electrolyte composition of claim 1, and an anode to obtain multiple layers, wherein said cathode, then said electrolyte, then said anode are layered;
placing a separator between the cathode and the anode,
wherein said cathode, then said electrolyte, then anode and said separator are sealed in a battery casing.
